(19) United States
(12) Patent Application Publication
(10) Pub. No.: US 2025/0236734 A1
(43) Pub. Date: Jul. 24, 2025

(54) CROSSLINKABLE ASPHALT COMPOSITIONS AND RELATED SYSTEMS AND RELATED METHODS

(71) Applicant: BMRC LLC, Wilmington, DE (US)

(72) Inventors: Adem Chich, Kearny, NJ (US); Zhengang Zong, Chester, NJ (US)

(21) Appl. No.: 19/028,544

(22) Filed: Jan. 17, 2025

Related U.S. Application Data
(60) Provisional application No. 63/622,896, filed on Jan. 19, 2024.

(51) Int. Cl. C08L 95/00; C08L 63/00

(52) U.S. Cl. CPC C08L 95/00; C08L 63/00; C08L 2207/22; C08L 2312/00; C08L 2555/80

(57) ABSTRACT

Kits for crosslinkable asphalt compositions are provided. A kit comprises a first container and a second container. The first container comprises a first formulation. The first formulation comprises a crosslinker. The second container comprises a second formulation. The second formulation comprises a polyfunctional epoxy-containing compound and an asphalt component. A sufficient amount of the second formulation is configured to be mixed with a sufficient amount of at least the first formulation so as to form a crosslinkable asphalt composition. The crosslinkable asphalt composition, when cured, forms a reaction product comprising a three-dimensional crosslinked polymer network. The asphalt component is within the three-dimensional crosslinked polymer network. Crosslinkable asphalt compositions, and related systems and related methods are also provided.

### CROSS-REFERENCE TO RELATED APPLICATIONS

This application claims priority to U.S. Provisional Patent Application No. 63/622,896, filed Jan. 19, 2024, and titled “CROSSLINKABLE ASPHALT COMPOSITIONS AND RELATED SYSTEMS AND RELATED METHODS,” the disclosure of which application is hereby incorporated herein by reference in its entirety.

### FIELD

This disclosure generally relates to crosslinkable asphalt compositions, and related systems and related methods.

### BACKGROUND

Various industries generate asphalt pavement waste and asphalt shingle waste. The asphalt pavement waste and the asphalt shingle waste are deposited in landfills. The asphalt pavement waste and the asphalt single waste can take hundreds of years to decompose.

### SUMMARY

Some embodiments relate to a kit. In some embodiments, the kit comprises a first container. In some embodiments, the first container comprises a first formulation. In some embodiments, the first formulation comprises a crosslinker. In some embodiments, the kit comprises a second container. In some embodiments, the second container comprises a second formulation. In some embodiments, the second formulation comprises a polyfunctional epoxy-containing compound. In some embodiments, at least one of the first formulation or the second formulation comprises an asphalt component. In some embodiments, a sufficient amount of the second formulation is configured to be mixed with at least a sufficient amount of the first formulation so as to form a crosslinkable asphalt composition. In some embodiments, the crosslinkable asphalt composition, when cured, forms a reaction product comprising a three-dimensional crosslinked polymer network. In some embodiments, the asphalt component is within the three-dimensional crosslinked polymer network.

In some embodiments, the crosslinker comprises at least one of a polyamine compound, an anhydride, an acid anhydride, a phenol-formaldehyde, an amino-formaldehyde, a carboxylic acid, a polybasic carboxylic acid, a polyamide, a polyamidoamide, an imidazoline, a polymeric amine, an aliphatic amine, an aromatic amine, a polyester, a polysulphide, a polymercaptan, a polyphenol, a thiol, a polythiol compound, or any combination thereof.

In some embodiments, the polyfunctional epoxy-containing compound comprises at least one of an alkyl glycidyl ether, an epoxidized fatty acid ester, an epoxidized plant oil, or any combination thereof.

In some embodiments, the asphalt component comprises at least one of an asphalt shingle waste, an asphalt pavement waste, or any combination thereof.

In some embodiments, the asphalt component comprises an asphalt shingle waste. In some embodiments, the asphalt shingle waste comprises a waste asphalt; a limestone; granules; and impurities.

In some embodiments, the asphalt component comprises an asphalt shingle waste. In some embodiments, the asphalt shingle waste comprises 1% to 99% by weight of an asphalt based on a total weight of the asphalt shingle waste. In some embodiments, the asphalt comprises a waste asphalt. In some embodiments, the asphalt shingle waste comprises 1% to 99% by weight of a limestone, granules, and impurities based on the total weight of the asphalt shingle waste.

In some embodiments, the asphalt component comprises an asphalt pavement waste. In some embodiments, the asphalt pavement waste comprises a waste asphalt; and an aggregate.

In some embodiments, the asphalt component comprises an asphalt. In some embodiments, the asphalt comprises 1% to 40% by weight of a waste asphalt based on a total weight of the asphalt.

In some embodiments, the second formulation comprises 1% to 20% by weight of the polyfunctional epoxy-containing compound based on a total weight of the second formulation.

In some embodiments, the second formulation comprises 10% to 90% by weight of the asphalt component based on the total weight of the second formulation.

In some embodiments, the first formulation comprises 10% to 90% by weight of the asphalt component based on the total weight of the first formulation.

In some embodiments, the second formulation further comprises 20% to 70% by weight of a filler material based on the total weight of the second formulation.

Some embodiments relate to a method. In some embodiments, the method comprises obtaining a first formulation. In some embodiments, the first formulation comprises a crosslinker. In some embodiments, the method comprises obtaining a second formulation. In some embodiments, the second formulation comprises a polyfunctional epoxy-containing compound. In some embodiments, at least one of the first formulation or the second formulation comprises an asphalt component. In some embodiments, the method comprises mixing a sufficient amount of the first formulation with a sufficient amount of at least the second formulation so as to form a crosslinkable asphalt composition. In some embodiments, the method comprises applying the crosslinkable asphalt composition to a surface. In some embodiments, the method comprises curing the crosslinkable asphalt composition, so as to form a reaction product comprising a three-dimensional crosslinked polymer network. In some embodiments, the asphalt component is within the three-dimensional crosslinked polymer network.

In some embodiments, the crosslinker comprises at least one of a polyamine compound, an anhydride, an acid anhydride, a phenol-formaldehyde, an amino-formaldehyde, a carboxylic acid, a polybasic carboxylic acid, a polyamide, a polyamidoamide, an imidazoline, a polymeric amine, an aliphatic amine, an aromatic amine, a polyester, a polysulphide, a polymercaptan, a polyphenol, a thiol, a polythiol compound, or any combination thereof.

In some embodiments, the polyfunctional epoxy-containing compound comprises at least one of an alkyl glycidyl ether, an epoxidized fatty acid ester, an epoxidized plant oil, or any combination thereof.

In some embodiments, the asphalt component comprises at least one of an asphalt shingle waste, an asphalt pavement waste, or any combination thereof.

In some embodiments, the asphalt component comprises an asphalt shingle waste. In some embodiments, the asphalt shingle waste comprises a waste asphalt; a limestone; granules; and impurities.

In some embodiments, the asphalt component comprises an asphalt shingle waste. In some embodiments, the asphalt shingle waste comprises 1% to 99% by weight of an asphalt based on a total weight of the asphalt shingle waste. In some embodiments, the asphalt comprises a waste asphalt. In some embodiments, the asphalt shingle waste comprise 1% to 99% by weight of limestone, granules, and impurities based on the total weight of the asphalt shingle waste.

In some embodiments, the asphalt component comprises an asphalt pavement waste. In some embodiments, the asphalt pavement waste comprises a waste asphalt; and an aggregate.

In some embodiments, the asphalt component comprises an asphalt. In some embodiments, the asphalt comprises 1% to 40% by weight of a waste asphalt based on a total weight of the asphalt.

In some embodiments, the second formulation comprises 1% to 20% by weight of the polyfunctional epoxy-containing compound based on a total weight of the second formulation.

In some embodiments, the second formulation comprises 10% to 90% by weight of the asphalt component based on the total weight of the second formulation.

In some embodiments, the first formulation comprises 10% to 90% by weight of the asphalt component based on the total weight of the first formulation.

Some embodiments relate to a system. In some embodiments, the system comprises a substrate. In some embodiments, the system comprises a crosslinked asphalt composition. In some embodiments, the crosslinked asphalt composition is located on the substrate. In some embodiments, the crosslinked asphalt composition comprises a three-dimensional crosslinked polymer network. In some embodiments, the three-dimensional crosslinked polymer network is a reaction product of a crosslinker and a polyfunctional epoxy-containing compound. In some embodiments, the crosslinked asphalt composition comprises an asphalt component. In some embodiments, the asphalt component is within the three-dimensional crosslinked polymer network.

### BRIEF DESCRIPTION OF THE DRAWINGS

Reference is made to the drawings that form a part of this disclosure, and which illustrate embodiments in which the materials and methods described herein can be practiced.

FIG. 1 is a flowchart of a method of forming a crosslinked asphalt composition, according to some embodiments.

FIG. 2 is a schematic diagram of a cross-section of a system comprising a crosslinked asphalt composition, according to some embodiments.

### DETAILED DESCRIPTION

As used herein, the term “asphalt pavement waste” refers to any form of discarded asphalt pavement.

As used herein, the term “asphalt shingle waste” refers to any form of discarded asphalt shingle. “Asphalt shingle waste” includes, but is not limited to, post-manufacturing waste and post-consumer waste.

As used herein, the term “post-consumer waste” refers to any waste produced by an end consumer of a material stream. A non-limiting example of “post-consumer waste” is a discarded roofing shingle from a residential or commercial roof. Another non-limiting example of “post-consumer waste” is contractor waste including, but not limited to, surplus new material, damaged material, and scrap from cut shingles during installation. Yet another non-limiting example of “post-consumer waste” is at least one of: distributor waste, retail waste, or any combination thereof, including, but not limited to, damaged shingle products, aged inventory of shingles, and customer returns.

As used herein, the term “post-manufacturing waste” refers to waste produced prior to reaching the end consumer of a material stream. A non-limiting example of “post-manufacturing waste” is any shingle waste generated during the production, handling, transportation or other method of generation prior to installation on a roof of a consumer. Post-manufacturing waste may include production waste such as, but not limited to, partial shingles and coated fiberglass mat with or without granules.

As used herein, the term “waste asphalt” refers to any form of asphalt that is obtained from asphalt shingle waste.

As used herein, the term “asphalt,” when used without the modifier “waste,” refers to any form of asphalt that is not obtained from asphalt shingle waste. Non-limiting examples of asphalt include at least one of hot mix asphalt, warm mix asphalt, cold mix asphalt, sheet asphalt, high-modulus asphalt, or any combination thereof.

As used herein, the “oxidized asphalt” is defined as a form of processed asphalt that is created by oxidizing asphalt. A non-limiting example of an oxidation procedure is air-blowing, in which air is blown into asphalt at a sufficient temperature (e.g., from 450° F. to 500° F.) to oxidize the asphalt. Other non-limiting examples of oxidation procedures are described in U.S. Pat. Nos. 7,901,563 and 9,556,383, each of which are incorporated by reference in their entireties.

In some embodiments, the term “unoxidized asphalt” refers to a form of asphalt that has not been subjected to the oxidization procedure.

As used herein, the term “polymer-modified asphalt” is defined as a form of processed asphalt that is created by adding at least one polymer to an asphalt. A non-limiting example of a polymer modification procedure is emulsification, in which at least one polymer is mixed with asphalt at a sufficient temperature (e.g., from 250° F. to 350° F.) to form an emulsion. Other non-limiting examples of polymer modification procedures are described in U.S. Pat. No. 8,901,211, which is incorporated by reference in its entirety. In yet other embodiments, the polymer forms a colloid suspension, colloid solution, or dispersion with the asphalt.

As used herein, the term “volatile organic compound” refers to an organic compound capable of evaporating at ambient conditions (e.g., ambient temperature and/or ambient pressure). In some embodiments, the ambient conditions comprise room temperature and atmospheric pressure.

As used herein, the term “substantially free” of a material refers to a composition comprising 5% by weight or less of the material. The term includes compositions not comprising the material. In some embodiments, for example, a composition comprises 1% to 5% by weight or less of the material based on a total weight of the composition. In some embodiments, a composition comprises 1% to 4.5% by weight or less of the material based on a total weight of the composition. In some embodiments, a composition comprises 1% to 4% by weight or less of the material based on a total weight of the composition. In some embodiments, a composition comprises 1% to 3.5% by weight or less of the material based on a total weight of the composition. In some embodiments, a composition comprises 1% to 3% by weight or less of the material based on a total weight of the composition. In some embodiments, a composition comprises 1% to 2.5% by weight or less of the material based on a total weight of the composition. In some embodiments, a composition comprises 1% to 2% by weight or less of the material based on a total weight of the composition. In some embodiments, a composition comprises 1% to 1.5% by weight or less of the material based on a total weight of the composition. In some embodiments, a composition comprises 1.5% to 5% by weight or less of the material based on a total weight of the composition. In some embodiments, a composition comprises 2% to 5% by weight or less of the material based on a total weight of the composition. In some embodiments, a composition comprises 2.5% to 5% by weight or less of the material based on a total weight of the composition. In some embodiments, a composition comprises 3% to 5% by weight or less of the material based on a total weight of the composition. In some embodiments, a composition comprises 3.5% to 5% by weight or less of the material based on a total weight of the composition. In some embodiments, a composition comprises 4% to 5% by weight or less of the material based on a total weight of the composition. In some embodiments, a composition comprises 4.5% to 5% by weight or less of the material based on a total weight of the composition. In some embodiments, the material comprises asphalt shingle waste. In some embodiments, the material comprises asphalt pavement waste. In some embodiments, the material comprises at least one volatile organic compound. In some embodiments, the composition comprises the first formulation. In some embodiments, the composition comprises the second formulation. In some embodiments, the composition comprises the crosslinkable asphalt composition. In some embodiments, the composition comprises the crosslinked asphalt composition.

As used herein, the term “free” of a material refers to a composition comprising 1% by weight or less of the material. The term includes compositions not comprising the material. In some embodiments, for example, a composition comprises 0.1% to 1% by weight of the material based on a total weight of the composition. In some embodiments, a composition comprises 0.1% to 0.9% by weight of the material based on a total weight of the composition. In some embodiments, a composition comprises 0.1% to 0.8% by weight of the material based on a total weight of the composition. In some embodiments, a composition comprises 0.1% to 0.7% by weight of the material based on a total weight of the composition. In some embodiments, a composition comprises 0.1% to 0.6% by weight of the material based on a total weight of the composition. In some embodiments, a composition comprises 0.1% to 0.5% by weight of the material based on a total weight of the composition. In some embodiments, a composition comprises 0.1% to 0.4% by weight of the material based on a total weight of the composition. In some embodiments, a composition comprises 0.1% to 0.3% by weight of the material based on a total weight of the composition. In some embodiments, a composition comprises 0.1% to 0.2% by weight of the material based on a total weight of the composition. In some embodiments, a composition comprises 0.2% to 1% by weight of the material based on a total weight of the composition. In some embodiments, a composition comprises 0.3% to 1% by weight of the material based on a total weight of the composition. In some embodiments, a composition comprises 0.4% to 1% by weight of the material based on a total weight of the composition. In some embodiments, a composition comprises 0.5% to 1% by weight of the material based on a total weight of the composition. In some embodiments, a composition comprises 0.6% to 1% by weight of the material based on a total weight of the composition. In some embodiments, a composition comprises 0.7% to 1% by weight of the material based on a total weight of the composition. In some embodiments, a composition comprises 0.8% to 1% by weight of the material based on a total weight of the composition. In some embodiments, a composition comprises 0.9% to 1% by weight of the material based on a total weight of the composition. In some embodiments, the material comprises asphalt shingle waste. In some embodiments, the material comprises asphalt pavement waste. In some embodiments, the material comprises at least one volatile organic compound. In some embodiments, the composition comprises the first formulation. In some embodiments, the composition comprises the second formulation. In some embodiments, the composition comprises the crosslinkable asphalt composition. In some embodiments, the composition comprises the crosslinked asphalt composition.

Some embodiments relate to crosslinkable asphalt compositions. In some embodiments, the crosslinkable asphalt compositions are provided with a low content of volatile organic compounds. In some embodiments, the crosslinkable asphalt compositions are provided with no volatile organic compounds. In some embodiments, the crosslinkable asphalt compositions are useful substitutes for conventional hot-melt asphalt, and thus do not require equipment for heating or otherwise curing conventional hot-melt asphalt. In some embodiments, the crosslinkable asphalt compositions are useful substitutes for conventional water-based asphalt emulsions, and thus do not require the long cure times required for conventional water-based asphalt emulsions to dry. In some embodiments, the crosslinkable asphalt compositions utilize lower cost chemistries, such as, for example and without limitation, acrylic-based chemistries and/or urethane-based chemistries.

In some embodiments, the crosslinkable asphalt compositions incorporate recycled asphalt materials, such as, for example and without limitation, recycled asphalt shingles and/or recycled asphalt pavement, while maintaining or enhancing at least one property of the crosslinkable asphalt composition, relative to a similar crosslinkable asphalt composition that comprises non-recycled asphalt and does not comprise any recycled asphalt materials. In some embodiments, a polyfunctional epoxy-containing compound is incorporated into the crosslinkable asphalt composition to modify and/or improve at least one property of the recycled asphalt materials, such that the crosslinkable asphalt composition is suitable for a particular application.

In some embodiments, the crosslinkable asphalt compositions are useful for paving applications. In some embodiments, the crosslinkable asphalt compositions are useful for building applications. In some embodiments, the crosslinkable asphalt compositions are useful for roofing applications. In some embodiments, the crosslinkable asphalt compositions are useful as sealants. In some embodiments, the crosslinkable asphalt compositions are useful as coatings. In some embodiments, the crosslinkable asphalt compositions are useful as adhesives. In some embodiments, the crosslinkable asphalt compositions are useful for pavement repair applications. In some embodiments, the crosslinkable asphalt compositions are useful for roofing repair applications. In some embodiments, the crosslinkable asphalt compositions are useful for building repair applications.

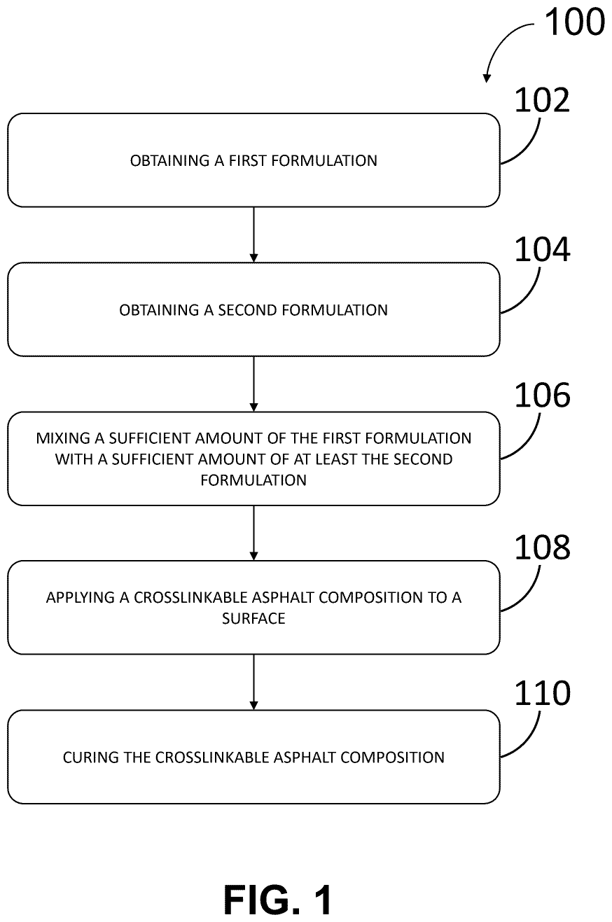

FIG. 1 is a flowchart of a method of forming a crosslinked asphalt composition 100, according to some embodiments. As shown in FIG. 1, in some embodiments, the method of forming a crosslinked asphalt composition comprises one or more of the following steps: obtaining 102 a first formulation, obtaining 104 a second formulation, mixing 106 a sufficient amount of the first formulation with a sufficient amount of at least the second formulation so as to form a crosslinkable asphalt composition; applying 108 the crosslinkable asphalt composition to a surface; and curing 110 the crosslinkable asphalt composition.

At step 102, in some embodiments, the method 100 of forming a crosslinked asphalt composition comprises obtaining the first formulation.

In some embodiments, the first formulation comprises a crosslinker. As used herein, the “crosslinker” refers to a compound comprising at least two reactive groups. In some embodiments, the crosslinker is not a polymer. In some embodiments, the crosslinker comprises at least one of a monomer, an oligomer, a polymer, or any combination thereof. In some embodiments, the crosslinker is capable of forming at least one bond between at least two polymer chains. In some embodiments, the at least one bond comprises a covalent bond. In some embodiments, the at least one bond comprises an ionic bond. In some embodiments, the at least two polymer chains are part of a same polymer. In some embodiments, the at least two polymer chains are part of different polymers. In some embodiments, the crosslinker is capable of reacting with the polyfunctional epoxy-containing compound to form a reaction product comprising a three-dimensional crosslinked polymer network.

In some embodiments, the crosslinker comprises a polyamine compound. As used herein, the term “polyamine compound” refers to a compound comprising at least two amines. In some embodiments, the polyamine compound is not a polymer. In some embodiments, the polyamine compound comprises at least one of a monomer, an oligomer, a polymer, or any combination thereof. In some embodiments, the polyamine compound comprises two amines. In some embodiments, the polyamine compound comprises three amines. In some embodiments, the polyamine compound comprises four amines. In some embodiments, the polyamine compound comprises five amines. In some embodiments, the polyamine compound comprises six amines. In some embodiments, the polyamine compound comprises seven amines. In some embodiments, the polyamine compound comprises eight amines. In some embodiments, the polyamine compound comprises nine amines. In some embodiments, the polyamine compound comprises ten amines. In some embodiments, the polyamine compound comprises more than ten amines.

In some embodiments, the polyamine compound comprises at least one of ethylenediamine, diethylenetriamine, triethylenetetramine, tetraethylenepentamine, pentaethylenehexamine, hexaethyleneheptamine, heptaethyleneoctamine, octaethylenenonamine, nonaethylene decamine, decaethylene undecamine, ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N,N-diethylethylenediamine, triethylethylenediamine, 1,2,3-triaminopropane, hydrazine, tris(2-aminoethyl)amine, tetra(aminomethyl) methane, diethylenetriamine, diazabicyloundecene, or any combination thereof. In some embodiments, the polyamine compound comprises at least one of ethylenediamine, diethylenetriamine, triethylenetetramine, tetraethylenepentamine, pentaethylenehexamine, or any combination thereof.

In some embodiments, the crosslinker comprises at least one of an anhydride, an acid anhydride, a phenol-formaldehyde, an amino-formaldehyde, a carboxylic acid, a polybasic carboxylic acid, a polyamide, a polyamidoamide, an imidazoline, a polymeric amine, an aliphatic amine, an aromatic amine, a polyester, a polysulphide, a polymercaptan, a polyphenol, a thiol, a polythiol compound, or any combination thereof. In some embodiments, for example, the thiol and/or the polythiol compound comprise at least one of ethylene glycol, diethylene glycol, triethylene glycol, 1,2-propane diol, 1,3-propane diol, dipropylene glycol, tripropylene glycol, 1,4-butane diol, 1,6-hexane diol, glycerin, trimethylolpropane, trimethylolethane, erythritol, pentaerythritol, sorbitol, sucrose, 1,2-ethane dithiol, 1,2-propane dithiol, 1,3-propanedithiol, 1,4-butane dithiol, 1,6-hexane dithiol, 1,2,3-trimercaptopropane, 1,2,3-tri (mercaptomethyl) propane, 1,2,3-tri (mercaptoethyl) ethane, (2,3-di((2-mercaptoethyl)thio) 1-propanethiol, or any combination thereof.

In some embodiments, the first formulation comprises 1% to 99% by weight of the crosslinker based on the total weight of the first formulation. In some embodiments, the first formulation comprises 1% to 95% by weight of the crosslinker based on the total weight of the first formulation. In some embodiments, the first formulation comprises 1% to 90% by weight of the crosslinker based on the total weight of the first formulation. In some embodiments, the first formulation comprises 1% to 85% by weight of the crosslinker based on the total weight of the first formulation. In some embodiments, the first formulation comprises 1% to 80% by weight of the crosslinker based on the total weight of the first formulation. In some embodiments, the first formulation comprises 1% to 75% by weight of the crosslinker based on the total weight of the first formulation. In some embodiments, the first formulation comprises 1% to 70% by weight of the crosslinker based on the total weight of the first formulation. In some embodiments, the first formulation comprises 1% to 65% by weight of the crosslinker based on the total weight of the first formulation. In some embodiments, the first formulation comprises 1% to 60% by weight of the crosslinker based on the total weight of the first formulation. In some embodiments, the first formulation comprises 1% to 55% by weight of the crosslinker based on the total weight of the first formulation. In some embodiments, the first formulation comprises 1% to 50% by weight of the crosslinker based on the total weight of the first formulation. In some embodiments, the first formulation comprises 1% to 45% by weight of the crosslinker based on the total weight of the first formulation. In some embodiments, the first formulation comprises 1% to 40% by weight of the crosslinker based on the total weight of the first formulation. In some embodiments, the first formulation comprises 1% to 35% by weight of the crosslinker based on the total weight of the first formulation. In some embodiments, the first formulation comprises 1% to 30% by weight of the crosslinker based on the total weight of the first formulation. In some embodiments, the first formulation comprises 1% to 25% by weight of the crosslinker based on the total weight of the first formulation. In some embodiments, the first formulation comprises 1% to 20% by weight of the crosslinker based on the total weight of the first formulation. In some embodiments, the first formulation comprises 1% to 15% by weight of the crosslinker based on the total weight of the first formulation. In some embodiments, the first formulation comprises 1% to 10% by weight of the crosslinker based on the total weight of the first formulation. In some embodiments, the first formulation comprises 1% to 5% by weight of the crosslinker based on the total weight of the first formulation.

In some embodiments, the first formulation comprises 5% to 99% by weight of the crosslinker based on the total weight of the first formulation. In some embodiments, the first formulation comprises 10% to 99% by weight of the crosslinker based on the total weight of the first formulation. In some embodiments, the first formulation comprises 15% to 99% by weight of the crosslinker based on the total weight of the first formulation. In some embodiments, the first formulation comprises 20% to 99% by weight of the crosslinker based on the total weight of the first formulation. In some embodiments, the first formulation comprises 25% to 99% by weight of the crosslinker based on the total weight of the first formulation. In some embodiments, the first formulation comprises 30% to 99% by weight of the crosslinker based on the total weight of the first formulation. In some embodiments, the first formulation comprises 35% to 99% by weight of the crosslinker based on the total weight of the first formulation. In some embodiments, the first formulation comprises 40% to 99% by weight of the crosslinker based on the total weight of the first formulation. In some embodiments, the first formulation comprises 45% to 99% by weight of the crosslinker based on the total weight of the first formulation. In some embodiments, the first formulation comprises 50% to 99% by weight of the crosslinker based on the total weight of the first formulation. In some embodiments, the first formulation comprises 55% to 99% by weight of the crosslinker based on the total weight of the first formulation. In some embodiments, the first formulation comprises 60% to 99% by weight of the crosslinker based on the total weight of the first formulation. In some embodiments, the first formulation comprises 65% to 99% by weight of the crosslinker based on the total weight of the first formulation. In some embodiments, the first formulation comprises 70% to 99% by weight of the crosslinker based on the total weight of the first formulation. In some embodiments, the first formulation comprises 75% to 99% by weight of the crosslinker based on the total weight of the first formulation. In some embodiments, the first formulation comprises 80% to 99% by weight of the crosslinker based on the total weight of the first formulation. In some embodiments, the first formulation comprises 85% to 99% by weight of the crosslinker based on the total weight of the first formulation. In some embodiments, the first formulation comprises 90% to 99% by weight of the crosslinker based on the total weight of the first formulation. In some embodiments, the first formulation comprises 95% to 99% by weight of the crosslinker based on the total weight of the first formulation.

In some embodiments, the first formulation comprises an asphalt component. In some embodiments, the asphalt component comprises any one or more of the asphalt components disclosed herein (e.g., the asphalt component disclosed in more detail below with respect to the second formulation). In some embodiments, the first formulation comprises an epoxy-modified asphalt component. In some embodiments, the first formulation comprises a monofunctional epoxy-modified asphalt component. In some embodiments, the first formulation comprises a polyfunctional epoxy-modified asphalt component. In some embodiments, the asphalt component is same or similar to the asphalt component disclosed in more detail below with respect to the second formulation. It will be appreciated that, although the weight percentage of the asphalt component disclosed in more detail below is described in the context of the second formulation, same or similar weight percentages of the asphalt component and/or the various constituents of the asphalt component may be used in the first formulation without departing from the scope of this disclosure. That is, for example, in some embodiments, the first formulation comprises the crosslinker and the asphalt component (e.g., such as any one or more of the asphalt components disclosed with respect to the second formulation), and the second formulation comprises an epoxy-containing compound, either with or without the asphalt component.

In some embodiments, the first formulation is substantially free of volatile organic compounds. In some embodiments, the first formulation is free of volatile organic compounds. In some embodiments, the first formulation does not comprise volatile organic compounds. In some embodiments, the first formulation is substantially free of asphalt shingle waste. In some embodiments, the first formulation is free of asphalt shingle waste. In some embodiments, the first formulation is substantially free of asphalt pavement waste. In some embodiments, the first formulation is free of asphalt pavement waste. In some embodiments, the first formulation comprises an asphalt component.

At step 104, in some embodiments, the method 100 of forming a crosslinked asphalt composition comprises obtaining the second formulation.

In some embodiments, the second formulation comprises an epoxy-containing compound. For example, in some embodiments, the second formulation comprises a monofunctional epoxy-containing compound. In some embodiments, the second formulation comprises a polyfunctional epoxy-containing compound. As used herein, the term “polyfunctional epoxy-containing compound” refers to a compound comprising at least two epoxy groups. In some embodiments, the polyfunctional epoxy-containing compound is not a polymer. In some embodiments, the polyfunctional epoxy-containing compound comprises at least one of a monomer, an oligomer, a polymer, or any combination thereof. In some embodiments, the polyfunctional epoxy-containing compound comprises two epoxy groups. In some embodiments, the polyfunctional epoxy-containing compound comprises three epoxy groups. In some embodiments, the polyfunctional epoxy-containing compound comprises four epoxy groups. In some embodiments, the polyfunctional epoxy-containing compound comprises five epoxy groups. In some embodiments, the polyfunctional epoxy-containing compound comprises six epoxy groups. In some embodiments, the polyfunctional epoxy-containing compound comprises seven epoxy groups. In some embodiments, the polyfunctional epoxy-containing compound comprises eight epoxy groups. In some embodiments, the polyfunctional epoxy-containing compound comprises nine epoxy groups. In some embodiments, the polyfunctional epoxy-containing compound comprises ten epoxy groups. In some embodiments, the polyfunctional epoxy-containing compound comprises ten or more epoxy groups, such as, for example and without limitation, 10 to 100 epoxy groups.

In some embodiments, the polyfunctional epoxy-containing compound comprises at least one of an epoxy resin diluent, a reactive diluent, an aliphatic epoxy resin, a cycloaliphatic epoxy resin, a bisphenol epoxy resin, a novolac epoxy resin, a glycidylamine epoxy resin, or any combination thereof. In some embodiments, the polyfunctional epoxy-containing compound comprises at least one of a glycidyl ether, an epoxidized fatty acid, an epoxidized fatty acid ester, an epoxidized plant oil, or any combination thereof. In some embodiments, the glycidyl ether comprises an alkyl glycidyl ether. In some embodiments, the glycidyl ether comprises at least one of allyl glycidyl ether, butyl glycidyl ether (BGE), 2-ethylhexyl glycidyl ether, alkyl glycidyl ether (C12 to C14), tridecyl glycidyl ether, phenyl glycidyl ether (PGE), o-cresol glycidyl ether (CGE), p-tert-butyl glycidyl ether, resorcinol diglycidyl ether (RDGE), 1,4-butanediol diglycidyl ether (BDGE), 1,6-hexanediol diglycidyl ether (HDGE), cyclohexanedimethanol diglycidyl ether, neopentyl glycol diglycidyl ether, trimethylolpropane triglycidyl ether, glycerol triglycidyl ether, polypropylene glycol diglycidyl ether, or any combination thereof. In some embodiments, the epoxidized fatty acid ester comprises at least one of epoxidized oleic acid, epoxidized elaidic acid, epoxidized myristoleic acid, epoxidized palmitoleic acid, epoxidized sapienic acid, epoxidized vaccenic acid, epoxidized erucic acid, epoxidized ricinoleic acid, epoxidized linoleic acid, epoxidized linoelaidic acid, epoxidized linolenic acid, epoxidized α-linolenic acid, epoxidized α-eleostearic acid, epoxidized arachidonic acid, epoxidized eicosapentaenoic acid, epoxidized docosahexaenoic acid, any ester thereof, or any combination thereof. In some embodiments, the epoxidized plant oil comprises a vegetable oil. For example, in some embodiments, the epoxidized plant oil comprises at least one of flaxseed oil, palm oil, olive oil, canola oil, corn oil, cottonseed oil, soybean oil, linseed oil, rapeseed oil, castor oil, coconut oil, palm kernel oil, rice bran oil, safflower oil, sesame oil, sunflower oil, or any combination thereof. In some embodiments, the second formulation comprises at least one of a monofunctional epoxy-containing compound, a polyfunctional epoxy-containing compound, a monofunctional liquid epoxy resin, a polyfunctional liquid epoxy resin, or any combination thereof.

In some embodiments, the second formulation comprises 1% to 20% by weight of the polyfunctional epoxy-containing compound based on a total weight of the second formulation. In some embodiments, the second formulation comprises 1% to 19% by weight of the polyfunctional epoxy-containing compound based on the total weight of the second formulation. In some embodiments, the second formulation comprises 1% to 18% by weight of the polyfunctional epoxy-containing compound based on the total weight of the second formulation. In some embodiments, the second formulation comprises 1% to 17% by weight of the polyfunctional epoxy-containing compound based on the total weight of the second formulation. In some embodiments, the second formulation comprises 1% to 16% by weight of the polyfunctional epoxy-containing compound based on the total weight of the second formulation. In some embodiments, the second formulation comprises 1% to 15% by weight of the polyfunctional epoxy-containing compound based on the total weight of the second formulation. In some embodiments, the second formulation comprises 1% to 14% by weight of the polyfunctional epoxy-containing compound based on the total weight of the second formulation. In some embodiments, the second formulation comprises 1% to 13% by weight of the polyfunctional epoxy-containing compound based on the total weight of the second formulation. In some embodiments, the second formulation comprises 1% to 12% by weight of the polyfunctional epoxy-containing compound based on the total weight of the second formulation. In some embodiments, the second formulation comprises 1% to 11% by weight of the polyfunctional epoxy-containing compound based on the total weight of the second formulation. In some embodiments, the second formulation comprises 1% to 10% by weight of the polyfunctional epoxy-containing compound based on the total weight of the second formulation. In some embodiments, the second formulation comprises 1% to 9% by weight of the polyfunctional epoxy-containing compound based on the total weight of the second formulation. In some embodiments, the second formulation comprises 1% to 8% by weight of the polyfunctional epoxy-containing compound based on the total weight of the second formulation. In some embodiments, the second formulation comprises 1% to 7% by weight of the polyfunctional epoxy-containing compound based on the total weight of the second formulation. In some embodiments, the second formulation comprises 1% to 6% by weight of the polyfunctional epoxy-containing compound based on the total weight of the second formulation. In some embodiments, the second formulation comprises 1% to 5% by weight of the polyfunctional epoxy-containing compound based on the total weight of the second formulation. In some embodiments, the second formulation comprises 1% to 4% by weight of the polyfunctional epoxy-containing compound based on the total weight of the second formulation. In some embodiments, the second formulation comprises 1% to 3% by weight of the polyfunctional epoxy-containing compound based on the total weight of the second formulation. In some embodiments, the second formulation comprises 1% to 2% by weight of the polyfunctional epoxy-containing compound based on the total weight of the second formulation.

In some embodiments, the second formulation comprises 2% to 20% by weight of the polyfunctional epoxy-containing compound based on the total weight of the second formulation. In some embodiments, the second formulation comprises 3% to 20% by weight of the polyfunctional epoxy-containing compound based on the total weight of the second formulation. In some embodiments, the second formulation comprises 4% to 20% by weight of the polyfunctional epoxy-containing compound based on the total weight of the second formulation. In some embodiments, the second formulation comprises 5% to 20% by weight of the polyfunctional epoxy-containing compound based on the total weight of the second formulation. In some embodiments, the second formulation comprises 6% to 20% by weight of the polyfunctional epoxy-containing compound based on the total weight of the second formulation. In some embodiments, the second formulation comprises 7% to 20% by weight of the polyfunctional epoxy-containing compound based on the total weight of the second formulation. In some embodiments, the second formulation comprises 8% to 20% by weight of the polyfunctional epoxy-containing compound based on the total weight of the second formulation. In some embodiments, the second formulation comprises 9% to 20% by weight of the polyfunctional epoxy-containing compound based on the total weight of the second formulation. In some embodiments, the second formulation comprises 10% to 20% by weight of the polyfunctional epoxy-containing compound based on the total weight of the second formulation. In some embodiments, the second formulation comprises 11% to 20% by weight of the polyfunctional epoxy-containing compound based on the total weight of the second formulation. In some embodiments, the second formulation comprises 12% to 20% by weight of the polyfunctional epoxy-containing compound based on the total weight of the second formulation. In some embodiments, the second formulation comprises 13% to 20% by weight of the polyfunctional epoxy-containing compound based on the total weight of the second formulation. In some embodiments, the second formulation comprises 14% to 20% by weight of the polyfunctional epoxy-containing compound based on the total weight of the second formulation. In some embodiments, the second formulation comprises 15% to 20% by weight of the polyfunctional epoxy-containing compound based on the total weight of the second formulation. In some embodiments, the second formulation comprises 16% to 20% by weight of the polyfunctional epoxy-containing compound based on the total weight of the second formulation. In some embodiments, the second formulation comprises 17% to 20% by weight of the polyfunctional epoxy-containing compound based on the total weight of the second formulation. In some embodiments, the second formulation comprises 18% to 20% by weight of the polyfunctional epoxy-containing compound based on the total weight of the second formulation. In some embodiments, the second formulation comprises 19% to 20% by weight of the polyfunctional epoxy-containing compound based on the total weight of the second formulation.

In some embodiments, the second formulation comprises an asphalt component. In some embodiments, the asphalt component comprises at least one of an asphalt, an asphalt shingle waste, an asphalt pavement waste, or any combination thereof. In some embodiments, the asphalt comprises at least one of an oxidized asphalt, an unoxidized asphalt, a polymer-modified asphalt, a waste asphalt, or any combination thereof. In some embodiments, the asphalt shingle waste comprises at least one of a waste asphalt, a limestone, granules, impurities, or any combination thereof. In some embodiments, the impurities comprise at least one of fiberglass mat, sand, fines, marker paint, sealant, adhesive, tape, plastic debris, paper debris, soil, woods, nails, or any combination thereof. In some embodiments, the polymer-modified asphalt comprises at least one of a styrenic polymer, a polyolefin, or any combination thereof. In some embodiments, the polymer-modified asphalt comprises at least one of a poly(styrene-butadiene-styrene) (SBS), a poly(styrene-ethylene/butylene-styrene) (SEBS), an atactic polypropylene (APP), an isotactic polypropylene (IPP), or any combination thereof. In some embodiments, the asphalt pavement waste comprises at least one of a waste asphalt, an aggregate, or any combination thereof. In some embodiments, the aggregate comprises a binder. In some embodiments, the aggregate comprises at least one of expanded clays, furnace slags, pumice, polystyrene beads, vermiculite, expanded shales, limestone, perlite, scoria, pumice, vermiculite, sand, gravel, stone, rock, or any combination thereof.

In some embodiments, the polyfunctional epoxy-containing compound modifies at least one property of the asphalt component. In some embodiments, the polyfunctional epoxy-containing compound modifies at least one property of the asphalt prior to curing and/or upon curing. In some embodiments, the polyfunctional epoxy-containing compound modifies an asphaltene content of the asphalt component. In some embodiments, the polyfunctional epoxy-containing compound modifies a penetration point of the asphalt component. In some embodiments, the polyfunctional epoxy-containing compound modifies a viscosity of the asphalt component. In some embodiments, the polyfunctional epoxy-containing compound modifies a softening point of the asphalt component. In some embodiments, the polyfunctional epoxy-containing compound modifies an asphaltene content of the crosslinkable asphalt composition. In some embodiments, the polyfunctional epoxy-containing compound modifies a penetration point of the crosslinkable asphalt composition. In some embodiments, the polyfunctional epoxy-containing compound modifies a viscosity of the crosslinkable asphalt composition. In some embodiments, the polyfunctional epoxy-containing compound modifies a softening point of the crosslinkable asphalt composition. In some embodiments, the polyfunctional epoxy-containing compound modifies an asphaltene content of the crosslinked asphalt composition. In some embodiments, the polyfunctional epoxy-containing compound modifies a penetration point of the crosslinked asphalt composition. In some embodiments, the polyfunctional epoxy-containing compound modifies a viscosity of the crosslinked asphalt composition. In some embodiments, the polyfunctional epoxy-containing compound modifies a softening point of the crosslinked asphalt composition.

In some embodiments, the second formulation comprises 10% to 90% by weight of an asphalt component based on the total weight of the second formulation. In some embodiments, the second formulation comprises 10% to 85% by weight of the asphalt component based on the total weight of the second formulation. In some embodiments, the second formulation comprises 10% to 80% by weight of the asphalt component based on the total weight of the second formulation. In some embodiments, the second formulation comprises 10% to 75% by weight of the asphalt component based on the total weight of the second formulation. In some embodiments, the second formulation comprises 10% to 70% by weight of the asphalt component based on the total weight of the second formulation. In some embodiments, the second formulation comprises 10% to 65% by weight of the asphalt component based on the total weight of the second formulation. In some embodiments, the second formulation comprises 10% to 60% by weight of the asphalt component based on the total weight of the second formulation. In some embodiments, the second formulation comprises 10% to 55% by weight of the asphalt component based on the total weight of the second formulation. In some embodiments, the second formulation comprises 10% to 50% by weight of the asphalt component based on the total weight of the second formulation. In some embodiments, the second formulation comprises 10% to 45% by weight of the asphalt component based on the total weight of the second formulation. In some embodiments, the second formulation comprises 10% to 40% by weight of the asphalt component based on the total weight of the second formulation. In some embodiments, the second formulation comprises 10% to 35% by weight of the asphalt component based on the total weight of the second formulation. In some embodiments, the second formulation comprises 10% to 30% by weight of the asphalt component based on the total weight of the second formulation. In some embodiments, the second formulation comprises 10% to 25% by weight of the asphalt component based on the total weight of the second formulation. In some embodiments, the second formulation comprises 10% to 20% by weight of the asphalt component based on the total weight of the second formulation. In some embodiments, the second formulation comprises 10% to 15% by weight of the asphalt component based on the total weight of the second formulation.

In some embodiments, the second formulation comprises 15% to 90% by weight of the asphalt component based on the total weight of the second formulation. In some embodiments, the second formulation comprises 20% to 90% by weight of the asphalt component based on the total weight of the second formulation. In some embodiments, the second formulation comprises 25% to 90% by weight of the asphalt component based on the total weight of the second formulation. In some embodiments, the second formulation comprises 30% to 90% by weight of the asphalt component based on the total weight of the second formulation. In some embodiments, the second formulation comprises 35% to 90% by weight of the asphalt component based on the total weight of the second formulation. In some embodiments, the second formulation comprises 40% to 90% by weight of the asphalt component based on the total weight of the second formulation. In some embodiments, the second formulation comprises 45% to 90% by weight of the asphalt component based on the total weight of the second formulation. In some embodiments, the second formulation comprises 50% to 90% by weight of the asphalt component based on the total weight of the second formulation. In some embodiments, the second formulation comprises 55% to 90% by weight of the asphalt component based on the total weight of the second formulation. In some embodiments, the second formulation comprises 60% to 90% by weight of the asphalt component based on the total weight of the second formulation. In some embodiments, the second formulation comprises 65% to 90% by weight of the asphalt component based on the total weight of the second formulation. In some embodiments, the second formulation comprises 70% to 90% by weight of the asphalt component based on the total weight of the second formulation. In some embodiments, the second formulation comprises 75% to 90% by weight of the asphalt component based on the total weight of the second formulation. In some embodiments, the second formulation comprises 80% to 90% by weight of the asphalt component based on the total weight of the second formulation. In some embodiments, the second formulation comprises 85% to 90% by weight of the asphalt component based on the total weight of the second formulation.

In some embodiments, the second formulation comprises 10% to 90% by weight of the asphalt based on the total weight of the second formulation. In some embodiments, the second formulation comprises 10% to 85% by weight of the asphalt based on the total weight of the second formulation. In some embodiments, the second formulation comprises 10% to 80% by weight of the asphalt based on the total weight of the second formulation. In some embodiments, the second formulation comprises 10% to 75% by weight of the asphalt based on the total weight of the second formulation. In some embodiments, the second formulation comprises 10% to 70% by weight of the asphalt based on the total weight of the second formulation. In some embodiments, the second formulation comprises 10% to 65% by weight of the asphalt based on the total weight of the second formulation. In some embodiments, the second formulation comprises 10% to 60% by weight of the asphalt based on the total weight of the second formulation. In some embodiments, the second formulation comprises 10% to 55% by weight of the asphalt based on the total weight of the second formulation. In some embodiments, the second formulation comprises 10% to 50% by weight of the asphalt based on the total weight of the second formulation. In some embodiments, the second formulation comprises 10% to 45% by weight of the asphalt based on the total weight of the second formulation. In some embodiments, the second formulation comprises 10% to 40% by weight of the asphalt based on the total weight of the second formulation. In some embodiments, the second formulation comprises 10% to 35% by weight of the asphalt based on the total weight of the second formulation. In some embodiments, the second formulation comprises 10% to 30% by weight of the asphalt based on the total weight of the second formulation. In some embodiments, the second formulation comprises 10% to 25% by weight of the asphalt based on the total weight of the second formulation. In some embodiments, the second formulation comprises 10% to 20% by weight of the asphalt based on the total weight of the second formulation. In some embodiments, the second formulation comprises 10% to 15% by weight of the asphalt based on the total weight of the second formulation.

In some embodiments, the second formulation comprises 15% to 90% by weight of the asphalt based on the total weight of the second formulation. In some embodiments, the second formulation comprises 20% to 90% by weight of the asphalt based on the total weight of the second formulation. In some embodiments, the second formulation comprises 25% to 90% by weight of the asphalt based on the total weight of the second formulation. In some embodiments, the second formulation comprises 30% to 90% by weight of the asphalt based on the total weight of the second formulation. In some embodiments, the second formulation comprises 35% to 90% by weight of the asphalt based on the total weight of the second formulation. In some embodiments, the second formulation comprises 40% to 90% by weight of the asphalt based on the total weight of the second formulation. In some embodiments, the second formulation comprises 45% to 90% by weight of the asphalt based on the total weight of the second formulation. In some embodiments, the second formulation comprises 50% to 90% by weight of the asphalt based on the total weight of the second formulation. In some embodiments, the second formulation comprises 55% to 90% by weight of the asphalt based on the total weight of the second formulation. In some embodiments, the second formulation comprises 60% to 90% by weight of the asphalt based on the total weight of the second formulation. In some embodiments, the second formulation comprises 65% to 90% by weight of the asphalt based on the total weight of the second formulation. In some embodiments, the second formulation comprises 70% to 90% by weight of the asphalt based on the total weight of the second formulation. In some embodiments, the second formulation comprises 75% to 90% by weight of the asphalt based on the total weight of the second formulation. In some embodiments, the second formulation comprises 80% to 90% by weight of the asphalt based on the total weight of the second formulation. In some embodiments, the second formulation comprises 85% to 90% by weight of the asphalt based on the total weight of the second formulation.

In some embodiments, the second formulation comprises 10% to 90% by weight of the oxidized asphalt based on the total weight of the second formulation. In some embodiments, the second formulation comprises 10% to 85% by weight of the oxidized asphalt based on the total weight of the second formulation. In some embodiments, the second formulation comprises 10% to 80% by weight of the oxidized asphalt based on the total weight of the second formulation. In some embodiments, the second formulation comprises 10% to 75% by weight of the oxidized asphalt based on the total weight of the second formulation. In some embodiments, the second formulation comprises 10% to 70% by weight of the oxidized asphalt based on the total weight of the second formulation. In some embodiments, the second formulation comprises 10% to 65% by weight of the oxidized asphalt based on the total weight of the second formulation. In some embodiments, the second formulation comprises 10% to 60% by weight of the oxidized asphalt based on the total weight of the second formulation. In some embodiments, the second formulation comprises 10% to 55% by weight of the oxidized asphalt based on the total weight of the second formulation. In some embodiments, the second formulation comprises 10% to 50% by weight of the oxidized asphalt based on the total weight of the second formulation. In some embodiments, the second formulation comprises 10% to 45% by weight of the oxidized asphalt based on the total weight of the second formulation. In some embodiments, the second formulation comprises 10% to 40% by weight of the oxidized asphalt based on the total weight of the second formulation. In some embodiments, the second formulation comprises 10% to 35% by weight of the oxidized asphalt based on the total weight of the second formulation. In some embodiments, the second formulation comprises 10% to 30% by weight of the oxidized asphalt based on the total weight of the second formulation. In some embodiments, the second formulation comprises 10% to 25% by weight of the oxidized asphalt based on the total weight of the second formulation. In some embodiments, the second formulation comprises 10% to 20% by weight of the oxidized asphalt based on the total weight of the second formulation. In some embodiments, the second formulation comprises 10% to 15% by weight of the oxidized asphalt based on the total weight of the second formulation.

In some embodiments, the second formulation comprises 15% to 90% by weight of the oxidized asphalt based on the total weight of the second formulation. In some embodiments, the second formulation comprises 20% to 90% by weight of the oxidized asphalt based on the total weight of the second formulation. In some embodiments, the second formulation comprises 25% to 90% by weight of the oxidized asphalt based on the total weight of the second formulation. In some embodiments, the second formulation comprises 30% to 90% by weight of the oxidized asphalt based on the total weight of the second formulation. In some embodiments, the second formulation comprises 35% to 90% by weight of the oxidized asphalt based on the total weight of the second formulation. In some embodiments, the second formulation comprises 40% to 90% by weight of the oxidized asphalt based on the total weight of the second formulation. In some embodiments, the second formulation comprises 45% to 90% by weight of the oxidized asphalt based on the total weight of the second formulation. In some embodiments, the second formulation comprises 50% to 90% by weight of the oxidized asphalt based on the total weight of the second formulation. In some embodiments, the second formulation comprises 55% to 90% by weight of the oxidized asphalt based on the total weight of the second formulation. In some embodiments, the second formulation comprises 60% to 90% by weight of the oxidized asphalt based on the total weight of the second formulation. In some embodiments, the second formulation comprises 65% to 90% by weight of the oxidized asphalt based on the total weight of the second formulation. In some embodiments, the second formulation comprises 70% to 90% by weight of the oxidized asphalt based on the total weight of the second formulation. In some embodiments, the second formulation comprises 75% to 90% by weight of the oxidized asphalt based on the total weight of the second formulation. In some embodiments, the second formulation comprises 80% to 90% by weight of the oxidized asphalt based on the total weight of the second formulation. In some embodiments, the second formulation comprises 85% to 90% by weight of the oxidized asphalt based on the total weight of the second formulation.

In some embodiments, the second formulation comprises 10% to 90% by weight of the unoxidized asphalt based on the total weight of the second formulation. In some embodiments, the second formulation comprises 10% to 85% by weight of the unoxidized asphalt based on the total weight of the second formulation. In some embodiments, the second formulation comprises 10% to 80% by weight of the unoxidized asphalt based on the total weight of the second formulation. In some embodiments, the second formulation comprises 10% to 75% by weight of the unoxidized asphalt based on the total weight of the second formulation. In some embodiments, the second formulation comprises 10% to 70% by weight of the unoxidized asphalt based on the total weight of the second formulation. In some embodiments, the second formulation comprises 10% to 65% by weight of the unoxidized asphalt based on the total weight of the second formulation. In some embodiments, the second formulation comprises 10% to 60% by weight of the unoxidized asphalt based on the total weight of the second formulation. In some embodiments, the second formulation comprises 10% to 55% by weight of the unoxidized asphalt based on the total weight of the second formulation. In some embodiments, the second formulation comprises 10% to 50% by weight of the unoxidized asphalt based on the total weight of the second formulation. In some embodiments, the second formulation comprises 10% to 45% by weight of the unoxidized asphalt based on the total weight of the second formulation. In some embodiments, the second formulation comprises 10% to 40% by weight of the unoxidized asphalt based on the total weight of the second formulation. In some embodiments, the second formulation comprises 10% to 35% by weight of the unoxidized asphalt based on the total weight of the second formulation. In some embodiments, the second formulation comprises 10% to 30% by weight of the unoxidized asphalt based on the total weight of the second formulation. In some embodiments, the second formulation comprises 10% to 25% by weight of the unoxidized asphalt based on the total weight of the second formulation. In some embodiments, the second formulation comprises 10% to 20% by weight of the unoxidized asphalt based on the total weight of the second formulation. In some embodiments, the second formulation comprises 10% to 15% by weight of the unoxidized asphalt based on the total weight of the second formulation.

In some embodiments, the second formulation comprises 15% to 90% by weight of the unoxidized asphalt based on the total weight of the second formulation. In some embodiments, the second formulation comprises 20% to 90% by weight of the unoxidized asphalt based on the total weight of the second formulation. In some embodiments, the second formulation comprises 25% to 90% by weight of the unoxidized asphalt based on the total weight of the second formulation. In some embodiments, the second formulation comprises 30% to 90% by weight of the unoxidized asphalt based on the total weight of the second formulation. In some embodiments, the second formulation comprises 35% to 90% by weight of the unoxidized asphalt based on the total weight of the second formulation. In some embodiments, the second formulation comprises 40% to 90% by weight of the unoxidized asphalt based on the total weight of the second formulation. In some embodiments, the second formulation comprises 45% to 90% by weight of the unoxidized asphalt based on the total weight of the second formulation. In some embodiments, the second formulation comprises 50% to 90% by weight of the unoxidized asphalt based on the total weight of the second formulation. In some embodiments, the second formulation comprises 55% to 90% by weight of the unoxidized asphalt based on the total weight of the second formulation. In some embodiments, the second formulation comprises 60% to 90% by weight of the unoxidized asphalt based on the total weight of the second formulation. In some embodiments, the second formulation comprises 65% to 90% by weight of the unoxidized asphalt based on the total weight of the second formulation. In some embodiments, the second formulation comprises 70% to 90% by weight of the unoxidized asphalt based on the total weight of the second formulation. In some embodiments, the second formulation comprises 75% to 90% by weight of the unoxidized asphalt based on the total weight of the second formulation. In some embodiments, the second formulation comprises 80% to 90% by weight of the unoxidized asphalt based on the total weight of the second formulation. In some embodiments, the second formulation comprises 85% to 90% by weight of the unoxidized asphalt based on the total weight of the second formulation.

In some embodiments, the second formulation comprises 10% to 90% by weight of the polymer-modified asphalt based on the total weight of the second formulation. In some embodiments, the second formulation comprises 10% to 85% by weight of the polymer-modified asphalt based on the total weight of the second formulation. In some embodiments, the second formulation comprises 10% to 80% by weight of the polymer-modified asphalt based on the total weight of the second formulation. In some embodiments, the second formulation comprises 10% to 75% by weight of the polymer-modified asphalt based on the total weight of the second formulation. In some embodiments, the second formulation comprises 10% to 70% by weight of the polymer-modified asphalt based on the total weight of the second formulation. In some embodiments, the second formulation comprises 10% to 65% by weight of the polymer-modified asphalt based on the total weight of the second formulation. In some embodiments, the second formulation comprises 10% to 60% by weight of the polymer-modified asphalt based on the total weight of the second formulation. In some embodiments, the second formulation comprises 10% to 55% by weight of the polymer-modified asphalt based on the total weight of the second formulation. In some embodiments, the second formulation comprises 10% to 50% by weight of the polymer-modified asphalt based on the total weight of the second formulation. In some embodiments, the second formulation comprises 10% to 45% by weight of the polymer-modified asphalt based on the total weight of the second formulation. In some embodiments, the second formulation comprises 10% to 40% by weight of the polymer-modified asphalt based on the total weight of the second formulation. In some embodiments, the second formulation comprises 10% to 35% by weight of the polymer-modified asphalt based on the total weight of the second formulation. In some embodiments, the second formulation comprises 10% to 30% by weight of the polymer-modified asphalt based on the total weight of the second formulation. In some embodiments, the second formulation comprises 10% to 25% by weight of the polymer-modified asphalt based on the total weight of the second formulation. In some embodiments, the second formulation comprises 10% to 20% by weight of the polymer-modified asphalt based on the total weight of the second formulation. In some embodiments, the second formulation comprises 10% to 15% by weight of the polymer-modified asphalt based on the total weight of the second formulation.

In some embodiments, the second formulation comprises 15% to 90% by weight of the polymer-modified asphalt based on the total weight of the second formulation. In some embodiments, the second formulation comprises 20% to 90% by weight of the polymer-modified asphalt based on the total weight of the second formulation. In some embodiments, the second formulation comprises 25% to 90% by weight of the polymer-modified asphalt based on the total weight of the second formulation. In some embodiments, the second formulation comprises 30% to 90% by weight of the polymer-modified asphalt based on the total weight of the second formulation. In some embodiments, the second formulation comprises 35% to 90% by weight of the polymer-modified asphalt based on the total weight of the second formulation. In some embodiments, the second formulation comprises 40% to 90% by weight of the polymer-modified asphalt based on the total weight of the second formulation. In some embodiments, the second formulation comprises 45% to 90% by weight of the polymer-modified asphalt based on the total weight of the second formulation. In some embodiments, the second formulation comprises 50% to 90% by weight of the polymer-modified asphalt based on the total weight of the second formulation. In some embodiments, the second formulation comprises 55% to 90% by weight of the polymer-modified asphalt based on the total weight of the second formulation. In some embodiments, the second formulation comprises 60% to 90% by weight of the polymer-modified asphalt based on the total weight of the second formulation. In some embodiments, the second formulation comprises 65% to 90% by weight of the polymer-modified asphalt based on the total weight of the second formulation. In some embodiments, the second formulation comprises 70% to 90% by weight of the polymer-modified asphalt based on the total weight of the second formulation. In some embodiments, the second formulation comprises 75% to 90% by weight of the polymer-modified asphalt based on the total weight of the second formulation. In some embodiments, the second formulation comprises 80% to 90% by weight of the polymer-modified asphalt based on the total weight of the second formulation. In some embodiments, the second formulation comprises 85% to 90% by weight of the polymer-modified asphalt based on the total weight of the second formulation.

In some embodiments, the second formulation comprises 10% to 90% by weight of the waste asphalt based on the total weight of the second formulation. In some embodiments, the second formulation comprises 10% to 85% by weight of the waste asphalt based on the total weight of the second formulation. In some embodiments, the second formulation comprises 10% to 80% by weight of the waste asphalt based on the total weight of the second formulation. In some embodiments, the second formulation comprises 10% to 75% by weight of the waste asphalt based on the total weight of the second formulation. In some embodiments, the second formulation comprises 10% to 70% by weight of the waste asphalt based on the total weight of the second formulation. In some embodiments, the second formulation comprises 10% to 65% by weight of the waste asphalt based on the total weight of the second formulation. In some embodiments, the second formulation comprises 10% to 60% by weight of the waste asphalt based on the total weight of the second formulation. In some embodiments, the second formulation comprises 10% to 55% by weight of the waste asphalt based on the total weight of the second formulation. In some embodiments, the second formulation comprises 10% to 50% by weight of the waste asphalt based on the total weight of the second formulation. In some embodiments, the second formulation comprises 10% to 45% by weight of the waste asphalt based on the total weight of the second formulation. In some embodiments, the second formulation comprises 10% to 40% by weight of the waste asphalt based on the total weight of the second formulation. In some embodiments, the second formulation comprises 10% to 35% by weight of the waste asphalt based on the total weight of the second formulation. In some embodiments, the second formulation comprises 10% to 30% by weight of the waste asphalt based on the total weight of the second formulation. In some embodiments, the second formulation comprises 10% to 25% by weight of the waste asphalt based on the total weight of the second formulation. In some embodiments, the second formulation comprises 10% to 20% by weight of the waste asphalt based on the total weight of the second formulation. In some embodiments, the second formulation comprises 10% to 15% by weight of the waste asphalt based on the total weight of the second formulation.

In some embodiments, the second formulation comprises 15% to 90% by weight of the waste asphalt based on the total weight of the second formulation. In some embodiments, the second formulation comprises 20% to 90% by weight of the waste asphalt based on the total weight of the second formulation. In some embodiments, the second formulation comprises 25% to 90% by weight of the waste asphalt based on the total weight of the second formulation. In some embodiments, the second formulation comprises 30% to 90% by weight of the waste asphalt based on the total weight of the second formulation. In some embodiments, the second formulation comprises 35% to 90% by weight of the waste asphalt based on the total weight of the second formulation. In some embodiments, the second formulation comprises 40% to 90% by weight of the waste asphalt based on the total weight of the second formulation. In some embodiments, the second formulation comprises 45% to 90% by weight of the waste asphalt based on the total weight of the second formulation. In some embodiments, the second formulation comprises 50% to 90% by weight of the waste asphalt based on the total weight of the second formulation. In some embodiments, the second formulation comprises 55% to 90% by weight of the waste asphalt based on the total weight of the second formulation. In some embodiments, the second formulation comprises 60% to 90% by weight of the waste asphalt based on the total weight of the second formulation. In some embodiments, the second formulation comprises 65% to 90% by weight of the waste asphalt based on the total weight of the second formulation. In some embodiments, the second formulation comprises 70% to 90% by weight of the waste asphalt based on the total weight of the second formulation. In some embodiments, the second formulation comprises 75% to 90% by weight of the waste asphalt based on the total weight of the second formulation. In some embodiments, the second formulation comprises 80% to 90% by weight of the waste asphalt based on the total weight of the second formulation. In some embodiments, the second formulation comprises 85% to 90% by weight of the waste asphalt based on the total weight of the second formulation.

In some embodiments, the second formulation comprises 10% to 90% by weight of the asphalt shingle waste based on the total weight of the second formulation. In some embodiments, the second formulation comprises 10% to 85% by weight of the asphalt shingle waste based on the total weight of the second formulation. In some embodiments, the second formulation comprises 10% to 80% by weight of the asphalt shingle waste based on the total weight of the second formulation. In some embodiments, the second formulation comprises 10% to 75% by weight of the asphalt shingle waste based on the total weight of the second formulation. In some embodiments, the second formulation comprises 10% to 70% by weight of the asphalt shingle waste based on the total weight of the second formulation. In some embodiments, the second formulation comprises 10% to 65% by weight of the asphalt shingle waste based on the total weight of the second formulation. In some embodiments, the second formulation comprises 10% to 60% by weight of the asphalt shingle waste based on the total weight of the second formulation. In some embodiments, the second formulation comprises 10% to 55% by weight of the asphalt shingle waste based on the total weight of the second formulation. In some embodiments, the second formulation comprises 10% to 50% by weight of the asphalt shingle waste based on the total weight of the second formulation. In some embodiments, the second formulation comprises 10% to 45% by weight of the asphalt shingle waste based on the total weight of the second formulation. In some embodiments, the second formulation comprises 10% to 40% by weight of the asphalt shingle waste based on the total weight of the second formulation. In some embodiments, the second formulation comprises 10% to 35% by weight of the asphalt shingle waste based on the total weight of the second formulation. In some embodiments, the second formulation comprises 10% to 30% by weight of the asphalt shingle waste based on the total weight of the second formulation. In some embodiments, the second formulation comprises 10% to 25% by weight of the asphalt shingle waste based on the total weight of the second formulation. In some embodiments, the second formulation comprises 10% to 20% by weight of the asphalt shingle waste based on the total weight of the second formulation. In some embodiments, the second formulation comprises 10% to 15% by weight of the asphalt shingle waste based on the total weight of the second formulation.

In some embodiments, the second formulation comprises 15% to 90% by weight of the asphalt shingle waste based on the total weight of the second formulation. In some embodiments, the second formulation comprises 20% to 90% by weight of the asphalt shingle waste based on the total weight of the second formulation. In some embodiments, the second formulation comprises 25% to 90% by weight of the asphalt shingle waste based on the total weight of the second formulation. In some embodiments, the second formulation comprises 30% to 90% by weight of the asphalt shingle waste based on the total weight of the second formulation. In some embodiments, the second formulation comprises 35% to 90% by weight of the asphalt shingle waste based on the total weight of the second formulation. In some embodiments, the second formulation comprises 40% to 90% by weight of the asphalt shingle waste based on the total weight of the second formulation. In some embodiments, the second formulation comprises 45% to 90% by weight of the asphalt shingle waste based on the total weight of the second formulation. In some embodiments, the second formulation comprises 50% to 90% by weight of the asphalt shingle waste based on the total weight of the second formulation. In some embodiments, the second formulation comprises 55% to 90% by weight of the asphalt shingle waste based on the total weight of the second formulation. In some embodiments, the second formulation comprises 60% to 90% by weight of the asphalt shingle waste based on the total weight of the second formulation. In some embodiments, the second formulation comprises 65% to 90% by weight of the asphalt shingle waste based on the total weight of the second formulation. In some embodiments, the second formulation comprises 70% to 90% by weight of the asphalt shingle waste based on the total weight of the second formulation. In some embodiments, the second formulation comprises 75% to 90% by weight of the asphalt shingle waste based on the total weight of the second formulation. In some embodiments, the second formulation comprises 80% to 90% by weight of the asphalt shingle waste based on the total weight of the second formulation. In some embodiments, the second formulation comprises 85% to 90% by weight of the asphalt shingle waste based on the total weight of the second formulation.

In some embodiments, the second formulation comprises 10% to 90% by weight of the asphalt pavement waste based on the total weight of the second formulation. In some embodiments, the second formulation comprises 10% to 85% by weight of the asphalt pavement waste based on the total weight of the second formulation. In some embodiments, the second formulation comprises 10% to 80% by weight of the asphalt pavement waste based on the total weight of the second formulation. In some embodiments, the second formulation comprises 10% to 75% by weight of the asphalt pavement waste based on the total weight of the second formulation. In some embodiments, the second formulation comprises 10% to 70% by weight of the asphalt pavement waste based on the total weight of the second formulation. In some embodiments, the second formulation comprises 10% to 65% by weight of the asphalt pavement waste based on the total weight of the second formulation. In some embodiments, the second formulation comprises 10% to 60% by weight of the asphalt pavement waste based on the total weight of the second formulation. In some embodiments, the second formulation comprises 10% to 55% by weight of the asphalt pavement waste based on the total weight of the second formulation. In some embodiments, the second formulation comprises 10% to 50% by weight of the asphalt pavement waste based on the total weight of the second formulation. In some embodiments, the second formulation comprises 10% to 45% by weight of the asphalt pavement waste based on the total weight of the second formulation. In some embodiments, the second formulation comprises 10% to 40% by weight of the asphalt pavement waste based on the total weight of the second formulation. In some embodiments, the second formulation comprises 10% to 35% by weight of the asphalt pavement waste based on the total weight of the second formulation. In some embodiments, the second formulation comprises 10% to 30% by weight of the asphalt pavement waste based on the total weight of the second formulation. In some embodiments, the second formulation comprises 10% to 25% by weight of the asphalt pavement waste based on the total weight of the second formulation. In some embodiments, the second formulation comprises 10% to 20% by weight of the asphalt pavement waste based on the total weight of the second formulation. In some embodiments, the second formulation comprises 10% to 15% by weight of the asphalt pavement waste based on the total weight of the second formulation.

In some embodiments, the second formulation comprises 15% to 90% by weight of the asphalt pavement waste based on the total weight of the second formulation. In some embodiments, the second formulation comprises 20% to 90% by weight of the asphalt pavement waste based on the total weight of the second formulation. In some embodiments, the second formulation comprises 25% to 90% by weight of the asphalt pavement waste based on the total weight of the second formulation. In some embodiments, the second formulation comprises 30% to 90% by weight of the asphalt pavement waste based on the total weight of the second formulation. In some embodiments, the second formulation comprises 35% to 90% by weight of the asphalt pavement waste based on the total weight of the second formulation. In some embodiments, the second formulation comprises 40% to 90% by weight of the asphalt pavement waste based on the total weight of the second formulation. In some embodiments, the second formulation comprises 45% to 90% by weight of the asphalt pavement waste based on the total weight of the second formulation. In some embodiments, the second formulation comprises 50% to 90% by weight of the asphalt pavement waste based on the total weight of the second formulation. In some embodiments, the second formulation comprises 55% to 90% by weight of the asphalt pavement waste based on the total weight of the second formulation. In some embodiments, the second formulation comprises 60% to 90% by weight of the asphalt pavement waste based on the total weight of the second formulation. In some embodiments, the second formulation comprises 65% to 90% by weight of the asphalt pavement waste based on the total weight of the second formulation. In some embodiments, the second formulation comprises 70% to 90% by weight of the asphalt pavement waste based on the total weight of the second formulation. In some embodiments, the second formulation comprises 75% to 90% by weight of the asphalt pavement waste based on the total weight of the second formulation. In some embodiments, the second formulation comprises 80% to 90% by weight of the asphalt pavement waste based on the total weight of the second formulation. In some embodiments, the second formulation comprises 85% to 90% by weight of the asphalt pavement waste based on the total weight of the second formulation.

In some embodiments, the asphalt component comprises 1% to 99% by weight of the asphalt based on a total weight of the asphalt component. In some embodiments, the asphalt component comprises 1% to 95% by weight of the asphalt based on a total weight of the asphalt component. In some embodiments, the asphalt component comprises 1% to 90% by weight of the asphalt based on a total weight of the asphalt component. In some embodiments, the asphalt component comprises 1% to 85% by weight of the asphalt based on a total weight of the asphalt component. In some embodiments, the asphalt component comprises 1% to 80% by weight of the asphalt based on a total weight of the asphalt component. In some embodiments, the asphalt component comprises 1% to 75% by weight of the asphalt based on a total weight of the asphalt component. In some embodiments, the asphalt component comprises 1% to 70% by weight of the asphalt based on a total weight of the asphalt component. In some embodiments, the asphalt component comprises 1% to 65% by weight of the asphalt based on a total weight of the asphalt component. In some embodiments, the asphalt component comprises 1% to 60% by weight of the asphalt based on a total weight of the asphalt component. In some embodiments, the asphalt component comprises 1% to 55% by weight of the asphalt based on a total weight of the asphalt component. In some embodiments, the asphalt component comprises 1% to 50% by weight of the asphalt based on a total weight of the asphalt component. In some embodiments, the asphalt component comprises 1% to 45% by weight of the asphalt based on a total weight of the asphalt component. In some embodiments, the asphalt component comprises 1% to 40% by weight of the asphalt based on a total weight of the asphalt component. In some embodiments, the asphalt component comprises 1% to 35% by weight of the asphalt based on a total weight of the asphalt component. In some embodiments, the asphalt component comprises 1% to 30% by weight of the asphalt based on a total weight of the asphalt component. In some embodiments, the asphalt component comprises 1% to 25% by weight of the asphalt based on a total weight of the asphalt component. In some embodiments, the asphalt component comprises 1% to 20% by weight of the asphalt based on a total weight of the asphalt component. In some embodiments, the asphalt component comprises 1% to 15% by weight of the asphalt based on a total weight of the asphalt component. In some embodiments, the asphalt component comprises 1% to 10% by weight of the asphalt based on a total weight of the asphalt component. In some embodiments, the asphalt component comprises 1% to 5% by weight of the asphalt based on a total weight of the asphalt component.

In some embodiments, the asphalt component comprises 5% to 99% by weight of the asphalt based on a total weight of the asphalt component. In some embodiments, the asphalt component comprises 10% to 99% by weight of the asphalt based on a total weight of the asphalt component. In some embodiments, the asphalt component comprises 15% to 99% by weight of the asphalt based on a total weight of the asphalt component. In some embodiments, the asphalt component comprises 20% to 99% by weight of the asphalt based on a total weight of the asphalt component. In some embodiments, the asphalt component comprises 25% to 99% by weight of the asphalt based on a total weight of the asphalt component. In some embodiments, the asphalt component comprises 30% to 99% by weight of the asphalt based on a total weight of the asphalt component. In some embodiments, the asphalt component comprises 35% to 99% by weight of the asphalt based on a total weight of the asphalt component. In some embodiments, the asphalt component comprises 40% to 99% by weight of the asphalt based on a total weight of the asphalt component. In some embodiments, the asphalt component comprises 45% to 99% by weight of the asphalt based on a total weight of the asphalt component. In some embodiments, the asphalt component comprises 50% to 99% by weight of the asphalt based on a total weight of the asphalt component. In some embodiments, the asphalt component comprises 55% to 99% by weight of the asphalt based on a total weight of the asphalt component. In some embodiments, the asphalt component comprises 60% to 99% by weight of the asphalt based on a total weight of the asphalt component. In some embodiments, the asphalt component comprises 65% to 99% by weight of the asphalt based on a total weight of the asphalt component. In some embodiments, the asphalt component comprises 70% to 99% by weight of the asphalt based on a total weight of the asphalt component. In some embodiments, the asphalt component comprises 75% to 99% by weight of the asphalt based on a total weight of the asphalt component. In some embodiments, the asphalt component comprises 80% to 99% by weight of the asphalt based on a total weight of the asphalt component. In some embodiments, the asphalt component comprises 85% to 99% by weight of the asphalt based on a total weight of the asphalt component. In some embodiments, the asphalt component comprises 90% to 99% by weight of the asphalt based on a total weight of the asphalt component. In some embodiments, the asphalt component comprises 95% to 99% by weight of the asphalt based on a total weight of the asphalt component.

In some embodiments, the asphalt component comprises 1% to 99% by weight of the oxidized asphalt based on the total weight of the asphalt component. In some embodiments, the asphalt component comprises 1% to 95% by weight of the oxidized asphalt based on the total weight of the asphalt component. In some embodiments, the asphalt component comprises 1% to 90% by weight of the oxidized asphalt based on the total weight of the asphalt component. In some embodiments, the asphalt component comprises 1% to 85% by weight of the oxidized asphalt based on the total weight of the asphalt component. In some embodiments, the asphalt component comprises 1% to 80% by weight of the oxidized asphalt based on the total weight of the asphalt component. In some embodiments, the asphalt component comprises 1% to 75% by weight of the oxidized asphalt based on the total weight of the asphalt component. In some embodiments, the asphalt component comprises 1% to 70% by weight of the oxidized asphalt based on the total weight of the asphalt component. In some embodiments, the asphalt component comprises 1% to 65% by weight of the oxidized asphalt based on the total weight of the asphalt component. In some embodiments, the asphalt component comprises 1% to 60% by weight of the oxidized asphalt based on the total weight of the asphalt component. In some embodiments, the asphalt component comprises 1% to 55% by weight of the oxidized asphalt based on the total weight of the asphalt component. In some embodiments, the asphalt component comprises 1% to 50% by weight of the oxidized asphalt based on the total weight of the asphalt component. In some embodiments, the asphalt component comprises 1% to 45% by weight of the oxidized asphalt based on the total weight of the asphalt component. In some embodiments, the asphalt component comprises 1% to 40% by weight of the oxidized asphalt based on the total weight of the asphalt component. In some embodiments, the asphalt component comprises 1% to 35% by weight of the oxidized asphalt based on the total weight of the asphalt component. In some embodiments, the asphalt component comprises 1% to 30% by weight of the oxidized asphalt based on the total weight of the asphalt component. In some embodiments, the asphalt component comprises 1% to 25% by weight of the oxidized asphalt based on the total weight of the asphalt component. In some embodiments, the asphalt component comprises 1% to 20% by weight of the oxidized asphalt based on the total weight of the asphalt component. In some embodiments, the asphalt component comprises 1% to 15% by weight of the oxidized asphalt based on the total weight of the asphalt component. In some embodiments, the asphalt component comprises 1% to 10% by weight of the oxidized asphalt based on the total weight of the asphalt component. In some embodiments, the asphalt component comprises 1% to 5% by weight of the oxidized asphalt based on the total weight of the asphalt component.

In some embodiments, the asphalt component comprises 5% to 99% by weight of the oxidized asphalt based on the total weight of the asphalt component. In some embodiments, the asphalt component comprises 10% to 99% by weight of the oxidized asphalt based on the total weight of the asphalt component. In some embodiments, the asphalt component comprises 15% to 99% by weight of the oxidized asphalt based on the total weight of the asphalt component. In some embodiments, the asphalt component comprises 20% to 99% by weight of the oxidized asphalt based on the total weight of the asphalt component. In some embodiments, the asphalt component comprises 25% to 99% by weight of the oxidized asphalt based on the total weight of the asphalt component. In some embodiments, the asphalt component comprises 30% to 99% by weight of the oxidized asphalt based on the total weight of the asphalt component. In some embodiments, the asphalt component comprises 35% to 99% by weight of the oxidized asphalt based on the total weight of the asphalt component. In some embodiments, the asphalt component comprises 40% to 99% by weight of the oxidized asphalt based on the total weight of the asphalt component. In some embodiments, the asphalt component comprises 45% to 99% by weight of the oxidized asphalt based on the total weight of the asphalt component. In some embodiments, the asphalt component comprises 50% to 99% by weight of the oxidized asphalt based on the total weight of the asphalt component. In some embodiments, the asphalt component comprises 55% to 99% by weight of the oxidized asphalt based on the total weight of the asphalt component. In some embodiments, the asphalt component comprises 60% to 99% by weight of the oxidized asphalt based on the total weight of the asphalt component. In some embodiments, the asphalt component comprises 65% to 99% by weight of the oxidized asphalt based on the total weight of the asphalt component. In some embodiments, the asphalt component comprises 70% to 99% by weight of the oxidized asphalt based on the total weight of the asphalt component. In some embodiments, the asphalt component comprises 75% to 99% by weight of the oxidized asphalt based on the total weight of the asphalt component. In some embodiments, the asphalt component comprises 80% to 99% by weight of the oxidized asphalt based on the total weight of the asphalt component. In some embodiments, the asphalt component comprises 85% to 99% by weight of the oxidized asphalt based on the total weight of the asphalt component. In some embodiments, the asphalt component comprises 90% to 99% by weight of the oxidized asphalt based on the total weight of the asphalt component. In some embodiments, the asphalt component comprises 95% to 99% by weight of the oxidized asphalt based on the total weight of the asphalt component.

In some embodiments, the asphalt component comprises 1% to 99% by weight of the unoxidized asphalt based on the total weight of the asphalt component. In some embodiments, the asphalt component comprises 1% to 95% by weight of the unoxidized asphalt based on the total weight of the asphalt component. In some embodiments, the asphalt component comprises 1% to 90% by weight of the unoxidized asphalt based on the total weight of the asphalt component. In some embodiments, the asphalt component comprises 1% to 85% by weight of the unoxidized asphalt based on the total weight of the asphalt component. In some embodiments, the asphalt component comprises 1% to 80% by weight of the unoxidized asphalt based on the total weight of the asphalt component. In some embodiments, the asphalt component comprises 1% to 75% by weight of the unoxidized asphalt based on the total weight of the asphalt component. In some embodiments, the asphalt component comprises 1% to 70% by weight of the unoxidized asphalt based on the total weight of the asphalt component. In some embodiments, the asphalt component comprises 1% to 65% by weight of the unoxidized asphalt based on the total weight of the asphalt component. In some embodiments, the asphalt component comprises 1% to 60% by weight of the unoxidized asphalt based on the total weight of the asphalt component. In some embodiments, the asphalt component comprises 1% to 55% by weight of the unoxidized asphalt based on the total weight of the asphalt component. In some embodiments, the asphalt component comprises 1% to 50% by weight of the unoxidized asphalt based on the total weight of the asphalt component. In some embodiments, the asphalt component comprises 1% to 45% by weight of the unoxidized asphalt based on the total weight of the asphalt component. In some embodiments, the asphalt component comprises 1% to 40% by weight of the unoxidized asphalt based on the total weight of the asphalt component. In some embodiments, the asphalt component comprises 1% to 35% by weight of the unoxidized asphalt based on the total weight of the asphalt component. In some embodiments, the asphalt component comprises 1% to 30% by weight of the unoxidized asphalt based on the total weight of the asphalt component. In some embodiments, the asphalt component comprises 1% to 25% by weight of the unoxidized asphalt based on the total weight of the asphalt component. In some embodiments, the asphalt component comprises 1% to 20% by weight of the unoxidized asphalt based on the total weight of the asphalt component. In some embodiments, the asphalt component comprises 1% to 15% by weight of the unoxidized asphalt based on the total weight of the asphalt component. In some embodiments, the asphalt component comprises 1% to 10% by weight of the unoxidized asphalt based on the total weight of the asphalt component. In some embodiments, the asphalt component comprises 1% to 5% by weight of the unoxidized asphalt based on the total weight of the asphalt component.

In some embodiments, the asphalt component comprises 5% to 99% by weight of the unoxidized asphalt based on the total weight of the asphalt component. In some embodiments, the asphalt component comprises 10% to 99% by weight of the unoxidized asphalt based on the total weight of the asphalt component. In some embodiments, the asphalt component comprises 15% to 99% by weight of the unoxidized asphalt based on the total weight of the asphalt component. In some embodiments, the asphalt component comprises 20% to 99% by weight of the unoxidized asphalt based on the total weight of the asphalt component. In some embodiments, the asphalt component comprises 25% to 99% by weight of the unoxidized asphalt based on the total weight of the asphalt component. In some embodiments, the asphalt component comprises 30% to 99% by weight of the unoxidized asphalt based on the total weight of the asphalt component. In some embodiments, the asphalt component comprises 35% to 99% by weight of the unoxidized asphalt based on the total weight of the asphalt component. In some embodiments, the asphalt component comprises 40% to 99% by weight of the unoxidized asphalt based on the total weight of the asphalt component. In some embodiments, the asphalt component comprises 45% to 99% by weight of the unoxidized asphalt based on the total weight of the asphalt component. In some embodiments, the asphalt component comprises 50% to 99% by weight of the unoxidized asphalt based on the total weight of the asphalt component. In some embodiments, the asphalt component comprises 55% to 99% by weight of the unoxidized asphalt based on the total weight of the asphalt component. In some embodiments, the asphalt component comprises 60% to 99% by weight of the unoxidized asphalt based on the total weight of the asphalt component. In some embodiments, the asphalt component comprises 65% to 99% by weight of the unoxidized asphalt based on the total weight of the asphalt component. In some embodiments, the asphalt component comprises 70% to 99% by weight of the unoxidized asphalt based on the total weight of the asphalt component. In some embodiments, the asphalt component comprises 75% to 99% by weight of the unoxidized asphalt based on the total weight of the asphalt component. In some embodiments, the asphalt component comprises 80% to 99% by weight of the unoxidized asphalt based on the total weight of the asphalt component. In some embodiments, the asphalt component comprises 85% to 99% by weight of the unoxidized asphalt based on the total weight of the asphalt component. In some embodiments, the asphalt component comprises 90% to 99% by weight of the unoxidized asphalt based on the total weight of the asphalt component. In some embodiments, the asphalt component comprises 95% to 99% by weight of the unoxidized asphalt based on the total weight of the asphalt component.

In some embodiments, the asphalt component comprises 1% to 99% by weight of the polymer-modified asphalt based on the total weight of the asphalt component. In some embodiments, the asphalt component comprises 1% to 95% by weight of the polymer-modified asphalt based on the total weight of the asphalt component. In some embodiments, the asphalt component comprises 1% to 90% by weight of the polymer-modified asphalt based on the total weight of the asphalt component. In some embodiments, the asphalt component comprises 1% to 85% by weight of the polymer-modified asphalt based on the total weight of the asphalt component. In some embodiments, the asphalt component comprises 1% to 80% by weight of the polymer-modified asphalt based on the total weight of the asphalt component. In some embodiments, the asphalt component comprises 1% to 75% by weight of the polymer-modified asphalt based on the total weight of the asphalt component. In some embodiments, the asphalt component comprises 1% to 70% by weight of the polymer-modified asphalt based on the total weight of the asphalt component. In some embodiments, the asphalt component comprises 1% to 65% by weight of the polymer-modified asphalt based on the total weight of the asphalt component. In some embodiments, the asphalt component comprises 1% to 60% by weight of the polymer-modified asphalt based on the total weight of the asphalt component. In some embodiments, the asphalt component comprises 1% to 55% by weight of the polymer-modified asphalt based on the total weight of the asphalt component. In some embodiments, the asphalt component comprises 1% to 50% by weight of the polymer-modified asphalt based on the total weight of the asphalt component. In some embodiments, the asphalt component comprises 1% to 45% by weight of the polymer-modified asphalt based on the total weight of the asphalt component. In some embodiments, the asphalt component comprises 1% to 40% by weight of the polymer-modified asphalt based on the total weight of the asphalt component. In some embodiments, the asphalt component comprises 1% to 35% by weight of the polymer-modified asphalt based on the total weight of the asphalt component. In some embodiments, the asphalt component comprises 1% to 30% by weight of the polymer-modified asphalt based on the total weight of the asphalt component. In some embodiments, the asphalt component comprises 1% to 25% by weight of the polymer-modified asphalt based on the total weight of the asphalt component. In some embodiments, the asphalt component comprises 1% to 20% by weight of the polymer-modified asphalt based on the total weight of the asphalt component. In some embodiments, the asphalt component comprises 1% to 15% by weight of the polymer-modified asphalt based on the total weight of the asphalt component. In some embodiments, the asphalt component comprises 1% to 10% by weight of the polymer-modified asphalt based on the total weight of the asphalt component. In some embodiments, the asphalt component comprises 1% to 5% by weight of the polymer-modified asphalt based on the total weight of the asphalt component.

In some embodiments, the asphalt component comprises 5% to 99% by weight of the polymer-modified asphalt based on the total weight of the asphalt component. In some embodiments, the asphalt component comprises 10% to 99% by weight of the polymer-modified asphalt based on the total weight of the asphalt component. In some embodiments, the asphalt component comprises 15% to 99% by weight of the polymer-modified asphalt based on the total weight of the asphalt component. In some embodiments, the asphalt component comprises 20% to 99% by weight of the polymer-modified asphalt based on the total weight of the asphalt component. In some embodiments, the asphalt component comprises 25% to 99% by weight of the polymer-modified asphalt based on the total weight of the asphalt component. In some embodiments, the asphalt component comprises 30% to 99% by weight of the polymer-modified asphalt based on the total weight of the asphalt component. In some embodiments, the asphalt component comprises 35% to 99% by weight of the polymer-modified asphalt based on the total weight of the asphalt component. In some embodiments, the asphalt component comprises 40% to 99% by weight of the polymer-modified asphalt based on the total weight of the asphalt component. In some embodiments, the asphalt component comprises 45% to 99% by weight of the polymer-modified asphalt based on the total weight of the asphalt component. In some embodiments, the asphalt component comprises 50% to 99% by weight of the polymer-modified asphalt based on the total weight of the asphalt component. In some embodiments, the asphalt component comprises 55% to 99% by weight of the polymer-modified asphalt based on the total weight of the asphalt component. In some embodiments, the asphalt component comprises 60% to 99% by weight of the polymer-modified asphalt based on the total weight of the asphalt component. In some embodiments, the asphalt component comprises 65% to 99% by weight of the polymer-modified asphalt based on the total weight of the asphalt component. In some embodiments, the asphalt component comprises 70% to 99% by weight of the polymer-modified asphalt based on the total weight of the asphalt component. In some embodiments, the asphalt component comprises 75% to 99% by weight of the polymer-modified asphalt based on the total weight of the asphalt component. In some embodiments, the asphalt component comprises 80% to 99% by weight of the polymer-modified asphalt based on the total weight of the asphalt component. In some embodiments, the asphalt component comprises 85% to 99% by weight of the polymer-modified asphalt based on the total weight of the asphalt component. In some embodiments, the asphalt component comprises 90% to 99% by weight of the polymer-modified asphalt based on the total weight of the asphalt component. In some embodiments, the asphalt component comprises 95% to 99% by weight of the polymer-modified asphalt based on the total weight of the asphalt component.

In some embodiments, the asphalt component comprises 1% to 99% by weight of the waste asphalt based on the total weight of the asphalt component. In some embodiments, the asphalt component comprises 1% to 95% by weight of the waste asphalt based on the total weight of the asphalt component. In some embodiments, the asphalt component comprises 1% to 90% by weight of the waste asphalt based on the total weight of the asphalt component. In some embodiments, the asphalt component comprises 1% to 85% by weight of the waste asphalt based on the total weight of the asphalt component. In some embodiments, the asphalt component comprises 1% to 80% by weight of the waste asphalt based on the total weight of the asphalt component. In some embodiments, the asphalt component comprises 1% to 75% by weight of the waste asphalt based on the total weight of the asphalt component. In some embodiments, the asphalt component comprises 1% to 70% by weight of the waste asphalt based on the total weight of the asphalt component. In some embodiments, the asphalt component comprises 1% to 65% by weight of the waste asphalt based on the total weight of the asphalt component. In some embodiments, the asphalt component comprises 1% to 60% by weight of the waste asphalt based on the total weight of the asphalt component. In some embodiments, the asphalt component comprises 1% to 55% by weight of the waste asphalt based on the total weight of the asphalt component. In some embodiments, the asphalt component comprises 1% to 50% by weight of the waste asphalt based on the total weight of the asphalt component. In some embodiments, the asphalt component comprises 1% to 45% by weight of the waste asphalt based on the total weight of the asphalt component. In some embodiments, the asphalt component comprises 1% to 40% by weight of the waste asphalt based on the total weight of the asphalt component. In some embodiments, the asphalt component comprises 1% to 35% by weight of the waste asphalt based on the total weight of the asphalt component. In some embodiments, the asphalt component comprises 1% to 30% by weight of the waste asphalt based on the total weight of the asphalt component. In some embodiments, the asphalt component comprises 1% to 25% by weight of the waste asphalt based on the total weight of the asphalt component. In some embodiments, the asphalt component comprises 1% to 20% by weight of the waste asphalt based on the total weight of the asphalt component. In some embodiments, the asphalt component comprises 1% to 15% by weight of the waste asphalt based on the total weight of the asphalt component. In some embodiments, the asphalt component comprises 1% to 10% by weight of the waste asphalt based on the total weight of the asphalt component. In some embodiments, the asphalt component comprises 1% to 5% by weight of the waste asphalt based on the total weight of the asphalt component.

In some embodiments, the asphalt component comprises 5% to 99% by weight of the waste asphalt based on the total weight of the asphalt component. In some embodiments, the asphalt component comprises 10% to 99% by weight of the waste asphalt based on the total weight of the asphalt component. In some embodiments, the asphalt component comprises 15% to 99% by weight of the waste asphalt based on the total weight of the asphalt component. In some embodiments, the asphalt component comprises 20% to 99% by weight of the waste asphalt based on the total weight of the asphalt component. In some embodiments, the asphalt component comprises 25% to 99% by weight of the waste asphalt based on the total weight of the asphalt component. In some embodiments, the asphalt component comprises 30% to 99% by weight of the waste asphalt based on the total weight of the asphalt component. In some embodiments, the asphalt component comprises 35% to 99% by weight of the waste asphalt based on the total weight of the asphalt component. In some embodiments, the asphalt component comprises 40% to 99% by weight of the waste asphalt based on the total weight of the asphalt component. In some embodiments, the asphalt component comprises 45% to 99% by weight of the waste asphalt based on the total weight of the asphalt component. In some embodiments, the asphalt component comprises 50% to 99% by weight of the waste asphalt based on the total weight of the asphalt component. In some embodiments, the asphalt component comprises 55% to 99% by weight of the waste asphalt based on the total weight of the asphalt component. In some embodiments, the asphalt component comprises 60% to 99% by weight of the waste asphalt based on the total weight of the asphalt component. In some embodiments, the asphalt component comprises 65% to 99% by weight of the waste asphalt based on the total weight of the asphalt component. In some embodiments, the asphalt component comprises 70% to 99% by weight of the waste asphalt based on the total weight of the asphalt component. In some embodiments, the asphalt component comprises 75% to 99% by weight of the waste asphalt based on the total weight of the asphalt component. In some embodiments, the asphalt component comprises 80% to 99% by weight of the waste asphalt based on the total weight of the asphalt component. In some embodiments, the asphalt component comprises 85% to 99% by weight of the waste asphalt based on the total weight of the asphalt component. In some embodiments, the asphalt component comprises 90% to 99% by weight of the waste asphalt based on the total weight of the asphalt component. In some embodiments, the asphalt component comprises 95% to 99% by weight of the waste asphalt based on the total weight of the asphalt component.

In some embodiments, the asphalt component comprises 1% to 99% by weight of the asphalt shingle waste based on the total weight of the asphalt component. In some embodiments, the asphalt component comprises 1% to 95% by weight of the asphalt shingle waste based on the total weight of the asphalt component. In some embodiments, the asphalt component comprises 1% to 90% by weight of the asphalt shingle waste based on the total weight of the asphalt component. In some embodiments, the asphalt component comprises 1% to 85% by weight of the asphalt shingle waste based on the total weight of the asphalt component. In some embodiments, the asphalt component comprises 1% to 80% by weight of the asphalt shingle waste based on the total weight of the asphalt component. In some embodiments, the asphalt component comprises 1% to 75% by weight of the asphalt shingle waste based on the total weight of the asphalt component. In some embodiments, the asphalt component comprises 1% to 70% by weight of the asphalt shingle waste based on the total weight of the asphalt component. In some embodiments, the asphalt component comprises 1% to 65% by weight of the asphalt shingle waste based on the total weight of the asphalt component. In some embodiments, the asphalt component comprises 1% to 60% by weight of the asphalt shingle waste based on the total weight of the asphalt component. In some embodiments, the asphalt component comprises 1% to 55% by weight of the asphalt shingle waste based on the total weight of the asphalt component. In some embodiments, the asphalt component comprises 1% to 50% by weight of the asphalt shingle waste based on the total weight of the asphalt component. In some embodiments, the asphalt component comprises 1% to 45% by weight of the asphalt shingle waste based on the total weight of the asphalt component. In some embodiments, the asphalt component comprises 1% to 40% by weight of the asphalt shingle waste based on the total weight of the asphalt component. In some embodiments, the asphalt component comprises 1% to 35% by weight of the asphalt shingle waste based on the total weight of the asphalt component. In some embodiments, the asphalt component comprises 1% to 30% by weight of the asphalt shingle waste based on the total weight of the asphalt component. In some embodiments, the asphalt component comprises 1% to 25% by weight of the asphalt shingle waste based on the total weight of the asphalt component. In some embodiments, the asphalt component comprises 1% to 20% by weight of the asphalt shingle waste based on the total weight of the asphalt component. In some embodiments, the asphalt component comprises 1% to 15% by weight of the asphalt shingle waste based on the total weight of the asphalt component. In some embodiments, the asphalt component comprises 1% to 10% by weight of the asphalt shingle waste based on the total weight of the asphalt component. In some embodiments, the asphalt component comprises 1% to 5% by weight of the asphalt shingle waste based on the total weight of the asphalt component.

In some embodiments, the asphalt component comprises 5% to 99% by weight of the asphalt shingle waste based on the total weight of the asphalt component. In some embodiments, the asphalt component comprises 10% to 99% by weight of the asphalt shingle waste based on the total weight of the asphalt component. In some embodiments, the asphalt component comprises 15% to 99% by weight of the asphalt shingle waste based on the total weight of the asphalt component. In some embodiments, the asphalt component comprises 20% to 99% by weight of the asphalt shingle waste based on the total weight of the asphalt component. In some embodiments, the asphalt component comprises 25% to 99% by weight of the asphalt shingle waste based on the total weight of the asphalt component. In some embodiments, the asphalt component comprises 30% to 99% by weight of the asphalt shingle waste based on the total weight of the asphalt component. In some embodiments, the asphalt component comprises 35% to 99% by weight of the asphalt shingle waste based on the total weight of the asphalt component. In some embodiments, the asphalt component comprises 40% to 99% by weight of the asphalt shingle waste based on the total weight of the asphalt component. In some embodiments, the asphalt component comprises 45% to 99% by weight of the asphalt shingle waste based on the total weight of the asphalt component. In some embodiments, the asphalt component comprises 50% to 99% by weight of the asphalt shingle waste based on the total weight of the asphalt component. In some embodiments, the asphalt component comprises 55% to 99% by weight of the asphalt shingle waste based on the total weight of the asphalt component. In some embodiments, the asphalt component comprises 60% to 99% by weight of the asphalt shingle waste based on the total weight of the asphalt component. In some embodiments, the asphalt component comprises 65% to 99% by weight of the asphalt shingle waste based on the total weight of the asphalt component. In some embodiments, the asphalt component comprises 70% to 99% by weight of the asphalt shingle waste based on the total weight of the asphalt component. In some embodiments, the asphalt component comprises 75% to 99% by weight of the asphalt shingle waste based on the total weight of the asphalt component. In some embodiments, the asphalt component comprises 80% to 99% by weight of the asphalt shingle waste based on the total weight of the asphalt component. In some embodiments, the asphalt component comprises 85% to 99% by weight of the asphalt shingle waste based on the total weight of the asphalt component. In some embodiments, the asphalt component comprises 90% to 99% by weight of the asphalt shingle waste based on the total weight of the asphalt component. In some embodiments, the asphalt component comprises 95% to 99% by weight of the asphalt shingle waste based on the total weight of the asphalt component.

In some embodiments, the asphalt component comprises 1% to 99% by weight of the asphalt pavement waste based on the total weight of the asphalt component. In some embodiments, the asphalt component comprises 1% to 95% by weight of the asphalt pavement waste based on the total weight of the asphalt component. In some embodiments, the asphalt component comprises 1% to 90% by weight of the asphalt pavement waste based on the total weight of the asphalt component. In some embodiments, the asphalt component comprises 1% to 85% by weight of the asphalt pavement waste based on the total weight of the asphalt component. In some embodiments, the asphalt component comprises 1% to 80% by weight of the asphalt pavement waste based on the total weight of the asphalt component. In some embodiments, the asphalt component comprises 1% to 75% by weight of the asphalt pavement waste based on the total weight of the asphalt component. In some embodiments, the asphalt component comprises 1% to 70% by weight of the asphalt pavement waste based on the total weight of the asphalt component. In some embodiments, the asphalt component comprises 1% to 65% by weight of the asphalt pavement waste based on the total weight of the asphalt component. In some embodiments, the asphalt component comprises 1% to 60% by weight of the asphalt pavement waste based on the total weight of the asphalt component. In some embodiments, the asphalt component comprises 1% to 55% by weight of the asphalt pavement waste based on the total weight of the asphalt component. In some embodiments, the asphalt component comprises 1% to 50% by weight of the asphalt pavement waste based on the total weight of the asphalt component. In some embodiments, the asphalt component comprises 1% to 45% by weight of the asphalt pavement waste based on the total weight of the asphalt component. In some embodiments, the asphalt component comprises 1% to 40% by weight of the asphalt pavement waste based on the total weight of the asphalt component. In some embodiments, the asphalt component comprises 1% to 35% by weight of the asphalt pavement waste based on the total weight of the asphalt component. In some embodiments, the asphalt component comprises 1% to 30% by weight of the asphalt pavement waste based on the total weight of the asphalt component. In some embodiments, the asphalt component comprises 1% to 25% by weight of the asphalt pavement waste based on the total weight of the asphalt component. In some embodiments, the asphalt component comprises 1% to 20% by weight of the asphalt pavement waste based on the total weight of the asphalt component. In some embodiments, the asphalt component comprises 1% to 15% by weight of the asphalt pavement waste based on the total weight of the asphalt component. In some embodiments, the asphalt component comprises 1% to 10% by weight of the asphalt pavement waste based on the total weight of the asphalt component. In some embodiments, the asphalt component comprises 1% to 5% by weight of the asphalt pavement waste based on the total weight of the asphalt component.

In some embodiments, the asphalt component comprises 5% to 99% by weight of the asphalt pavement waste based on the total weight of the asphalt component. In some embodiments, the asphalt component comprises 10% to 99% by weight of the asphalt pavement waste based on the total weight of the asphalt component. In some embodiments, the asphalt component comprises 15% to 99% by weight of the asphalt pavement waste based on the total weight of the asphalt component. In some embodiments, the asphalt component comprises 20% to 99% by weight of the asphalt pavement waste based on the total weight of the asphalt component. In some embodiments, the asphalt component comprises 25% to 99% by weight of the asphalt pavement waste based on the total weight of the asphalt component. In some embodiments, the asphalt component comprises 30% to 99% by weight of the asphalt pavement waste based on the total weight of the asphalt component. In some embodiments, the asphalt component comprises 35% to 99% by weight of the asphalt pavement waste based on the total weight of the asphalt component. In some embodiments, the asphalt component comprises 40% to 99% by weight of the asphalt pavement waste based on the total weight of the asphalt component. In some embodiments, the asphalt component comprises 45% to 99% by weight of the asphalt pavement waste based on the total weight of the asphalt component. In some embodiments, the asphalt component comprises 50% to 99% by weight of the asphalt pavement waste based on the total weight of the asphalt component. In some embodiments, the asphalt component comprises 55% to 99% by weight of the asphalt pavement waste based on the total weight of the asphalt component. In some embodiments, the asphalt component comprises 60% to 99% by weight of the asphalt pavement waste based on the total weight of the asphalt component. In some embodiments, the asphalt component comprises 65% to 99% by weight of the asphalt pavement waste based on the total weight of the asphalt component. In some embodiments, the asphalt component comprises 70% to 99% by weight of the asphalt pavement waste based on the total weight of the asphalt component. In some embodiments, the asphalt component comprises 75% to 99% by weight of the asphalt pavement waste based on the total weight of the asphalt component. In some embodiments, the asphalt component comprises 80% to 99% by weight of the asphalt pavement waste based on the total weight of the asphalt component. In some embodiments, the asphalt component comprises 85% to 99% by weight of the asphalt pavement waste based on the total weight of the asphalt component. In some embodiments, the asphalt component comprises 90% to 99% by weight of the asphalt pavement waste based on the total weight of the asphalt component. In some embodiments, the asphalt component comprises 95% to 99% by weight of the asphalt pavement waste based on the total weight of the asphalt component.

In some embodiments, the asphalt comprises 1% to 99% by weight of the oxidized asphalt based on a total weight of the asphalt. In some embodiments, the asphalt comprises 1% to 95% by weight of the oxidized asphalt based on the total weight of the asphalt. In some embodiments, the asphalt comprises 1% to 90% by weight of the oxidized asphalt based on the total weight of the asphalt. In some embodiments, the asphalt comprises 1% to 85% by weight of the oxidized asphalt based on the total weight of the asphalt. In some embodiments, the asphalt comprises 1% to 80% by weight of the oxidized asphalt based on the total weight of the asphalt. In some embodiments, the asphalt comprises 1% to 75% by weight of the oxidized asphalt based on the total weight of the asphalt. In some embodiments, the asphalt comprises 1% to 70% by weight of the oxidized asphalt based on the total weight of the asphalt. In some embodiments, the asphalt comprises 1% to 65% by weight of the oxidized asphalt based on the total weight of the asphalt. In some embodiments, the asphalt comprises 1% to 60% by weight of the oxidized asphalt based on the total weight of the asphalt. In some embodiments, the asphalt comprises 1% to 55% by weight of the oxidized asphalt based on the total weight of the asphalt. In some embodiments, the asphalt comprises 1% to 50% by weight of the oxidized asphalt based on the total weight of the asphalt. In some embodiments, the asphalt comprises 1% to 45% by weight of the oxidized asphalt based on the total weight of the asphalt. In some embodiments, the asphalt comprises 1% to 40% by weight of the oxidized asphalt based on the total weight of the asphalt. In some embodiments, the asphalt comprises 1% to 35% by weight of the oxidized asphalt based on the total weight of the asphalt. In some embodiments, the asphalt comprises 1% to 30% by weight of the oxidized asphalt based on the total weight of the asphalt. In some embodiments, the asphalt comprises 1% to 25% by weight of the oxidized asphalt based on the total weight of the asphalt. In some embodiments, the asphalt comprises 1% to 20% by weight of the oxidized asphalt based on the total weight of the asphalt. In some embodiments, the asphalt comprises 1% to 15% by weight of the oxidized asphalt based on the total weight of the asphalt. In some embodiments, the asphalt comprises 1% to 10% by weight of the oxidized asphalt based on the total weight of the asphalt. In some embodiments, the asphalt comprises 1% to 5% by weight of the oxidized asphalt based on the total weight of the asphalt.

In some embodiments, the asphalt comprises 5% to 99% by weight of the oxidized asphalt based on the total weight of the asphalt. In some embodiments, the asphalt comprises 10% to 99% by weight of the oxidized asphalt based on the total weight of the asphalt. In some embodiments, the asphalt comprises 15% to 99% by weight of the oxidized asphalt based on the total weight of the asphalt. In some embodiments, the asphalt comprises 20% to 99% by weight of the oxidized asphalt based on the total weight of the asphalt. In some embodiments, the asphalt comprises 25% to 99% by weight of the oxidized asphalt based on the total weight of the asphalt. In some embodiments, the asphalt comprises 30% to 99% by weight of the oxidized asphalt based on the total weight of the asphalt. In some embodiments, the asphalt comprises 35% to 99% by weight of the oxidized asphalt based on the total weight of the asphalt. In some embodiments, the asphalt comprises 40% to 99% by weight of the oxidized asphalt based on the total weight of the asphalt. In some embodiments, the asphalt comprises 45% to 99% by weight of the oxidized asphalt based on the total weight of the asphalt. In some embodiments, the asphalt comprises 50% to 99% by weight of the oxidized asphalt based on the total weight of the asphalt. In some embodiments, the asphalt comprises 55% to 99% by weight of the oxidized asphalt based on the total weight of the asphalt. In some embodiments, the asphalt comprises 60% to 99% by weight of the oxidized asphalt based on the total weight of the asphalt. In some embodiments, the asphalt comprises 65% to 99% by weight of the oxidized asphalt based on the total weight of the asphalt. In some embodiments, the asphalt comprises 70% to 99% by weight of the oxidized asphalt based on the total weight of the asphalt. In some embodiments, the asphalt comprises 75% to 99% by weight of the oxidized asphalt based on the total weight of the asphalt. In some embodiments, the asphalt comprises 80% to 99% by weight of the oxidized asphalt based on the total weight of the asphalt. In some embodiments, the asphalt comprises 85% to 99% by weight of the oxidized asphalt based on the total weight of the asphalt. In some embodiments, the asphalt comprises 90% to 99% by weight of the oxidized asphalt based on the total weight of the asphalt. In some embodiments, the asphalt comprises 95% to 99% by weight of the oxidized asphalt based on the total weight of the asphalt.

In some embodiments, the asphalt comprises 1% to 99% by weight of the unoxidized asphalt based on the total weight of the asphalt. In some embodiments, the asphalt comprises 1% to 95% by weight of the unoxidized asphalt based on the total weight of the asphalt. In some embodiments, the asphalt comprises 1% to 90% by weight of the unoxidized asphalt based on the total weight of the asphalt. In some embodiments, the asphalt comprises 1% to 85% by weight of the unoxidized asphalt based on the total weight of the asphalt. In some embodiments, the asphalt comprises 1% to 80% by weight of the unoxidized asphalt based on the total weight of the asphalt. In some embodiments, the asphalt comprises 1% to 75% by weight of the unoxidized asphalt based on the total weight of the asphalt. In some embodiments, the asphalt comprises 1% to 70% by weight of the unoxidized asphalt based on the total weight of the asphalt. In some embodiments, the asphalt comprises 1% to 65% by weight of the unoxidized asphalt based on the total weight of the asphalt. In some embodiments, the asphalt comprises 1% to 60% by weight of the unoxidized asphalt based on the total weight of the asphalt. In some embodiments, the asphalt comprises 1% to 55% by weight of the unoxidized asphalt based on the total weight of the asphalt. In some embodiments, the asphalt comprises 1% to 50% by weight of the unoxidized asphalt based on the total weight of the asphalt. In some embodiments, the asphalt comprises 1% to 45% by weight of the unoxidized asphalt based on the total weight of the asphalt. In some embodiments, the asphalt comprises 1% to 40% by weight of the unoxidized asphalt based on the total weight of the asphalt. In some embodiments, the asphalt comprises 1% to 35% by weight of the unoxidized asphalt based on the total weight of the asphalt. In some embodiments, the asphalt comprises 1% to 30% by weight of the unoxidized asphalt based on the total weight of the asphalt. In some embodiments, the asphalt comprises 1% to 25% by weight of the unoxidized asphalt based on the total weight of the asphalt. In some embodiments, the asphalt comprises 1% to 20% by weight of the unoxidized asphalt based on the total weight of the asphalt. In some embodiments, the asphalt comprises 1% to 15% by weight of the unoxidized asphalt based on the total weight of the asphalt. In some embodiments, the asphalt comprises 1% to 10% by weight of the unoxidized asphalt based on the total weight of the asphalt. In some embodiments, the asphalt comprises 1% to 5% by weight of the unoxidized asphalt based on the total weight of the asphalt.

In some embodiments, the asphalt comprises 5% to 99% by weight of the unoxidized asphalt based on the total weight of the asphalt. In some embodiments, the asphalt comprises 10% to 99% by weight of the unoxidized asphalt based on the total weight of the asphalt. In some embodiments, the asphalt comprises 15% to 99% by weight of the unoxidized asphalt based on the total weight of the asphalt. In some embodiments, the asphalt comprises 20% to 99% by weight of the unoxidized asphalt based on the total weight of the asphalt. In some embodiments, the asphalt comprises 25% to 99% by weight of the unoxidized asphalt based on the total weight of the asphalt. In some embodiments, the asphalt comprises 30% to 99% by weight of the unoxidized asphalt based on the total weight of the asphalt. In some embodiments, the asphalt comprises 35% to 99% by weight of the unoxidized asphalt based on the total weight of the asphalt. In some embodiments, the asphalt comprises 40% to 99% by weight of the unoxidized asphalt based on the total weight of the asphalt. In some embodiments, the asphalt comprises 45% to 99% by weight of the unoxidized asphalt based on the total weight of the asphalt. In some embodiments, the asphalt comprises 50% to 99% by weight of the unoxidized asphalt based on the total weight of the asphalt. In some embodiments, the asphalt comprises 55% to 99% by weight of the unoxidized asphalt based on the total weight of the asphalt. In some embodiments, the asphalt comprises 60% to 99% by weight of the unoxidized asphalt based on the total weight of the asphalt. In some embodiments, the asphalt comprises 65% to 99% by weight of the unoxidized asphalt based on the total weight of the asphalt. In some embodiments, the asphalt comprises 70% to 99% by weight of the unoxidized asphalt based on the total weight of the asphalt. In some embodiments, the asphalt comprises 75% to 99% by weight of the unoxidized asphalt based on the total weight of the asphalt. In some embodiments, the asphalt comprises 80% to 99% by weight of the unoxidized asphalt based on the total weight of the asphalt. In some embodiments, the asphalt comprises 85% to 99% by weight of the unoxidized asphalt based on the total weight of the asphalt. In some embodiments, the asphalt comprises 90% to 99% by weight of the unoxidized asphalt based on the total weight of the asphalt. In some embodiments, the asphalt comprises 95% to 99% by weight of the unoxidized asphalt based on the total weight of the asphalt.

In some embodiments, the asphalt comprises 1% to 99% by weight of the polymer-modified asphalt based on the total weight of the asphalt. In some embodiments, the asphalt comprises 1% to 95% by weight of the polymer-modified asphalt based on the total weight of the asphalt. In some embodiments, the asphalt comprises 1% to 90% by weight of the polymer-modified asphalt based on the total weight of the asphalt. In some embodiments, the asphalt comprises 1% to 85% by weight of the polymer-modified asphalt based on the total weight of the asphalt. In some embodiments, the asphalt comprises 1% to 80% by weight of the polymer-modified asphalt based on the total weight of the asphalt. In some embodiments, the asphalt comprises 1% to 75% by weight of the polymer-modified asphalt based on the total weight of the asphalt. In some embodiments, the asphalt comprises 1% to 70% by weight of the polymer-modified asphalt based on the total weight of the asphalt. In some embodiments, the asphalt comprises 1% to 65% by weight of the polymer-modified asphalt based on the total weight of the asphalt. In some embodiments, the asphalt comprises 1% to 60% by weight of the polymer-modified asphalt based on the total weight of the asphalt. In some embodiments, the asphalt comprises 1% to 55% by weight of the polymer-modified asphalt based on the total weight of the asphalt. In some embodiments, the asphalt comprises 1% to 50% by weight of the polymer-modified asphalt based on the total weight of the asphalt. In some embodiments, the asphalt comprises 1% to 45% by weight of the polymer-modified asphalt based on the total weight of the asphalt. In some embodiments, the asphalt comprises 1% to 40% by weight of the polymer-modified asphalt based on the total weight of the asphalt. In some embodiments, the asphalt comprises 1% to 35% by weight of the polymer-modified asphalt based on the total weight of the asphalt. In some embodiments, the asphalt comprises 1% to 30% by weight of the polymer-modified asphalt based on the total weight of the asphalt. In some embodiments, the asphalt comprises 1% to 25% by weight of the polymer-modified asphalt based on the total weight of the asphalt. In some embodiments, the asphalt comprises 1% to 20% by weight of the polymer-modified asphalt based on the total weight of the asphalt. In some embodiments, the asphalt comprises 1% to 15% by weight of the polymer-modified asphalt based on the total weight of the asphalt. In some embodiments, the asphalt comprises 1% to 10% by weight of the polymer-modified asphalt based on the total weight of the asphalt. In some embodiments, the asphalt comprises 1% to 5% by weight of the polymer-modified asphalt based on the total weight of the asphalt.

In some embodiments, the asphalt comprises 5% to 99% by weight of the polymer-modified asphalt based on the total weight of the asphalt. In some embodiments, the asphalt comprises 10% to 99% by weight of the polymer-modified asphalt based on the total weight of the asphalt. In some embodiments, the asphalt comprises 15% to 99% by weight of the polymer-modified asphalt based on the total weight of the asphalt. In some embodiments, the asphalt comprises 20% to 99% by weight of the polymer-modified asphalt based on the total weight of the asphalt. In some embodiments, the asphalt comprises 25% to 99% by weight of the polymer-modified asphalt based on the total weight of the asphalt. In some embodiments, the asphalt comprises 30% to 99% by weight of the polymer-modified asphalt based on the total weight of the asphalt. In some embodiments, the asphalt comprises 35% to 99% by weight of the polymer-modified asphalt based on the total weight of the asphalt. In some embodiments, the asphalt comprises 40% to 99% by weight of the polymer-modified asphalt based on the total weight of the asphalt. In some embodiments, the asphalt comprises 45% to 99% by weight of the polymer-modified asphalt based on the total weight of the asphalt. In some embodiments, the asphalt comprises 50% to 99% by weight of the polymer-modified asphalt based on the total weight of the asphalt. In some embodiments, the asphalt comprises 55% to 99% by weight of the polymer-modified asphalt based on the total weight of the asphalt. In some embodiments, the asphalt comprises 60% to 99% by weight of the polymer-modified asphalt based on the total weight of the asphalt. In some embodiments, the asphalt comprises 65% to 99% by weight of the polymer-modified asphalt based on the total weight of the asphalt. In some embodiments, the asphalt comprises 70% to 99% by weight of the polymer-modified asphalt based on the total weight of the asphalt. In some embodiments, the asphalt comprises 75% to 99% by weight of the polymer-modified asphalt based on the total weight of the asphalt. In some embodiments, the asphalt comprises 80% to 99% by weight of the polymer-modified asphalt based on the total weight of the asphalt. In some embodiments, the asphalt comprises 85% to 99% by weight of the polymer-modified asphalt based on the total weight of the asphalt. In some embodiments, the asphalt comprises 90% to 99% by weight of the polymer-modified asphalt based on the total weight of the asphalt. In some embodiments, the asphalt comprises 95% to 99% by weight of the polymer-modified asphalt based on the total weight of the asphalt.

In some embodiments, the asphalt comprises 1% to 99% by weight of the waste asphalt based on the total weight of the asphalt. In some embodiments, the asphalt comprises 1% to 95% by weight of the waste asphalt based on the total weight of the asphalt. In some embodiments, the asphalt comprises 1% to 90% by weight of the waste asphalt based on the total weight of the asphalt. In some embodiments, the asphalt comprises 1% to 85% by weight of the waste asphalt based on the total weight of the asphalt. In some embodiments, the asphalt comprises 1% to 80% by weight of the waste asphalt based on the total weight of the asphalt. In some embodiments, the asphalt comprises 1% to 75% by weight of the waste asphalt based on the total weight of the asphalt. In some embodiments, the asphalt comprises 1% to 70% by weight of the waste asphalt based on the total weight of the asphalt. In some embodiments, the asphalt comprises 1% to 65% by weight of the waste asphalt based on the total weight of the asphalt. In some embodiments, the asphalt comprises 1% to 60% by weight of the waste asphalt based on the total weight of the asphalt. In some embodiments, the asphalt comprises 1% to 55% by weight of the waste asphalt based on the total weight of the asphalt. In some embodiments, the asphalt comprises 1% to 50% by weight of the waste asphalt based on the total weight of the asphalt. In some embodiments, the asphalt comprises 1% to 45% by weight of the waste asphalt based on the total weight of the asphalt. In some embodiments, the asphalt comprises 1% to 40% by weight of the waste asphalt based on the total weight of the asphalt. In some embodiments, the asphalt comprises 1% to 35% by weight of the waste asphalt based on the total weight of the asphalt. In some embodiments, the asphalt comprises 1% to 30% by weight of the waste asphalt based on the total weight of the asphalt. In some embodiments, the asphalt comprises 1% to 25% by weight of the waste asphalt based on the total weight of the asphalt. In some embodiments, the asphalt comprises 1% to 20% by weight of the waste asphalt based on the total weight of the asphalt. In some embodiments, the asphalt comprises 1% to 15% by weight of the waste asphalt based on the total weight of the asphalt. In some embodiments, the asphalt comprises 1% to 10% by weight of the waste asphalt based on the total weight of the asphalt. In some embodiments, the asphalt comprises 1% to 5% by weight of the waste asphalt based on the total weight of the asphalt.

In some embodiments, the asphalt comprises 5% to 99% by weight of the waste asphalt based on the total weight of the asphalt. In some embodiments, the asphalt comprises 10% to 99% by weight of the waste asphalt based on the total weight of the asphalt. In some embodiments, the asphalt comprises 15% to 99% by weight of the waste asphalt based on the total weight of the asphalt. In some embodiments, the asphalt comprises 20% to 99% by weight of the waste asphalt based on the total weight of the asphalt. In some embodiments, the asphalt comprises 25% to 99% by weight of the waste asphalt based on the total weight of the asphalt. In some embodiments, the asphalt comprises 30% to 99% by weight of the waste asphalt based on the total weight of the asphalt. In some embodiments, the asphalt comprises 35% to 99% by weight of the waste asphalt based on the total weight of the asphalt. In some embodiments, the asphalt comprises 40% to 99% by weight of the waste asphalt based on the total weight of the asphalt. In some embodiments, the asphalt comprises 45% to 99% by weight of the waste asphalt based on the total weight of the asphalt. In some embodiments, the asphalt comprises 50% to 99% by weight of the waste asphalt based on the total weight of the asphalt. In some embodiments, the asphalt comprises 55% to 99% by weight of the waste asphalt based on the total weight of the asphalt. In some embodiments, the asphalt comprises 60% to 99% by weight of the waste asphalt based on the total weight of the asphalt. In some embodiments, the asphalt comprises 65% to 99% by weight of the waste asphalt based on the total weight of the asphalt. In some embodiments, the asphalt comprises 70% to 99% by weight of the waste asphalt based on the total weight of the asphalt. In some embodiments, the asphalt comprises 75% to 99% by weight of the waste asphalt based on the total weight of the asphalt. In some embodiments, the asphalt comprises 80% to 99% by weight of the waste asphalt based on the total weight of the asphalt. In some embodiments, the asphalt comprises 85% to 99% by weight of the waste asphalt based on the total weight of the asphalt. In some embodiments, the asphalt comprises 90% to 99% by weight of the waste asphalt based on the total weight of the asphalt. In some embodiments, the asphalt comprises 95% to 99% by weight of the waste asphalt based on the total weight of the asphalt.

In some embodiments, the asphalt shingle waste comprises 1% to 99% by weight of waste asphalt based on a total weight of the asphalt shingle waste. In some embodiments, the asphalt shingle waste comprises 1% to 90% by weight of waste asphalt based on the total weight of the asphalt shingle waste. In some embodiments, the asphalt shingle waste comprises 1% to 80% by weight of waste asphalt based on the total weight of the asphalt shingle waste. In some embodiments, the asphalt shingle waste comprises 1% to 70% by weight of waste asphalt based on the total weight of the asphalt shingle waste. In some embodiments, the asphalt shingle waste comprises 1% to 60% by weight of waste asphalt based on the total weight of the asphalt shingle waste. In some embodiments, the asphalt shingle waste comprises 1% to 50% by weight of waste asphalt based on the total weight of the asphalt shingle waste. In some embodiments, the asphalt shingle waste comprises 1% to 40% by weight of waste asphalt based on the total weight of the asphalt shingle waste. In some embodiments, the asphalt shingle waste comprises 1% to 30% by weight of waste asphalt based on the total weight of the asphalt shingle waste. In some embodiments, the asphalt shingle waste comprises 1% to 20% by weight of waste asphalt based on the total weight of the asphalt shingle waste. In some embodiments, the asphalt shingle waste comprises 1% to 10% by weight of waste asphalt based on the total weight of the asphalt shingle waste.

In some embodiments, the asphalt shingle waste comprises 10% to 99% by weight of waste asphalt based on the total weight of the asphalt shingle waste. In some embodiments, the asphalt shingle waste comprises 20% to 99% by weight of waste asphalt based on the total weight of the asphalt shingle waste. In some embodiments, the asphalt shingle waste comprises 30% to 99% by weight of waste asphalt based on the total weight of the asphalt shingle waste. In some embodiments, the asphalt shingle waste comprises 40% to 99% by weight of waste asphalt based on the total weight of the asphalt shingle waste. In some embodiments, the asphalt shingle waste comprises 50% to 99% by weight of waste asphalt based on the total weight of the asphalt shingle waste. In some embodiments, the asphalt shingle waste comprises 60% to 99% by weight of waste asphalt based on the total weight of the asphalt shingle waste. In some embodiments, the asphalt shingle waste comprises 70% to 99% by weight of waste asphalt based on the total weight of the asphalt shingle waste. In some embodiments, the asphalt shingle waste comprises 80% to 99% by weight of waste asphalt based on the total weight of the asphalt shingle waste. In some embodiments, the asphalt shingle waste comprises 90% to 99% by weight of waste asphalt based on the total weight of the asphalt shingle waste.

In some embodiments, the asphalt shingle waste comprises 1% to 99% by weight of at least one of limestone, granules, impurities, or any combination thereof based on the total weight of the asphalt shingle waste. In some embodiments, the asphalt shingle waste comprises 1% to 90% by weight of at least one of limestone, granules, impurities, or any combination thereof based on the total weight of the asphalt shingle waste. In some embodiments, the asphalt shingle waste comprises 1% to 80% by weight of at least one of limestone, granules, impurities, or any combination thereof based on the total weight of the asphalt shingle waste. In some embodiments, the asphalt shingle waste comprises 1% to 70% by weight of at least one of limestone, granules, impurities, or any combination thereof based on the total weight of the asphalt shingle waste. In some embodiments, the asphalt shingle waste comprises 1% to 60% by weight of at least one of limestone, granules, impurities, or any combination thereof based on the total weight of the asphalt shingle waste. In some embodiments, the asphalt shingle waste comprises 1% to 50% by weight of at least one of limestone, granules, impurities, or any combination thereof based on the total weight of the asphalt shingle waste. In some embodiments, the asphalt shingle waste comprises 1% to 40% by weight of at least one of limestone, granules, impurities, or any combination thereof based on the total weight of the asphalt shingle waste. In some embodiments, the asphalt shingle waste comprises 1% to 30% by weight of at least one of limestone, granules, impurities, or any combination thereof based on the total weight of the asphalt shingle waste. In some embodiments, the asphalt shingle waste comprises 1% to 20% by weight of at least one of limestone, granules, impurities, or any combination thereof based on the total weight of the asphalt shingle waste. In some embodiments, the asphalt shingle waste comprises 1% to 10% by weight of at least one of limestone, granules, impurities, or any combination thereof based on the total weight of the asphalt shingle waste.

In some embodiments, the asphalt shingle waste comprises 10% to 99% by weight of at least one of limestone, granules, impurities, or any combination thereof based on the total weight of the asphalt shingle waste. In some embodiments, the asphalt shingle waste comprises 20% to 99% by weight of at least one of limestone, granules, impurities, or any combination thereof based on the total weight of the asphalt shingle waste. In some embodiments, the asphalt shingle waste comprises 30% to 99% by weight of at least one of limestone, granules, impurities, or any combination thereof based on the total weight of the asphalt shingle waste. In some embodiments, the asphalt shingle waste comprises 40% to 99% by weight of at least one of limestone, granules, impurities, or any combination thereof based on the total weight of the asphalt shingle waste. In some embodiments, the asphalt shingle waste comprises 50% to 99% by weight of at least one of limestone, granules, impurities, or any combination thereof based on the total weight of the asphalt shingle waste. In some embodiments, the asphalt shingle waste comprises 60% to 99% by weight of at least one of limestone, granules, impurities, or any combination thereof based on the total weight of the asphalt shingle waste. In some embodiments, the asphalt shingle waste comprises 70% to 99% by weight of at least one of limestone, granules, impurities, or any combination thereof based on the total weight of the asphalt shingle waste. In some embodiments, the asphalt shingle waste comprises 80% to 99% by weight of at least one of limestone, granules, impurities, or any combination thereof based on the total weight of the asphalt shingle waste. In some embodiments, the asphalt shingle waste comprises 90% to 99% by weight of at least one of limestone, granules, impurities, or any combination thereof based on the total weight of the asphalt shingle waste.

In some embodiments, the asphalt pavement waste comprises 1% to 99% by weight of a waste asphalt based on a total weight of the asphalt pavement waste. In some embodiments, the asphalt pavement waste comprises 1% to 95% by weight of the waste asphalt based on the total weight of the asphalt pavement waste. In some embodiments, the asphalt pavement waste comprises 1% to 90% by weight of the waste asphalt based on the total weight of the asphalt pavement waste. In some embodiments, the asphalt pavement waste comprises 1% to 85% by weight of the waste asphalt based on the total weight of the asphalt pavement waste. In some embodiments, the asphalt pavement waste comprises 1% to 80% by weight of the waste asphalt based on the total weight of the asphalt pavement waste. In some embodiments, the asphalt pavement waste comprises 1% to 75% by weight of the waste asphalt based on the total weight of the asphalt pavement waste. In some embodiments, the asphalt pavement waste comprises 1% to 70% by weight of the waste asphalt based on the total weight of the asphalt pavement waste. In some embodiments, the asphalt pavement waste comprises 1% to 65% by weight of the waste asphalt based on the total weight of the asphalt pavement waste. In some embodiments, the asphalt pavement waste comprises 1% to 60% by weight of the waste asphalt based on the total weight of the asphalt pavement waste. In some embodiments, the asphalt pavement waste comprises 1% to 55% by weight of the waste asphalt based on the total weight of the asphalt pavement waste. In some embodiments, the asphalt pavement waste comprises 1% to 50% by weight of the waste asphalt based on the total weight of the asphalt pavement waste. In some embodiments, the asphalt pavement waste comprises 1% to 45% by weight of the waste asphalt based on the total weight of the asphalt pavement waste. In some embodiments, the asphalt pavement waste comprises 1% to 40% by weight of the waste asphalt based on the total weight of the asphalt pavement waste. In some embodiments, the asphalt pavement waste comprises 1% to 35% by weight of the waste asphalt based on the total weight of the asphalt pavement waste. In some embodiments, the asphalt pavement waste comprises 1% to 30% by weight of the waste asphalt based on the total weight of the asphalt pavement waste. In some embodiments, the asphalt pavement waste comprises 1% to 25% by weight of the waste asphalt based on the total weight of the asphalt pavement waste. In some embodiments, the asphalt pavement waste comprises 1% to 20% by weight of the waste asphalt based on the total weight of the asphalt pavement waste. In some embodiments, the asphalt pavement waste comprises 1% to 15% by weight of the waste asphalt based on the total weight of the asphalt pavement waste. In some embodiments, the asphalt pavement waste comprises 1% to 10% by weight of the waste asphalt based on the total weight of the asphalt pavement waste. In some embodiments, the asphalt pavement waste comprises 1% to 5% by weight of the waste asphalt based on the total weight of the asphalt pavement waste.

In some embodiments, the asphalt pavement waste comprises 5% to 99% by weight of the waste asphalt based on the total weight of the asphalt pavement waste. In some embodiments, the asphalt pavement waste comprises 10% to 99% by weight of the waste asphalt based on the total weight of the asphalt pavement waste. In some embodiments, the asphalt pavement waste comprises 15% to 99% by weight of the waste asphalt based on the total weight of the asphalt pavement waste. In some embodiments, the asphalt pavement waste comprises 20% to 99% by weight of the waste asphalt based on the total weight of the asphalt pavement waste. In some embodiments, the asphalt pavement waste comprises 25% to 99% by weight of the waste asphalt based on the total weight of the asphalt pavement waste. In some embodiments, the asphalt pavement waste comprises 30% to 99% by weight of the waste asphalt based on the total weight of the asphalt pavement waste. In some embodiments, the asphalt pavement waste comprises 35% to 99% by weight of the waste asphalt based on the total weight of the asphalt pavement waste. In some embodiments, the asphalt pavement waste comprises 40% to 99% by weight of the waste asphalt based on the total weight of the asphalt pavement waste. In some embodiments, the asphalt pavement waste comprises 45% to 99% by weight of the waste asphalt based on the total weight of the asphalt pavement waste. In some embodiments, the asphalt pavement waste comprises 50% to 99% by weight of the waste asphalt based on the total weight of the asphalt pavement waste. In some embodiments, the asphalt pavement waste comprises 55% to 99% by weight of the waste asphalt based on the total weight of the asphalt pavement waste. In some embodiments, the asphalt pavement waste comprises 60% to 99% by weight of the waste asphalt based on the total weight of the asphalt pavement waste. In some embodiments, the asphalt pavement waste comprises 65% to 99% by weight of the waste asphalt based on the total weight of the asphalt pavement waste. In some embodiments, the asphalt pavement waste comprises 70% to 99% by weight of the waste asphalt based on the total weight of the asphalt pavement waste. In some embodiments, the asphalt pavement waste comprises 75% to 99% by weight of the waste asphalt based on the total weight of the asphalt pavement waste. In some embodiments, the asphalt pavement waste comprises 80% to 99% by weight of the waste asphalt based on the total weight of the asphalt pavement waste. In some embodiments, the asphalt pavement waste comprises 85% to 99% by weight of the waste asphalt based on the total weight of the asphalt pavement waste. In some embodiments, the asphalt pavement waste comprises 90% to 99% by weight of the waste asphalt based on the total weight of the asphalt pavement waste. In some embodiments, the asphalt pavement waste comprises 95% to 99% by weight of the waste asphalt based on the total weight of the asphalt pavement waste.

In some embodiments, the asphalt pavement waste comprises 1% to 99% by weight of an aggregate based on the total weight of the asphalt pavement waste. In some embodiments, the asphalt pavement waste comprises 1% to 95% by weight of the aggregate based on the total weight of the asphalt pavement waste. In some embodiments, the asphalt pavement waste comprises 1% to 90% by weight of the aggregate based on the total weight of the asphalt pavement waste. In some embodiments, the asphalt pavement waste comprises 1% to 85% by weight of the aggregate based on the total weight of the asphalt pavement waste. In some embodiments, the asphalt pavement waste comprises 1% to 80% by weight of the aggregate based on the total weight of the asphalt pavement waste. In some embodiments, the asphalt pavement waste comprises 1% to 75% by weight of the aggregate based on the total weight of the asphalt pavement waste. In some embodiments, the asphalt pavement waste comprises 1% to 70% by weight of the aggregate based on the total weight of the asphalt pavement waste. In some embodiments, the asphalt pavement waste comprises 1% to 65% by weight of the aggregate based on the total weight of the asphalt pavement waste. In some embodiments, the asphalt pavement waste comprises 1% to 60% by weight of the aggregate based on the total weight of the asphalt pavement waste. In some embodiments, the asphalt pavement waste comprises 1% to 55% by weight of the aggregate based on the total weight of the asphalt pavement waste. In some embodiments, the asphalt pavement waste comprises 1% to 50% by weight of the aggregate based on the total weight of the asphalt pavement waste. In some embodiments, the asphalt pavement waste comprises 1% to 45% by weight of the aggregate based on the total weight of the asphalt pavement waste. In some embodiments, the asphalt pavement waste comprises 1% to 40% by weight of the aggregate based on the total weight of the asphalt pavement waste. In some embodiments, the asphalt pavement waste comprises 1% to 35% by weight of the aggregate based on the total weight of the asphalt pavement waste. In some embodiments, the asphalt pavement waste comprises 1% to 30% by weight of the aggregate based on the total weight of the asphalt pavement waste. In some embodiments, the asphalt pavement waste comprises 1% to 25% by weight of the aggregate based on the total weight of the asphalt pavement waste. In some embodiments, the asphalt pavement waste comprises 1% to 20% by weight of the aggregate based on the total weight of the asphalt pavement waste. In some embodiments, the asphalt pavement waste comprises 1% to 15% by weight of the aggregate based on the total weight of the asphalt pavement waste. In some embodiments, the asphalt pavement waste comprises 1% to 10% by weight of the aggregate based on the total weight of the asphalt pavement waste. In some embodiments, the asphalt pavement waste comprises 1% to 5% by weight of the aggregate based on the total weight of the asphalt pavement waste.

In some embodiments, the asphalt pavement waste comprises 5% to 99% by weight of the aggregate based on the total weight of the asphalt pavement waste. In some embodiments, the asphalt pavement waste comprises 10% to 99% by weight of the aggregate based on the total weight of the asphalt pavement waste. In some embodiments, the asphalt pavement waste comprises 15% to 99% by weight of the aggregate based on the total weight of the asphalt pavement waste. In some embodiments, the asphalt pavement waste comprises 20% to 99% by weight of the aggregate based on the total weight of the asphalt pavement waste. In some embodiments, the asphalt pavement waste comprises 25% to 99% by weight of the aggregate based on the total weight of the asphalt pavement waste. In some embodiments, the asphalt pavement waste comprises 30% to 99% by weight of the aggregate based on the total weight of the asphalt pavement waste. In some embodiments, the asphalt pavement waste comprises 35% to 99% by weight of the aggregate based on the total weight of the asphalt pavement waste. In some embodiments, the asphalt pavement waste comprises 40% to 99% by weight of the aggregate based on the total weight of the asphalt pavement waste. In some embodiments, the asphalt pavement waste comprises 45% to 99% by weight of the aggregate based on the total weight of the asphalt pavement waste. In some embodiments, the asphalt pavement waste comprises 50% to 99% by weight of the aggregate based on the total weight of the asphalt pavement waste. In some embodiments, the asphalt pavement waste comprises 55% to 99% by weight of the aggregate based on the total weight of the asphalt pavement waste. In some embodiments, the asphalt pavement waste comprises 60% to 99% by weight of the aggregate based on the total weight of the asphalt pavement waste. In some embodiments, the asphalt pavement waste comprises 65% to 99% by weight of the aggregate based on the total weight of the asphalt pavement waste. In some embodiments, the asphalt pavement waste comprises 70% to 99% by weight of the aggregate based on the total weight of the asphalt pavement waste. In some embodiments, the asphalt pavement waste comprises 75% to 99% by weight of the aggregate based on the total weight of the asphalt pavement waste. In some embodiments, the asphalt pavement waste comprises 80% to 99% by weight of the aggregate based on the total weight of the asphalt pavement waste. In some embodiments, the asphalt pavement waste comprises 85% to 99% by weight of the aggregate based on the total weight of the asphalt pavement waste. In some embodiments, the asphalt pavement waste comprises 90% to 99% by weight of the aggregate based on the total weight of the asphalt pavement waste. In some embodiments, the asphalt pavement waste comprises 95% to 99% by weight of the aggregate based on the total weight of the asphalt pavement waste.

In some embodiments, the polymer-modified asphalt comprises 0.1% to 20% by weight of at least one polymer based on a total weight of the polymer-modified asphalt. In some embodiments, the polymer-modified asphalt comprises 0.1% to 19% by weight of at least one polymer based on a total weight of the polymer-modified asphalt. In some embodiments, the polymer-modified asphalt comprises 0.1% to 18% by weight of at least one polymer based on a total weight of the polymer-modified asphalt. In some embodiments, the polymer-modified asphalt comprises 0.1% to 17% by weight of at least one polymer based on a total weight of the polymer-modified asphalt. In some embodiments, the polymer-modified asphalt comprises 0.1% to 16% by weight of at least one polymer based on a total weight of the polymer-modified asphalt. In some embodiments, the polymer-modified asphalt comprises 0.1% to 15% by weight of at least one polymer based on a total weight of the polymer-modified asphalt. In some embodiments, the polymer-modified asphalt comprises 0.1% to 14% by weight of at least one polymer based on a total weight of the polymer-modified asphalt. In some embodiments, the polymer-modified asphalt comprises 0.1% to 13% by weight of at least one polymer based on a total weight of the polymer-modified asphalt. In some embodiments, the polymer-modified asphalt comprises 0.1% to 12% by weight of at least one polymer based on a total weight of the polymer-modified asphalt. In some embodiments, the polymer-modified asphalt comprises 0.1% to 11% by weight of at least one polymer based on a total weight of the polymer-modified asphalt. In some embodiments, the polymer-modified asphalt comprises 0.1% to 10% by weight of at least one polymer based on a total weight of the polymer-modified asphalt. In some embodiments, the polymer-modified asphalt comprises 0.1% to 9% by weight of at least one polymer based on a total weight of the polymer-modified asphalt. In some embodiments, the polymer-modified asphalt comprises 0.1% to 8% by weight of at least one polymer based on a total weight of the polymer-modified asphalt. In some embodiments, the polymer-modified asphalt comprises 0.1% to 7% by weight of at least one polymer based on a total weight of the polymer-modified asphalt. In some embodiments, the polymer-modified asphalt comprises 0.1% to 6% by weight of at least one polymer based on a total weight of the polymer-modified asphalt. In some embodiments, the polymer-modified asphalt comprises 0.1% to 5% by weight of at least one polymer based on a total weight of the polymer-modified asphalt. In some embodiments, the polymer-modified asphalt comprises 0.1% to 4% by weight of at least one polymer based on a total weight of the polymer-modified asphalt. In some embodiments, the polymer-modified asphalt comprises 0.1% to 3% by weight of at least one polymer based on a total weight of the polymer-modified asphalt. In some embodiments, the polymer-modified asphalt comprises 0.1% to 2% by weight of at least one polymer based on a total weight of the polymer-modified asphalt. In some embodiments, the polymer-modified asphalt comprises 0.1% to 1% by weight of at least one polymer based on a total weight of the polymer-modified asphalt.

In some embodiments, the polymer-modified asphalt comprises 1% to 20% by weight of at least one polymer based on a total weight of the polymer-modified asphalt. In some embodiments, the polymer-modified asphalt comprises 2% to 20% by weight of at least one polymer based on a total weight of the polymer-modified asphalt. In some embodiments, the polymer-modified asphalt comprises 3% to 20% by weight of at least one polymer based on a total weight of the polymer-modified asphalt. In some embodiments, the polymer-modified asphalt comprises 4% to 20% by weight of at least one polymer based on a total weight of the polymer-modified asphalt. In some embodiments, the polymer-modified asphalt comprises 5% to 20% by weight of at least one polymer based on a total weight of the polymer-modified asphalt. In some embodiments, the polymer-modified asphalt comprises 6% to 20% by weight of at least one polymer based on a total weight of the polymer-modified asphalt. In some embodiments, the polymer-modified asphalt comprises 7% to 20% by weight of at least one polymer based on a total weight of the polymer-modified asphalt. In some embodiments, the polymer-modified asphalt comprises 8% to 20% by weight of at least one polymer based on a total weight of the polymer-modified asphalt. In some embodiments, the polymer-modified asphalt comprises 9% to 20% by weight of at least one polymer based on a total weight of the polymer-modified asphalt. In some embodiments, the polymer-modified asphalt comprises 10% to 20% by weight of at least one polymer based on a total weight of the polymer-modified asphalt. In some embodiments, the polymer-modified asphalt comprises 11% to 20% by weight of at least one polymer based on a total weight of the polymer-modified asphalt. In some embodiments, the polymer-modified asphalt comprises 12% to 20% by weight of at least one polymer based on a total weight of the polymer-modified asphalt. In some embodiments, the polymer-modified asphalt comprises 13% to 20% by weight of at least one polymer based on a total weight of the polymer-modified asphalt. In some embodiments, the polymer-modified asphalt comprises 14% to 20% by weight of at least one polymer based on a total weight of the polymer-modified asphalt. In some embodiments, the polymer-modified asphalt comprises 15% to 20% by weight of at least one polymer based on a total weight of the polymer-modified asphalt. In some embodiments, the polymer-modified asphalt comprises 16% to 20% by weight of at least one polymer based on a total weight of the polymer-modified asphalt. In some embodiments, the polymer-modified asphalt comprises 17% to 20% by weight of at least one polymer based on a total weight of the polymer-modified asphalt. In some embodiments, the polymer-modified asphalt comprises 18% to 20% by weight of at least one polymer based on a total weight of the polymer-modified asphalt. In some embodiments, the polymer-modified asphalt comprises 19% to 20% by weight of at least one polymer based on a total weight of the polymer-modified asphalt.

In some embodiments, the second formulation comprises a filler material. In some embodiments, the filler material comprises at least one of calcium carbonate, barium sulfate, calcium sulfate, talc, perlite, silica, fumed silica, precipitated silica, quartz, aluminum trihydrate, magnesium hydroxide, colemanite, titanium dioxide, snow white, fly ash, graphene nanoparticles, carbon black, recycled rubber tires, recycled shingles, recycled thermoplastic resins, basalt, roofing granules, clay, ammonium polyphosphate, graphite, or any combination thereof. In some embodiments, the filler material comprises at least one of calcium carbonate, barium sulfate, calcium sulfate, talc, limestone, perlite, silica, fumed silica, precipitated silica, quartz, aluminum trihydrate, magnesium hydroxide, colemanite, titanium dioxide, fly ash, graphene nanoparticles, carbon black, recycled rubber tires, recycled shingles, recycled thermoplastic resins, basalt, roofing granules, clay, lignin, or a combination thereof. In some embodiments, the filler comprises at least one of a colorant, a pigment, a dye, or any combination thereof.

In some embodiments, the second formulation comprises 20% to 80% by weight of a filler material based on the total weight of the second formulation. In some embodiments, the second formulation comprises 20% to 75% by weight of the filler material based on the total weight of the second formulation. In some embodiments, the second formulation comprises 20% to 70% by weight of the filler material based on the total weight of the second formulation. In some embodiments, the second formulation comprises 20% to 65% by weight of the filler material based on the total weight of the second formulation. In some embodiments, the second formulation comprises 20% to 60% by weight of the filler material based on the total weight of the second formulation. In some embodiments, the second formulation comprises 20% to 55% by weight of the filler material based on the total weight of the second formulation. In some embodiments, the second formulation comprises 20% to 50% by weight of the filler material based on the total weight of the second formulation. In some embodiments, the second formulation comprises 20% to 45% by weight of the filler material based on the total weight of the second formulation. In some embodiments, the second formulation comprises 20% to 40% by weight of the filler material based on the total weight of the second formulation. In some embodiments, the second formulation comprises 20% to 35% by weight of the filler material based on the total weight of the second formulation. In some embodiments, the second formulation comprises 20% to 30% by weight of the filler material based on the total weight of the second formulation. In some embodiments, the second formulation comprises 20% to 25% by weight of the filler material based on the total weight of the second formulation.

In some embodiments, the second formulation comprises 25% to 80% by weight of the filler material based on the total weight of the second formulation. In some embodiments, the second formulation comprises 30% to 80% by weight of the filler material based on the total weight of the second formulation. In some embodiments, the second formulation comprises 35% to 80% by weight of the filler material based on the total weight of the second formulation. In some embodiments, the second formulation comprises 40% to 80% by weight of the filler material based on the total weight of the second formulation. In some embodiments, the second formulation comprises 45% to 80% by weight of the filler material based on the total weight of the second formulation. In some embodiments, the second formulation comprises 50% to 80% by weight of the filler material based on the total weight of the second formulation. In some embodiments, the second formulation comprises 55% to 80% by weight of the filler material based on the total weight of the second formulation. In some embodiments, the second formulation comprises 60% to 80% by weight of the filler material based on the total weight of the second formulation. In some embodiments, the second formulation comprises 65% to 80% by weight of the filler material based on the total weight of the second formulation. In some embodiments, the second formulation comprises 70% to 80% by weight of the filler material based on the total weight of the second formulation. In some embodiments, the second formulation comprises 75% to 80% by weight of the filler material based on the total weight of the second formulation.

In some embodiments, the second formulation is substantially free of volatile organic compounds. In some embodiments, the second formulation is free of volatile organic compounds. In some embodiments, the second formulation does not comprise volatile organic compounds. In some embodiments, the second formulation is substantially free of asphalt shingle waste. In some embodiments, the second formulation is free of asphalt shingle waste. In some embodiments, the second formulation is substantially free of asphalt pavement waste. In some embodiments, the second formulation is free of asphalt pavement waste.

At step 106, in some embodiments, the method 100 of forming a crosslinked asphalt composition comprises mixing a sufficient amount of the first formulation with a sufficient amount of at least the second formulation, so as to form a crosslinkable asphalt composition.

In some embodiments, the mixing comprises bringing the first formulation and the second formulation into immediate or close proximity. In some embodiments, the mixing comprises bringing the first formulation and the second formulation into direct physical contact. In some embodiments, the mixing comprises contacting the first formulation and the second formulation. In some embodiments, the mixing comprises agitating the first formulation and the second formulation. In some embodiments, the mixing comprises tumbling the first formulation and the second formulation. In some embodiments, the mixing comprises stirring the first formulation and the second formulation. In some embodiments, the mixing comprises combining the first formulation and the second formulation. In some embodiments, the mixing comprises pouring simultaneously or sequentially the first formulation and the second formulation into a container. In some embodiments, the mixing comprises adding the second formulation to the first formulation. In some embodiments, the mixing comprises adding the first formulation to the second formulation.

In some embodiments, a sufficient amount of the first formulation is 10% to 90% by weight of the first formulation based on a total weight of the crosslinkable asphalt composition. In some embodiments, a sufficient amount of the first formulation is 10% to 85% by weight of the first formulation based on the total weight of the crosslinkable asphalt composition. In some embodiments, a sufficient amount of the first formulation is 10% to 80% by weight of the first formulation based on the total weight of the crosslinkable asphalt composition. In some embodiments, a sufficient amount of the first formulation is 10% to 75% by weight of the first formulation based on the total weight of the crosslinkable asphalt composition. In some embodiments, a sufficient amount of the first formulation is 10% to 70% by weight of the first formulation based on the total weight of the crosslinkable asphalt composition. In some embodiments, a sufficient amount of the first formulation is 10% to 65% by weight of the first formulation based on the total weight of the crosslinkable asphalt composition. In some embodiments, a sufficient amount of the first formulation is 10% to 60% by weight of the first formulation based on the total weight of the crosslinkable asphalt composition. In some embodiments, a sufficient amount of the first formulation is 10% to 55% by weight of the first formulation based on the total weight of the crosslinkable asphalt composition. In some embodiments, a sufficient amount of the first formulation is 10% to 50% by weight of the first formulation based on the total weight of the crosslinkable asphalt composition. In some embodiments, a sufficient amount of the first formulation is 10% to 45% by weight of the first formulation based on the total weight of the crosslinkable asphalt composition. In some embodiments, a sufficient amount of the first formulation is 10% to 40% by weight of the first formulation based on the total weight of the crosslinkable asphalt composition. In some embodiments, a sufficient amount of the first formulation is 10% to 35% by weight of the first formulation based on the total weight of the crosslinkable asphalt composition. In some embodiments, a sufficient amount of the first formulation is 10% to 30% by weight of the first formulation based on the total weight of the crosslinkable asphalt composition. In some embodiments, a sufficient amount of the first formulation is 10% to 25% by weight of the first formulation based on the total weight of the crosslinkable asphalt composition. In some embodiments, a sufficient amount of the first formulation is 10% to 20% by weight of the first formulation based on the total weight of the crosslinkable asphalt composition. In some embodiments, a sufficient amount of the first formulation is 10% to 15% by weight of the first formulation based on the total weight of the crosslinkable asphalt composition.

In some embodiments, a sufficient amount of the first formulation is 15% to 90% by weight of the first formulation based on the total weight of the crosslinkable asphalt composition. In some embodiments, a sufficient amount of the first formulation is 20% to 90% by weight of the first formulation based on the total weight of the crosslinkable asphalt composition. In some embodiments, a sufficient amount of the first formulation is 25% to 90% by weight of the first formulation based on the total weight of the crosslinkable asphalt composition. In some embodiments, a sufficient amount of the first formulation is 30% to 90% by weight of the first formulation based on the total weight of the crosslinkable asphalt composition. In some embodiments, a sufficient amount of the first formulation is 35% to 90% by weight of the first formulation based on the total weight of the crosslinkable asphalt composition. In some embodiments, a sufficient amount of the first formulation is 40% to 90% by weight of the first formulation based on the total weight of the crosslinkable asphalt composition. In some embodiments, a sufficient amount of the first formulation is 45% to 90% by weight of the first formulation based on the total weight of the crosslinkable asphalt composition. In some embodiments, a sufficient amount of the first formulation is 50% to 90% by weight of the first formulation based on the total weight of the crosslinkable asphalt composition. In some embodiments, a sufficient amount of the first formulation is 55% to 90% by weight of the first formulation based on the total weight of the crosslinkable asphalt composition. In some embodiments, a sufficient amount of the first formulation is 60% to 90% by weight of the first formulation based on the total weight of the crosslinkable asphalt composition. In some embodiments, a sufficient amount of the first formulation is 65% to 90% by weight of the first formulation based on the total weight of the crosslinkable asphalt composition. In some embodiments, a sufficient amount of the first formulation is 70% to 90% by weight of the first formulation based on the total weight of the crosslinkable asphalt composition. In some embodiments, a sufficient amount of the first formulation is 75% to 90% by weight of the first formulation based on the total weight of the crosslinkable asphalt composition. In some embodiments, a sufficient amount of the first formulation is 80% to 90% by weight of the first formulation based on the total weight of the crosslinkable asphalt composition. In some embodiments, a sufficient amount of the first formulation is 85% to 90% by weight of the first formulation based on the total weight of the crosslinkable asphalt composition.

In some embodiments, a sufficient amount of the second formulation is 10% to 90% by weight of the second formulation based on the total weight of the crosslinkable asphalt composition. In some embodiments, a sufficient amount of the second formulation is 10% to 85% by weight of the second formulation based on the total weight of the crosslinkable asphalt composition. In some embodiments, a sufficient amount of the second formulation is 10% to 80% by weight of the second formulation based on the total weight of the crosslinkable asphalt composition. In some embodiments, a sufficient amount of the second formulation is 10% to 75% by weight of the second formulation based on the total weight of the crosslinkable asphalt composition. In some embodiments, a sufficient amount of the second formulation is 10% to 70% by weight of the second formulation based on the total weight of the crosslinkable asphalt composition. In some embodiments, a sufficient amount of the second formulation is 10% to 65% by weight of the second formulation based on the total weight of the crosslinkable asphalt composition. In some embodiments, a sufficient amount of the second formulation is 10% to 60% by weight of the second formulation based on the total weight of the crosslinkable asphalt composition. In some embodiments, a sufficient amount of the second formulation is 10% to 55% by weight of the second formulation based on the total weight of the crosslinkable asphalt composition. In some embodiments, a sufficient amount of the second formulation is 10% to 50% by weight of the second formulation based on the total weight of the crosslinkable asphalt composition. In some embodiments, a sufficient amount of the second formulation is 10% to 45% by weight of the second formulation based on the total weight of the crosslinkable asphalt composition. In some embodiments, a sufficient amount of the second formulation is 10% to 40% by weight of the second formulation based on the total weight of the crosslinkable asphalt composition. In some embodiments, a sufficient amount of the second formulation is 10% to 35% by weight of the second formulation based on the total weight of the crosslinkable asphalt composition. In some embodiments, a sufficient amount of the second formulation is 10% to 30% by weight of the second formulation based on the total weight of the crosslinkable asphalt composition. In some embodiments, a sufficient amount of the second formulation is 10% to 25% by weight of the second formulation based on the total weight of the crosslinkable asphalt composition. In some embodiments, a sufficient amount of the second formulation is 10% to 20% by weight of the second formulation based on the total weight of the crosslinkable asphalt composition. In some embodiments, a sufficient amount of the second formulation is 10% to 15% by weight of the second formulation based on the total weight of the crosslinkable asphalt composition.

In some embodiments, a sufficient amount of the second formulation is 15% to 90% by weight of the second formulation based on the total weight of the crosslinkable asphalt composition. In some embodiments, a sufficient amount of the second formulation is 20% to 90% by weight of the second formulation based on the total weight of the crosslinkable asphalt composition. In some embodiments, a sufficient amount of the second formulation is 25% to 90% by weight of the second formulation based on the total weight of the crosslinkable asphalt composition. In some embodiments, a sufficient amount of the second formulation is 30% to 90% by weight of the second formulation based on the total weight of the crosslinkable asphalt composition. In some embodiments, a sufficient amount of the second formulation is 35% to 90% by weight of the second formulation based on the total weight of the crosslinkable asphalt composition. In some embodiments, a sufficient amount of the second formulation is 40% to 90% by weight of the second formulation based on the total weight of the crosslinkable asphalt composition. In some embodiments, a sufficient amount of the second formulation is 45% to 90% by weight of the second formulation based on the total weight of the crosslinkable asphalt composition. In some embodiments, a sufficient amount of the second formulation is 50% to 90% by weight of the second formulation based on the total weight of the crosslinkable asphalt composition. In some embodiments, a sufficient amount of the second formulation is 55% to 90% by weight of the second formulation based on the total weight of the crosslinkable asphalt composition. In some embodiments, a sufficient amount of the second formulation is 60% to 90% by weight of the second formulation based on the total weight of the crosslinkable asphalt composition. In some embodiments, a sufficient amount of the second formulation is 65% to 90% by weight of the second formulation based on the total weight of the crosslinkable asphalt composition. In some embodiments, a sufficient amount of the second formulation is 70% to 90% by weight of the second formulation based on the total weight of the crosslinkable asphalt composition. In some embodiments, a sufficient amount of the second formulation is 75% to 90% by weight of the second formulation based on the total weight of the crosslinkable asphalt composition. In some embodiments, a sufficient amount of the second formulation is 80% to 90% by weight of the second formulation based on the total weight of the crosslinkable asphalt composition. In some embodiments, a sufficient amount of the second formulation is 85% to 90% by weight of the second formulation based on the total weight of the crosslinkable asphalt composition.

In some embodiments, a sufficient amount of the first formulation is 1% to 99% by weight of the first formulation based on a total weight of the first formulation and the second formulation. In some embodiments, a sufficient amount of the first formulation is 1% to 95% by weight of the first formulation based on the total weight of the first formulation and the second formulation. In some embodiments, a sufficient amount of the first formulation is 1% to 90% by weight of the first formulation based on the total weight of the first formulation and the second formulation. In some embodiments, a sufficient amount of the first formulation is 1% to 85% by weight of the first formulation based on the total weight of the first formulation and the second formulation. In some embodiments, a sufficient amount of the first formulation is 1% to 80% by weight of the first formulation based on the total weight of the first formulation and the second formulation. In some embodiments, a sufficient amount of the first formulation is 1% to 75% by weight of the first formulation based on the total weight of the first formulation and the second formulation. In some embodiments, a sufficient amount of the first formulation is 1% to 70% by weight of the first formulation based on the total weight of the first formulation and the second formulation. In some embodiments, a sufficient amount of the first formulation is 1% to 65% by weight of the first formulation based on the total weight of the first formulation and the second formulation. In some embodiments, a sufficient amount of the first formulation is 1% to 60% by weight of the first formulation based on the total weight of the first formulation and the second formulation. In some embodiments, a sufficient amount of the first formulation is 1% to 55% by weight of the first formulation based on the total weight of the first formulation and the second formulation. In some embodiments, a sufficient amount of the first formulation is 1% to 50% by weight of the first formulation based on the total weight of the first formulation and the second formulation. In some embodiments, a sufficient amount of the first formulation is 1% to 45% by weight of the first formulation based on the total weight of the first formulation and the second formulation. In some embodiments, a sufficient amount of the first formulation is 1% to 40% by weight of the first formulation based on the total weight of the first formulation and the second formulation. In some embodiments, a sufficient amount of the first formulation is 1% to 35% by weight of the first formulation based on the total weight of the first formulation and the second formulation. In some embodiments, a sufficient amount of the first formulation is 1% to 30% by weight of the first formulation based on the total weight of the first formulation and the second formulation. In some embodiments, a sufficient amount of the first formulation is 1% to 25% by weight of the first formulation based on the total weight of the first formulation and the second formulation. In some embodiments, a sufficient amount of the first formulation is 1% to 20% by weight of the first formulation based on the total weight of the first formulation and the second formulation. In some embodiments, a sufficient amount of the first formulation is 1% to 15% by weight of the first formulation based on the total weight of the first formulation and the second formulation. In some embodiments, a sufficient amount of the first formulation is 1% to 10% by weight of the first formulation based on the total weight of the first formulation and the second formulation. In some embodiments, a sufficient amount of the first formulation is 1% to 5% by weight of the first formulation based on the total weight of the first formulation and the second formulation.

In some embodiments, a sufficient amount of the first formulation is 5% to 99% by weight of the first formulation based on the total weight of the first formulation and the second formulation. In some embodiments, a sufficient amount of the first formulation is 10% to 99% by weight of the first formulation based on the total weight of the first formulation and the second formulation. In some embodiments, a sufficient amount of the first formulation is 15% to 99% by weight of the first formulation based on the total weight of the first formulation and the second formulation. In some embodiments, a sufficient amount of the first formulation is 20% to 99% by weight of the first formulation based on the total weight of the first formulation and the second formulation. In some embodiments, a sufficient amount of the first formulation is 25% to 99% by weight of the first formulation based on the total weight of the first formulation and the second formulation. In some embodiments, a sufficient amount of the first formulation is 30% to 99% by weight of the first formulation based on the total weight of the first formulation and the second formulation. In some embodiments, a sufficient amount of the first formulation is 35% to 99% by weight of the first formulation based on the total weight of the first formulation and the second formulation. In some embodiments, a sufficient amount of the first formulation is 40% to 99% by weight of the first formulation based on the total weight of the first formulation and the second formulation. In some embodiments, a sufficient amount of the first formulation is 45% to 99% by weight of the first formulation based on the total weight of the first formulation and the second formulation. In some embodiments, a sufficient amount of the first formulation is 50% to 99% by weight of the first formulation based on the total weight of the first formulation and the second formulation. In some embodiments, a sufficient amount of the first formulation is 55% to 99% by weight of the first formulation based on the total weight of the first formulation and the second formulation. In some embodiments, a sufficient amount of the first formulation is 60% to 99% by weight of the first formulation based on the total weight of the first formulation and the second formulation. In some embodiments, a sufficient amount of the first formulation is 65% to 99% by weight of the first formulation based on the total weight of the first formulation and the second formulation. In some embodiments, a sufficient amount of the first formulation is 70% to 99% by weight of the first formulation based on the total weight of the first formulation and the second formulation. In some embodiments, a sufficient amount of the first formulation is 75% to 99% by weight of the first formulation based on the total weight of the first formulation and the second formulation. In some embodiments, a sufficient amount of the first formulation is 80% to 99% by weight of the first formulation based on the total weight of the first formulation and the second formulation. In some embodiments, a sufficient amount of the first formulation is 85% to 99% by weight of the first formulation based on the total weight of the first formulation and the second formulation. In some embodiments, a sufficient amount of the first formulation is 90% to 99% by weight of the first formulation based on the total weight of the first formulation and the second formulation. In some embodiments, a sufficient amount of the first formulation is 95% to 99% by weight of the first formulation based on the total weight of the first formulation and the second formulation.

In some embodiments, a sufficient amount of the second formulation is 1% to 99% by weight of the second formulation based on the total weight of the first formulation and the second formulation. In some embodiments, a sufficient amount of the second formulation is 1% to 95% by weight of the second formulation based on the total weight of the first formulation and the second formulation. In some embodiments, a sufficient amount of the second formulation is 1% to 90% by weight of the second formulation based on the total weight of the first formulation and the second formulation. In some embodiments, a sufficient amount of the second formulation is 1% to 85% by weight of the second formulation based on the total weight of the first formulation and the second formulation. In some embodiments, a sufficient amount of the second formulation is 1% to 80% by weight of the second formulation based on the total weight of the first formulation and the second formulation. In some embodiments, a sufficient amount of the second formulation is 1% to 75% by weight of the second formulation based on the total weight of the first formulation and the second formulation. In some embodiments, a sufficient amount of the second formulation is 1% to 70% by weight of the second formulation based on the total weight of the first formulation and the second formulation. In some embodiments, a sufficient amount of the second formulation is 1% to 65% by weight of the second formulation based on the total weight of the first formulation and the second formulation. In some embodiments, a sufficient amount of the second formulation is 1% to 60% by weight of the second formulation based on the total weight of the first formulation and the second formulation. In some embodiments, a sufficient amount of the second formulation is 1% to 55% by weight of the second formulation based on the total weight of the first formulation and the second formulation. In some embodiments, a sufficient amount of the second formulation is 1% to 50% by weight of the second formulation based on the total weight of the first formulation and the second formulation. In some embodiments, a sufficient amount of the second formulation is 1% to 45% by weight of the second formulation based on the total weight of the first formulation and the second formulation. In some embodiments, a sufficient amount of the second formulation is 1% to 40% by weight of the second formulation based on the total weight of the first formulation and the second formulation. In some embodiments, a sufficient amount of the second formulation is 1% to 35% by weight of the second formulation based on the total weight of the first formulation and the second formulation. In some embodiments, a sufficient amount of the second formulation is 1% to 30% by weight of the second formulation based on the total weight of the first formulation and the second formulation. In some embodiments, a sufficient amount of the second formulation is 1% to 25% by weight of the second formulation based on the total weight of the first formulation and the second formulation. In some embodiments, a sufficient amount of the second formulation is 1% to 20% by weight of the second formulation based on the total weight of the first formulation and the second formulation. In some embodiments, a sufficient amount of the second formulation is 1% to 15% by weight of the second formulation based on the total weight of the first formulation and the second formulation. In some embodiments, a sufficient amount of the second formulation is 1% to 10% by weight of the second formulation based on the total weight of the first formulation and the second formulation. In some embodiments, a sufficient amount of the second formulation is 1% to 5% by weight of the second formulation based on the total weight of the first formulation and the second formulation.

In some embodiments, a sufficient amount of the second formulation is 5% to 99% by weight of the second formulation based on the total weight of the first formulation and the second formulation. In some embodiments, a sufficient amount of the second formulation is 10% to 99% by weight of the second formulation based on the total weight of the first formulation and the second formulation. In some embodiments, a sufficient amount of the second formulation is 15% to 99% by weight of the second formulation based on the total weight of the first formulation and the second formulation. In some embodiments, a sufficient amount of the second formulation is 20% to 99% by weight of the second formulation based on the total weight of the first formulation and the second formulation. In some embodiments, a sufficient amount of the second formulation is 25% to 99% by weight of the second formulation based on the total weight of the first formulation and the second formulation. In some embodiments, a sufficient amount of the second formulation is 30% to 99% by weight of the second formulation based on the total weight of the first formulation and the second formulation. In some embodiments, a sufficient amount of the second formulation is 35% to 99% by weight of the second formulation based on the total weight of the first formulation and the second formulation. In some embodiments, a sufficient amount of the second formulation is 40% to 99% by weight of the second formulation based on the total weight of the first formulation and the second formulation. In some embodiments, a sufficient amount of the second formulation is 45% to 99% by weight of the second formulation based on the total weight of the first formulation and the second formulation. In some embodiments, a sufficient amount of the second formulation is 50% to 99% by weight of the second formulation based on the total weight of the first formulation and the second formulation. In some embodiments, a sufficient amount of the second formulation is 55% to 99% by weight of the second formulation based on the total weight of the first formulation and the second formulation. In some embodiments, a sufficient amount of the second formulation is 60% to 99% by weight of the second formulation based on the total weight of the first formulation and the second formulation. In some embodiments, a sufficient amount of the second formulation is 65% to 99% by weight of the second formulation based on the total weight of the first formulation and the second formulation. In some embodiments, a sufficient amount of the second formulation is 70% to 99% by weight of the second formulation based on the total weight of the first formulation and the second formulation. In some embodiments, a sufficient amount of the second formulation is 75% to 99% by weight of the second formulation based on the total weight of the first formulation and the second formulation. In some embodiments, a sufficient amount of the second formulation is 80% to 99% by weight of the second formulation based on the total weight of the first formulation and the second formulation. In some embodiments, a sufficient amount of the second formulation is 85% to 99% by weight of the second formulation based on the total weight of the first formulation and the second formulation. In some embodiments, a sufficient amount of the second formulation is 90% to 99% by weight of the second formulation based on the total weight of the first formulation and the second formulation. In some embodiments, a sufficient amount of the second formulation is 95% to 99% by weight of the second formulation based on the total weight of the first formulation and the second formulation.

In some embodiments, as mentioned above, the first formulation comprises the asphalt component. It will be appreciated that the weight percentages disclosed herein for the asphalt component in the second formulation are applicable to embodiments in which the asphalt component is present in the first formulation.

In some embodiments, the crosslinkable asphalt composition comprises 1% to 99% by weight of the crosslinker based on the total weight of the crosslinkable asphalt composition. In some embodiments, the crosslinkable asphalt composition comprises 1% to 95% by weight of the crosslinker based on the total weight of the crosslinkable asphalt composition. In some embodiments, the crosslinkable asphalt composition comprises 1% to 90% by weight of the crosslinker based on the total weight of the crosslinkable asphalt composition. In some embodiments, the crosslinkable asphalt composition comprises 1% to 85% by weight of the crosslinker based on the total weight of the crosslinkable asphalt composition. In some embodiments, the crosslinkable asphalt composition comprises 1% to 80% by weight of the crosslinker based on the total weight of the crosslinkable asphalt composition. In some embodiments, the crosslinkable asphalt composition comprises 1% to 75% by weight of the crosslinker based on the total weight of the crosslinkable asphalt composition. In some embodiments, the crosslinkable asphalt composition comprises 1% to 70% by weight of the crosslinker based on the total weight of the crosslinkable asphalt composition. In some embodiments, the crosslinkable asphalt composition comprises 1% to 65% by weight of the crosslinker based on the total weight of the crosslinkable asphalt composition. In some embodiments, the crosslinkable asphalt composition comprises 1% to 60% by weight of the crosslinker based on the total weight of the crosslinkable asphalt composition. In some embodiments, the crosslinkable asphalt composition comprises 1% to 55% by weight of the crosslinker based on the total weight of the crosslinkable asphalt composition. In some embodiments, the crosslinkable asphalt composition comprises 1% to 50% by weight of the crosslinker based on the total weight of the crosslinkable asphalt composition. In some embodiments, the crosslinkable asphalt composition comprises 1% to 45% by weight of the crosslinker based on the total weight of the crosslinkable asphalt composition. In some embodiments, the crosslinkable asphalt composition comprises 1% to 40% by weight of the crosslinker based on the total weight of the crosslinkable asphalt composition. In some embodiments, the crosslinkable asphalt composition comprises 1% to 35% by weight of the crosslinker based on the total weight of the crosslinkable asphalt composition. In some embodiments, the crosslinkable asphalt composition comprises 1% to 30% by weight of the crosslinker based on the total weight of the crosslinkable asphalt composition. In some embodiments, the crosslinkable asphalt composition comprises 1% to 25% by weight of the crosslinker based on the total weight of the crosslinkable asphalt composition. In some embodiments, the crosslinkable asphalt composition comprises 1% to 20% by weight of the crosslinker based on the total weight of the crosslinkable asphalt composition. In some embodiments, the crosslinkable asphalt composition comprises 1% to 15% by weight of the crosslinker based on the total weight of the crosslinkable asphalt composition. In some embodiments, the crosslinkable asphalt composition comprises 1% to 10% by weight of the crosslinker based on the total weight of the crosslinkable asphalt composition. In some embodiments, the crosslinkable asphalt composition comprises 1% to 5% by weight of the crosslinker based on the total weight of the crosslinkable asphalt composition.

In some embodiments, the crosslinkable asphalt composition comprises 5% to 99% by weight of the crosslinker based on the total weight of the crosslinkable asphalt composition. In some embodiments, the crosslinkable asphalt composition comprises 10% to 99% by weight of the crosslinker based on the total weight of the crosslinkable asphalt composition. In some embodiments, the crosslinkable asphalt composition comprises 15% to 99% by weight of the crosslinker based on the total weight of the crosslinkable asphalt composition. In some embodiments, the crosslinkable asphalt composition comprises 20% to 99% by weight of the crosslinker based on the total weight of the crosslinkable asphalt composition. In some embodiments, the crosslinkable asphalt composition comprises 25% to 99% by weight of the crosslinker based on the total weight of the crosslinkable asphalt composition. In some embodiments, the crosslinkable asphalt composition comprises 30% to 99% by weight of the crosslinker based on the total weight of the crosslinkable asphalt composition. In some embodiments, the crosslinkable asphalt composition comprises 35% to 99% by weight of the crosslinker based on the total weight of the crosslinkable asphalt composition. In some embodiments, the crosslinkable asphalt composition comprises 40% to 99% by weight of the crosslinker based on the total weight of the crosslinkable asphalt composition. In some embodiments, the crosslinkable asphalt composition comprises 45% to 99% by weight of the crosslinker based on the total weight of the crosslinkable asphalt composition. In some embodiments, the crosslinkable asphalt composition comprises 50% to 99% by weight of the crosslinker based on the total weight of the crosslinkable asphalt composition. In some embodiments, the crosslinkable asphalt composition comprises 55% to 99% by weight of the crosslinker based on the total weight of the crosslinkable asphalt composition. In some embodiments, the crosslinkable asphalt composition comprises 60% to 99% by weight of the crosslinker based on the total weight of the crosslinkable asphalt composition. In some embodiments, the crosslinkable asphalt composition comprises 65% to 99% by weight of the crosslinker based on the total weight of the crosslinkable asphalt composition. In some embodiments, the crosslinkable asphalt composition comprises 70% to 99% by weight of the crosslinker based on the total weight of the crosslinkable asphalt composition. In some embodiments, the crosslinkable asphalt composition comprises 75% to 99% by weight of the crosslinker based on the total weight of the crosslinkable asphalt composition. In some embodiments, the crosslinkable asphalt composition comprises 80% to 99% by weight of the crosslinker based on the total weight of the crosslinkable asphalt composition. In some embodiments, the crosslinkable asphalt composition comprises 85% to 99% by weight of the crosslinker based on the total weight of the crosslinkable asphalt composition. In some embodiments, the crosslinkable asphalt composition comprises 90% to 99% by weight of the crosslinker based on the total weight of the crosslinkable asphalt composition. In some embodiments, the crosslinkable asphalt composition comprises 95% to 99% by weight of the crosslinker based on the total weight of the crosslinkable asphalt composition.

In some embodiments, the crosslinkable asphalt composition comprises 0.1% to 20% by weight of the polyfunctional epoxy-containing compound based on the total weight of the crosslinkable asphalt composition. In some embodiments, the crosslinkable asphalt composition comprises 0.1% to 19% by weight of the polyfunctional epoxy-containing compound based on the total weight of the crosslinkable asphalt composition. In some embodiments, the crosslinkable asphalt composition comprises 0.1% to 18% by weight of the polyfunctional epoxy-containing compound based on the total weight of the crosslinkable asphalt composition. In some embodiments, the crosslinkable asphalt composition comprises 0.1% to 17% by weight of the polyfunctional epoxy-containing compound based on the total weight of the crosslinkable asphalt composition. In some embodiments, the crosslinkable asphalt composition comprises 0.1% to 16% by weight of the polyfunctional epoxy-containing compound based on the total weight of the crosslinkable asphalt composition. In some embodiments, the crosslinkable asphalt composition comprises 0.1% to 15% by weight of the polyfunctional epoxy-containing compound based on the total weight of the crosslinkable asphalt composition. In some embodiments, the crosslinkable asphalt composition comprises 0.1% to 14% by weight of the polyfunctional epoxy-containing compound based on the total weight of the crosslinkable asphalt composition. In some embodiments, the crosslinkable asphalt composition comprises 0.1% to 13% by weight of the polyfunctional epoxy-containing compound based on the total weight of the crosslinkable asphalt composition. In some embodiments, the crosslinkable asphalt composition comprises 0.1% to 12% by weight of the polyfunctional epoxy-containing compound based on the total weight of the crosslinkable asphalt composition. In some embodiments, the crosslinkable asphalt composition comprises 0.1% to 11% by weight of the polyfunctional epoxy-containing compound based on the total weight of the crosslinkable asphalt composition. In some embodiments, the crosslinkable asphalt composition comprises 0.1% to 10% by weight of the polyfunctional epoxy-containing compound based on the total weight of the crosslinkable asphalt composition. In some embodiments, the crosslinkable asphalt composition comprises 0.1% to 9% by weight of the polyfunctional epoxy-containing compound based on the total weight of the crosslinkable asphalt composition. In some embodiments, the crosslinkable asphalt composition comprises 0.1% to 8% by weight of the polyfunctional epoxy-containing compound based on the total weight of the crosslinkable asphalt composition. In some embodiments, the crosslinkable asphalt composition comprises 0.1% to 7% by weight of the polyfunctional epoxy-containing compound based on the total weight of the crosslinkable asphalt composition. In some embodiments, the crosslinkable asphalt composition comprises 0.1% to 6% by weight of the polyfunctional epoxy-containing compound based on the total weight of the crosslinkable asphalt composition. In some embodiments, the crosslinkable asphalt composition comprises 0.1% to 5% by weight of the polyfunctional epoxy-containing compound based on the total weight of the crosslinkable asphalt composition. In some embodiments, the crosslinkable asphalt composition comprises 0.1% to 4% by weight of the polyfunctional epoxy-containing compound based on the total weight of the crosslinkable asphalt composition. In some embodiments, the crosslinkable asphalt composition comprises 0.1% to 3% by weight of the polyfunctional epoxy-containing compound based on the total weight of the crosslinkable asphalt composition. In some embodiments, the crosslinkable asphalt composition comprises 0.1% to 2% by weight of the polyfunctional epoxy-containing compound based on the total weight of the crosslinkable asphalt composition. In some embodiments, the crosslinkable asphalt composition comprises 0.1% to 1% by weight of the polyfunctional epoxy-containing compound based on the total weight of the crosslinkable asphalt composition.

In some embodiments, the crosslinkable asphalt composition comprises 1% to 20% by weight of the polyfunctional epoxy-containing compound based on the total weight of the crosslinkable asphalt composition. In some embodiments, the crosslinkable asphalt composition comprises 2% to 20% by weight of the polyfunctional epoxy-containing compound based on the total weight of the crosslinkable asphalt composition. In some embodiments, the crosslinkable asphalt composition comprises 3% to 20% by weight of the polyfunctional epoxy-containing compound based on the total weight of the crosslinkable asphalt composition. In some embodiments, the crosslinkable asphalt composition comprises 4% to 20% by weight of the polyfunctional epoxy-containing compound based on the total weight of the crosslinkable asphalt composition. In some embodiments, the crosslinkable asphalt composition comprises 5% to 20% by weight of the polyfunctional epoxy-containing compound based on the total weight of the crosslinkable asphalt composition. In some embodiments, the crosslinkable asphalt composition comprises 6% to 20% by weight of the polyfunctional epoxy-containing compound based on the total weight of the crosslinkable asphalt composition. In some embodiments, the crosslinkable asphalt composition comprises 7% to 20% by weight of the polyfunctional epoxy-containing compound based on the total weight of the crosslinkable asphalt composition. In some embodiments, the crosslinkable asphalt composition comprises 8% to 20% by weight of the polyfunctional epoxy-containing compound based on the total weight of the crosslinkable asphalt composition. In some embodiments, the crosslinkable asphalt composition comprises 9% to 20% by weight of the polyfunctional epoxy-containing compound based on the total weight of the crosslinkable asphalt composition. In some embodiments, the crosslinkable asphalt composition comprises 10% to 20% by weight of the polyfunctional epoxy-containing compound based on the total weight of the crosslinkable asphalt composition. In some embodiments, the crosslinkable asphalt composition comprises 11% to 20% by weight of the polyfunctional epoxy-containing compound based on the total weight of the crosslinkable asphalt composition. In some embodiments, the crosslinkable asphalt composition comprises 12% to 20% by weight of the polyfunctional epoxy-containing compound based on the total weight of the crosslinkable asphalt composition. In some embodiments, the crosslinkable asphalt composition comprises 13% to 20% by weight of the polyfunctional epoxy-containing compound based on the total weight of the crosslinkable asphalt composition. In some embodiments, the crosslinkable asphalt composition comprises 14% to 20% by weight of the polyfunctional epoxy-containing compound based on the total weight of the crosslinkable asphalt composition. In some embodiments, the crosslinkable asphalt composition comprises 15% to 20% by weight of the polyfunctional epoxy-containing compound based on the total weight of the crosslinkable asphalt composition. In some embodiments, the crosslinkable asphalt composition comprises 16% to 20% by weight of the polyfunctional epoxy-containing compound based on the total weight of the crosslinkable asphalt composition. In some embodiments, the crosslinkable asphalt composition comprises 17% to 20% by weight of the polyfunctional epoxy-containing compound based on the total weight of the crosslinkable asphalt composition. In some embodiments, the crosslinkable asphalt composition comprises 18% to 20% by weight of the polyfunctional epoxy-containing compound based on the total weight of the crosslinkable asphalt composition. In some embodiments, the crosslinkable asphalt composition comprises 19% to 20% by weight of the polyfunctional epoxy-containing compound based on the total weight of the crosslinkable asphalt composition.

In some embodiments, the crosslinkable asphalt composition comprises 10% to 90% by weight of the asphalt component based on the total weight of the crosslinkable asphalt composition. In some embodiments, the crosslinkable asphalt composition comprises 10% to 85% by weight of the asphalt component based on the total weight of the crosslinkable asphalt composition. In some embodiments, the crosslinkable asphalt composition comprises 10% to 80% by weight of the asphalt component based on the total weight of the crosslinkable asphalt composition. In some embodiments, the crosslinkable asphalt composition comprises 10% to 75% by weight of the asphalt component based on the total weight of the crosslinkable asphalt composition. In some embodiments, the crosslinkable asphalt composition comprises 10% to 70% by weight of the asphalt component based on the total weight of the crosslinkable asphalt composition. In some embodiments, the crosslinkable asphalt composition comprises 10% to 65% by weight of the asphalt component based on the total weight of the crosslinkable asphalt composition. In some embodiments, the crosslinkable asphalt composition comprises 10% to 60% by weight of the asphalt component based on the total weight of the crosslinkable asphalt composition. In some embodiments, the crosslinkable asphalt composition comprises 10% to 55% by weight of the asphalt component based on the total weight of the crosslinkable asphalt composition. In some embodiments, the crosslinkable asphalt composition comprises 10% to 50% by weight of the asphalt component based on the total weight of the crosslinkable asphalt composition. In some embodiments, the crosslinkable asphalt composition comprises 10% to 45% by weight of the asphalt component based on the total weight of the crosslinkable asphalt composition. In some embodiments, the crosslinkable asphalt composition comprises 10% to 40% by weight of the asphalt component based on the total weight of the crosslinkable asphalt composition. In some embodiments, the crosslinkable asphalt composition comprises 10% to 35% by weight of the asphalt component based on the total weight of the crosslinkable asphalt composition. In some embodiments, the crosslinkable asphalt composition comprises 10% to 30% by weight of the asphalt component based on the total weight of the crosslinkable asphalt composition. In some embodiments, the crosslinkable asphalt composition comprises 10% to 25% by weight of the asphalt component based on the total weight of the crosslinkable asphalt composition. In some embodiments, the crosslinkable asphalt composition comprises 10% to 20% by weight of the asphalt component based on the total weight of the crosslinkable asphalt composition. In some embodiments, the crosslinkable asphalt composition comprises 10% to 15% by weight of the asphalt component based on the total weight of the crosslinkable asphalt composition.

In some embodiments, the crosslinkable asphalt composition comprises 15% to 90% by weight of the asphalt component based on the total weight of the crosslinkable asphalt composition. In some embodiments, the crosslinkable asphalt composition comprises 20% to 90% by weight of the asphalt component based on the total weight of the crosslinkable asphalt composition. In some embodiments, the crosslinkable asphalt composition comprises 25% to 90% by weight of the asphalt component based on the total weight of the crosslinkable asphalt composition. In some embodiments, the crosslinkable asphalt composition comprises 30% to 90% by weight of the asphalt component based on the total weight of the crosslinkable asphalt composition. In some embodiments, the crosslinkable asphalt composition comprises 35% to 90% by weight of the asphalt component based on the total weight of the crosslinkable asphalt composition. In some embodiments, the crosslinkable asphalt composition comprises 40% to 90% by weight of the asphalt component based on the total weight of the crosslinkable asphalt composition. In some embodiments, the crosslinkable asphalt composition comprises 45% to 90% by weight of the asphalt component based on the total weight of the crosslinkable asphalt composition. In some embodiments, the crosslinkable asphalt composition comprises 50% to 90% by weight of the asphalt component based on the total weight of the crosslinkable asphalt composition. In some embodiments, the crosslinkable asphalt composition comprises 55% to 90% by weight of the asphalt component based on the total weight of the crosslinkable asphalt composition. In some embodiments, the crosslinkable asphalt composition comprises 60% to 90% by weight of the asphalt component based on the total weight of the crosslinkable asphalt composition. In some embodiments, the crosslinkable asphalt composition comprises 65% to 90% by weight of the asphalt component based on the total weight of the crosslinkable asphalt composition. In some embodiments, the crosslinkable asphalt composition comprises 70% to 90% by weight of the asphalt component based on the total weight of the crosslinkable asphalt composition. In some embodiments, the crosslinkable asphalt composition comprises 75% to 90% by weight of the asphalt component based on the total weight of the crosslinkable asphalt composition. In some embodiments, the crosslinkable asphalt composition comprises 80% to 90% by weight of the asphalt component based on the total weight of the crosslinkable asphalt composition. In some embodiments, the crosslinkable asphalt composition comprises 85% to 90% by weight of the asphalt component based on the total weight of the crosslinkable asphalt composition.

In some embodiments, the crosslinkable asphalt composition comprises 10% to 70% by weight of the filler material based on the total weight of the crosslinkable asphalt composition. In some embodiments, the crosslinkable asphalt composition comprises 10% to 65% by weight of the filler material based on the total weight of the crosslinkable asphalt composition. In some embodiments, the crosslinkable asphalt composition comprises 10% to 60% by weight of the filler material based on the total weight of the crosslinkable asphalt composition. In some embodiments, the crosslinkable asphalt composition comprises 10% to 55% by weight of the filler material based on the total weight of the crosslinkable asphalt composition. In some embodiments, the crosslinkable asphalt composition comprises 10% to 50% by weight of the filler material based on the total weight of the crosslinkable asphalt composition. In some embodiments, the crosslinkable asphalt composition comprises 10% to 45% by weight of the filler material based on the total weight of the crosslinkable asphalt composition. In some embodiments, the crosslinkable asphalt composition comprises 10% to 40% by weight of the filler material based on the total weight of the crosslinkable asphalt composition. In some embodiments, the crosslinkable asphalt composition comprises 10% to 35% by weight of the filler material based on the total weight of the crosslinkable asphalt composition. In some embodiments, the crosslinkable asphalt composition comprises 10% to 30% by weight of the filler material based on the total weight of the crosslinkable asphalt composition. In some embodiments, the crosslinkable asphalt composition comprises 10% to 25% by weight of the filler material based on the total weight of the crosslinkable asphalt composition. In some embodiments, the crosslinkable asphalt composition comprises 10% to 20% by weight of the filler material based on the total weight of the crosslinkable asphalt composition. In some embodiments, the crosslinkable asphalt composition comprises 10% to 15% by weight of the filler material based on the total weight of the crosslinkable asphalt composition.

In some embodiments, the crosslinkable asphalt composition comprises 15% to 70% by weight of the filler material based on the total weight of the crosslinkable asphalt composition. In some embodiments, the crosslinkable asphalt composition comprises 20% to 70% by weight of the filler material based on the total weight of the crosslinkable asphalt composition. In some embodiments, the crosslinkable asphalt composition comprises 25% to 70% by weight of the filler material based on the total weight of the crosslinkable asphalt composition. In some embodiments, the crosslinkable asphalt composition comprises 30% to 70% by weight of the filler material based on the total weight of the crosslinkable asphalt composition. In some embodiments, the crosslinkable asphalt composition comprises 35% to 70% by weight of the filler material based on the total weight of the crosslinkable asphalt composition. In some embodiments, the crosslinkable asphalt composition comprises 40% to 70% by weight of the filler material based on the total weight of the crosslinkable asphalt composition. In some embodiments, the crosslinkable asphalt composition comprises 45% to 70% by weight of the filler material based on the total weight of the crosslinkable asphalt composition. In some embodiments, the crosslinkable asphalt composition comprises 50% to 70% by weight of the filler material based on the total weight of the crosslinkable asphalt composition. In some embodiments, the crosslinkable asphalt composition comprises 55% to 70% by weight of the filler material based on the total weight of the crosslinkable asphalt composition. In some embodiments, the crosslinkable asphalt composition comprises 60% to 70% by weight of the filler material based on the total weight of the crosslinkable asphalt composition. In some embodiments, the crosslinkable asphalt composition comprises 65% to 70% by weight of the filler material based on the total weight of the crosslinkable asphalt composition.

In some embodiments, the crosslinkable asphalt composition is substantially free of volatile organic compounds. In some embodiments, the crosslinkable asphalt composition is free of volatile organic compounds. In some embodiments, the crosslinkable asphalt composition does not comprise volatile organic compounds. In some embodiments, the crosslinkable asphalt composition is substantially free of asphalt shingle waste. In some embodiments, the crosslinkable asphalt composition is free of asphalt shingle waste. In some embodiments, the crosslinkable asphalt composition is substantially free of asphalt pavement waste. In some embodiments, the crosslinkable asphalt composition is free of asphalt pavement waste.

At step 108, in some embodiments, the method 100 of forming a crosslinked asphalt composition comprises applying the crosslinkable asphalt composition to a surface.

In some embodiments, the applying comprises brushing the crosslinkable asphalt composition onto a surface. In some embodiments, the applying comprises pumping the crosslinkable asphalt composition onto a surface. In some embodiments, the applying comprises spraying the crosslinkable asphalt composition onto a surface. In some embodiments, the applying comprises extruding the crosslinkable asphalt composition onto a surface. In some embodiments, the applying comprises pouring the crosslinkable asphalt composition onto a surface. In some embodiments, the applying comprises coating the crosslinkable asphalt composition onto a surface. In some embodiments, the applying comprises spreading the crosslinkable asphalt composition onto a surface. In some embodiments, the applying comprises contacting the crosslinkable asphalt composition with a surface.

In some embodiments, the surface comprises asphalt. In some embodiments, the surface comprises pavement. In some embodiments, the surface comprises asphalt pavement. In some embodiments, the surface comprises at least one of a pavement, a road, a cement, a roofing substrate, a building substrate, a sheathing, an insulation, an asphaltic substrate, a plywood substrate, a glass substrate, a cellulosic substrate, an underlayment, a roofing membrane (reinforced or unreinforced), a roof deck, a photovoltaic (PV) panel, a modified bitumen (MODBIT) substrate, an oriented strand board (OSB), a roll good, a board (such as but not limited to at least one of a foam board (e.g., a polyisocyanurate (ISO) foam board), a cover board, or any combination thereof), a fire retardant board, a hail resistant board, a building structure, a high density cover board, a cement board, concrete, a base sheet, a pipe, a chimney, a wax paper, a roof shingle, a mat, a fabric, a glass mat, a fiberglass mat, a woven mat, a nonwoven a fabric, a polyester mat, a scrim, a coated scrim, or any combination thereof.

At step 110, in some embodiments, the method 100 of forming a crosslinked asphalt composition comprises curing the crosslinkable asphalt composition.

In some embodiments, the curing comprises exposing the crosslinkable asphalt composition to ambient conditions for a duration sufficient to at least partially cure the crosslinkable asphalt composition. In some embodiments, the curing comprises exposing the crosslinkable asphalt composition to water moisture sufficient to at least partially cure the crosslinkable asphalt composition. In some embodiments, the curing comprises exposing the crosslinkable asphalt composition to light (e.g., ultraviolet light, visible light, infrared light, etc.) sufficient to at least partially cure the crosslinkable asphalt composition. In some embodiments, the curing comprises applying a stimulus or stimuli sufficient to induce curing. In some embodiments, the curing proceeds under conditions sufficient to at least partially cure or gel the crosslinkable asphalt composition. In some embodiments, the duration for the crosslinkable asphalt composition to at least partially cure or gel is considered the gel time. In some embodiments, the curing proceeds under conditions sufficient to at least substantially cure the crosslinkable asphalt composition. In some embodiments, the curing proceeds under conditions sufficient to fully cure the crosslinkable asphalt composition. In some embodiments, the curing does not comprise heating using a heating device (e.g., only heating is a result of exposure to ambient conditions).

In some embodiments, the gel time is 6 hours or less. For example, in some embodiments, the gel time is 1 minute to 6 hours. In some embodiments, the gel time is 1 minute to 5 hours. In some embodiments, the gel time is 1 minute to 4 hours. In some embodiments, the gel time is 1 minute to 3 hours. In some embodiments, the gel time is 1 minute to 2 hours. In some embodiments, the gel time is 1 minute to 1 hour. In some embodiments, the gel time is 1 minute to 50 minutes. In some embodiments, the gel time is 1 minute to 40 minutes. In some embodiments, the gel time is 1 minute to 30 minutes. In some embodiments, the gel time is 1 minute to 20 minutes. In some embodiments, the gel time is 1 minute to 10 minutes. In some embodiments, the gel time is 10 minutes to 6 hours. In some embodiments, the gel time is 20 minutes to 6 hours. In some embodiments, the gel time is 30 minutes to 6 hours. In some embodiments, the gel time is 40 minutes to 6 hours. In some embodiments, the gel time is 50 minutes to 6 hours. In some embodiments, the gel time is 1 hour to 6 hours. In some embodiments, the gel time is 2 hours to 6 hours. In some embodiments, the gel time is 3 hours to 6 hours. In some embodiments, the gel time is 4 hours to 6 hours. In some embodiments, the gel time is 5 hours to 6 hours.

In some embodiments, the curing proceeds for a duration of 12 hours or less. For example, in some embodiments, the curing proceeds for a duration of 1 minute to 12 hours. In some embodiments, the curing proceeds for a duration of 1 minute to 11 hours. In some embodiments, the curing proceeds for a duration of 1 minute to 10 hours. In some embodiments, the curing proceeds for a duration of 1 minute to 9 hours. In some embodiments, the curing proceeds for a duration of 1 minute to 8 hours. In some embodiments, the curing proceeds for a duration of 1 minute to 7 hours. In some embodiments, the curing proceeds for a duration of 1 minute to 6 hours. In some embodiments, the curing proceeds for a duration of 1 minute to 5 hours. In some embodiments, the curing proceeds for a duration of 1 minute to 4 hours. In some embodiments, the curing proceeds for a duration of 1 minute to 3 hours. In some embodiments, the curing proceeds for a duration of 1 minute to 2 hours. In some embodiments, the curing proceeds for a duration of 1 minute to 1 hours. In some embodiments, the curing proceeds for a duration of 1 minute to 50 minutes. In some embodiments, the curing proceeds for a duration of 1 minute to 40 minutes. In some embodiments, the curing proceeds for a duration of 1 minute to 30 minutes. In some embodiments, the curing proceeds for a duration of 1 minute to 20 minutes. In some embodiments, the curing proceeds for a duration of 1 minute to 10 minutes. In some embodiments, the curing proceeds for a duration of 1 minute to 5 minutes.

In some embodiments, the curing proceeds for a duration of 10 minutes to 12 hours. In some embodiments, the curing proceeds for a duration of 20 minutes to 12 hours. In some embodiments, the curing proceeds for a duration of 30 minutes to 12 hours. In some embodiments, the curing proceeds for a duration of 40 minutes to 12 hours. In some embodiments, the curing proceeds for a duration of 50 minutes to 12 hours. In some embodiments, the curing proceeds for a duration of 1 hour to 12 hours. In some embodiments, the curing proceeds for a duration of 2 hours to 12 hours. In some embodiments, the curing proceeds for a duration of 3 hours to 12 hours. In some embodiments, the curing proceeds for a duration of 4 hours to 12 hours. In some embodiments, the curing proceeds for a duration of 5 hours to 12 hours. In some embodiments, the curing proceeds for a duration of 6 hours to 12 hours. In some embodiments, the curing proceeds for a duration of 7 hours to 12 hours. In some embodiments, the curing proceeds for a duration of 8 hours to 12 hours. In some embodiments, the curing proceeds for a duration of 9 hours to 12 hours. In some embodiments, the curing proceeds for a duration of 10 hours to 12 hours. In some embodiments, the curing proceeds for a duration of 11 hours to 12 hours.

In some embodiments, the curing is sufficient to form a reaction product comprising a three-dimensional crosslinked polymer network. In some embodiments, the three-dimensional crosslinked polymer network is a reaction product of the crosslinker and the polyfunctional epoxy-containing compound. That is, in some embodiments, the crosslinker and the polyfunctional epoxy-containing compound react to form a three-dimensional crosslinked polymer network. In some embodiments, the curing comprises polymerizing the polyfunctional epoxy-containing compound to form a polymer which is crosslinked by the crosslinker, thereby resulting in the three-dimensional crosslinked polymer network. In some embodiments, the asphalt component is within the three-dimensional crosslinked polymer network. In some embodiments, the curing is sufficient to form a cured crosslinkable asphalt composition. In some embodiments, the curing is sufficient to form a crosslinked asphalt composition. In some embodiments, the curing is sufficient to form a reaction product of a first formulation and a second formulation, wherein the first formulation and/or the second formulation comprises any one or more of the formulations disclosed herein. In some embodiments, In some embodiments, the curing is sufficient to form a layer in which the asphalt component is distributed within and/or throughout all or at least a portion of the three-dimensional crosslinked polymer network. In some embodiments, the curing is sufficient to form a surface coating on the surface. In some embodiments, the curing is sufficient to form a seal between the crosslinked asphalt composition and the surface. In some embodiments, the crosslinked asphalt composition comprises a reaction product of a crosslinker and a polyfunctional epoxy-containing compound. In some embodiments, the reaction product comprises a three-dimensional crosslinked polymer network. In some embodiments, the crosslinked asphalt composition comprises an asphalt component. In some embodiments, the asphalt component is within the three-dimensional crosslinked polymer network.

In some embodiments, the crosslinked asphalt composition has a thickness of 1 mil to 200 mils. In some embodiments, the crosslinked asphalt composition has a thickness of 1 mil to 190 mils. In some embodiments, the crosslinked asphalt composition has a thickness of 1 mil to 180 mils. In some embodiments, the crosslinked asphalt composition has a thickness of 1 mil to 170 mils. In some embodiments, the crosslinked asphalt composition has a thickness of 1 mil to 160 mils. In some embodiments, the crosslinked asphalt composition has a thickness of 1 mil to 150 mils. In some embodiments, the crosslinked asphalt composition has a thickness of 1 mil to 140 mils. In some embodiments, the crosslinked asphalt composition has a thickness of 1 mil to 130 mils. In some embodiments, the crosslinked asphalt composition has a thickness of 1 mil to 120 mils. In some embodiments, the crosslinked asphalt composition has a thickness of 1 mil to 110 mils. In some embodiments, the crosslinked asphalt composition has a thickness of 1 mil to 100 mils. In some embodiments, the crosslinked asphalt composition has a thickness of 1 mil to 90 mils. In some embodiments, the crosslinked asphalt composition has a thickness of 1 mil to 80 mils. In some embodiments, the crosslinked asphalt composition has a thickness of 1 mil to 70 mils. In some embodiments, the crosslinked asphalt composition has a thickness of 1 mil to 60 mils. In some embodiments, the crosslinked asphalt composition has a thickness of 1 mil to 50 mils. In some embodiments, the crosslinked asphalt composition has a thickness of 1 mil to 40 mils. In some embodiments, the crosslinked asphalt composition has a thickness of 1 mil to 30 mils. In some embodiments, the crosslinked asphalt composition has a thickness of 1 mil to 20 mils. In some embodiments, the crosslinked asphalt composition has a thickness of 1 mil to 10 mils. In some embodiments, the crosslinked asphalt composition has a thickness of 1 mil to 5 mils.

In some embodiments, the crosslinked asphalt composition has a thickness of 5 mils to 200 mils. In some embodiments, the crosslinked asphalt composition has a thickness of 10 mils to 200 mils. In some embodiments, the crosslinked asphalt composition has a thickness of 20 mils to 200 mils. In some embodiments, the crosslinked asphalt composition has a thickness of 30 mils to 200 mils. In some embodiments, the crosslinked asphalt composition has a thickness of 40 mils to 200 mils. In some embodiments, the crosslinked asphalt composition has a thickness of 50 mils to 200 mils. In some embodiments, the crosslinked asphalt composition has a thickness of 60 mils to 200 mils. In some embodiments, the crosslinked asphalt composition has a thickness of 70 mils to 200 mils. In some embodiments, the crosslinked asphalt composition has a thickness of 80 mils to 200 mils. In some embodiments, the crosslinked asphalt composition has a thickness of 90 mils to 200 mils. In some embodiments, the crosslinked asphalt composition has a thickness of 100 mils to 200 mils. In some embodiments, the crosslinked asphalt composition has a thickness of 110 mils to 200 mils. In some embodiments, the crosslinked asphalt composition has a thickness of 120 mils to 200 mils. In some embodiments, the crosslinked asphalt composition has a thickness of 130 mils to 200 mils. In some embodiments, the crosslinked asphalt composition has a thickness of 140 mils to 200 mils. In some embodiments, the crosslinked asphalt composition has a thickness of 150 mils to 200 mils. In some embodiments, the crosslinked asphalt composition has a thickness of 160 mils to 200 mils. In some embodiments, the crosslinked asphalt composition has a thickness of 170 mils to 200 mils. In some embodiments, the crosslinked asphalt composition has a thickness of 180 mils to 200 mils. In some embodiments, the crosslinked asphalt composition has a thickness of 190 mils to 200 mils.

In some embodiments, the curing is performed at a temperature of 20° C. to 40° C. In some embodiments, the curing is performed at a temperature of 20° C. to 38° C. In some embodiments, the curing is performed at a temperature of 20° C. to 36° C. In some embodiments, the curing is performed at a temperature of 20° C. to 35° C. In some embodiments, the curing is performed at a temperature of 20° C. to 34° C. In some embodiments, the curing is performed at a temperature of 20° C. to 32° C. In some embodiments, the curing is performed at a temperature of 20° C. to 30° C. In some embodiments, the curing is performed at a temperature of 20° C. to 28° C. In some embodiments, the curing is performed at a temperature of 20° C. to 26° C. In some embodiments, the curing is performed at a temperature of 20° C. to 25° C. In some embodiments, the curing is performed at a temperature of 20° C. to 24° C. In some embodiments, the curing is performed at a temperature of 20° C. to 22° C.

In some embodiments, the curing is performed at a temperature of 22° C. to 40° C. In some embodiments, the curing is performed at a temperature of 24° C. to 40° C. In some embodiments, the curing is performed at a temperature of 25° C. to 40° C. In some embodiments, the curing is performed at a temperature of 26° C. to 40° C. In some embodiments, the curing is performed at a temperature of 28° C. to 40° C. In some embodiments, the curing is performed at a temperature of 30° C. to 40° C. In some embodiments, the curing is performed at a temperature of 32° C. to 40° C. In some embodiments, the curing is performed at a temperature of 34° C. to 40° C. In some embodiments, the curing is performed at a temperature of 35° C. to 40° C. In some embodiments, the curing is performed at a temperature of 36° C. to 40° C. In some embodiments, the curing is performed at a temperature of 38° C. to 40° C.

In some embodiments, the crosslinked asphalt composition is substantially free of volatile organic compounds. In some embodiments, the crosslinked asphalt composition is free of volatile organic compounds. In some embodiments, the crosslinked asphalt composition does not comprise volatile organic compounds. In some embodiments, the crosslinked asphalt composition is substantially free of asphalt shingle waste. In some embodiments, the crosslinked asphalt composition is free of asphalt shingle waste. In some embodiments, the crosslinked asphalt composition is substantially free of asphalt pavement waste. In some embodiments, the crosslinked asphalt composition is free of asphalt pavement waste.

In some embodiments, the crosslinked asphalt composition has a penetration point of 10 dmm to 300 dmm at 77° F. In some embodiments, the crosslinked asphalt composition has a penetration point of 10 dmm to 290 dmm at 77° F. In some embodiments, the crosslinked asphalt composition has a penetration point of 10 dmm to 280 dmm at 77° F. In some embodiments, the crosslinked asphalt composition has a penetration point of 10 dmm to 270 dmm at 77° F. In some embodiments, the crosslinked asphalt composition has a penetration point of 10 dmm to 260 dmm at 77° F. In some embodiments, the crosslinked asphalt composition has a penetration point of 10 dmm to 250 dmm at 77° F. In some embodiments, the crosslinked asphalt composition has a penetration point of 10 dmm to 240 dmm at 77° F. In some embodiments, the crosslinked asphalt composition has a penetration point of 10 dmm to 230 dmm at 77° F. In some embodiments, the crosslinked asphalt composition has a penetration point of 10 dmm to 220 dmm at 77° F. In some embodiments, the crosslinked asphalt composition has a penetration point of 10 dmm to 210 dmm at 77° F. In some embodiments, the crosslinked asphalt composition has a penetration point of 10 dmm to 200 dmm at 77° F. In some embodiments, the crosslinked asphalt composition has a penetration point of 10 dmm to 190 dmm at 77° F. In some embodiments, the crosslinked asphalt composition has a penetration point of 10 dmm to 180 dmm at 77° F. In some embodiments, the crosslinked asphalt composition has a penetration point of 10 dmm to 170 dmm at 77° F. In some embodiments, the crosslinked asphalt composition has a penetration point of 10 dmm to 160 dmm at 77° F. In some embodiments, the crosslinked asphalt composition has a penetration point of 10 dmm to 150 dmm at 77° F. In some embodiments, the crosslinked asphalt composition has a penetration point of 10 dmm to 140 dmm at 77° F. In some embodiments, the crosslinked asphalt composition has a penetration point of 10 dmm to 130 dmm at 77° F. In some embodiments, the crosslinked asphalt composition has a penetration point of 10 dmm to 120 dmm at 77° F. In some embodiments, the crosslinked asphalt composition has a penetration point of 10 dmm to 110 dmm at 77° F. In some embodiments, the crosslinked asphalt composition has a penetration point of 10 dmm to 100 dmm at 77° F. In some embodiments, the crosslinked asphalt composition has a penetration point of 10 dmm to 90 dmm at 77° F. In some embodiments, the crosslinked asphalt composition has a penetration point of 10 dmm to 80 dmm at 77° F. In some embodiments, the crosslinked asphalt composition has a penetration point of 10 dmm to 70 dmm at 77° F. In some embodiments, the crosslinked asphalt composition has a penetration point of 10 dmm to 60 dmm at 77° F. In some embodiments, the crosslinked asphalt composition has a penetration point of 10 dmm to 50 dmm at 77° F. In some embodiments, the crosslinked asphalt composition has a penetration point of 10 dmm to 40 dmm at 77° F. In some embodiments, the crosslinked asphalt composition has a penetration point of 10 dmm to 30 dmm at 77° F. In some embodiments, the crosslinked asphalt composition has a penetration point of 10 dmm to 20 dmm at 77° F.

In some embodiments, the crosslinked asphalt composition has a penetration point of 20 dmm to 300 dmm at 77° F. In some embodiments, the crosslinked asphalt composition has a penetration point of 30 dmm to 300 dmm at 77° F. In some embodiments, the crosslinked asphalt composition has a penetration point of 40 dmm to 300 dmm at 77° F. In some embodiments, the crosslinked asphalt composition has a penetration point of 50 dmm to 300 dmm at 77° F. In some embodiments, the crosslinked asphalt composition has a penetration point of 60 dmm to 300 dmm at 77° F. In some embodiments, the crosslinked asphalt composition has a penetration point of 70 dmm to 300 dmm at 77° F. In some embodiments, the crosslinked asphalt composition has a penetration point of 80 dmm to 300 dmm at 77° F. In some embodiments, the crosslinked asphalt composition has a penetration point of 90 dmm to 300 dmm at 77° F. In some embodiments, the crosslinked asphalt composition has a penetration point of 100 dmm to 300 dmm at 77° F. In some embodiments, the crosslinked asphalt composition has a penetration point of 110 dmm to 300 dmm at 77° F. In some embodiments, the crosslinked asphalt composition has a penetration point of 120 dmm to 300 dmm at 77° F. In some embodiments, the crosslinked asphalt composition has a penetration point of 130 dmm to 300 dmm at 77° F. In some embodiments, the crosslinked asphalt composition has a penetration point of 140 dmm to 300 dmm at 77° F. In some embodiments, the crosslinked asphalt composition has a penetration point of 150 dmm to 300 dmm at 77° F. In some embodiments, the crosslinked asphalt composition has a penetration point of 160 dmm to 300 dmm at 77° F. In some embodiments, the crosslinked asphalt composition has a penetration point of 170 dmm to 300 dmm at 77° F. In some embodiments, the crosslinked asphalt composition has a penetration point of 180 dmm to 300 dmm at 77° F. In some embodiments, the crosslinked asphalt composition has a penetration point of 190 dmm to 300 dmm at 77° F. In some embodiments, the crosslinked asphalt composition has a penetration point of 200 dmm to 300 dmm at 77° F. In some embodiments, the crosslinked asphalt composition has a penetration point of 210 dmm to 300 dmm at 77° F. In some embodiments, the crosslinked asphalt composition has a penetration point of 220 dmm to 300 dmm at 77° F. In some embodiments, the crosslinked asphalt composition has a penetration point of 230 dmm to 300 dmm at 77° F. In some embodiments, the crosslinked asphalt composition has a penetration point of 240 dmm to 300 dmm at 77° F. In some embodiments, the crosslinked asphalt composition has a penetration point of 250 dmm to 300 dmm at 77° F. In some embodiments, the crosslinked asphalt composition has a penetration point of 260 dmm to 300 dmm at 77° F. In some embodiments, the crosslinked asphalt composition has a penetration point of 270 dmm to 300 dmm at 77° F. In some embodiments, the crosslinked asphalt composition has a penetration point of 280 dmm to 300 dmm at 77° F. In some embodiments, the crosslinked asphalt composition has a penetration point of 290 dmm to 300 dmm at 77° F.

In some embodiments, the penetration point is measured according to ASTM D5. In some embodiments, the penetration point is measured according to BS EN 1426.

In some embodiments, the crosslinked asphalt composition has a softening point of 100° F. to 300° F. In some embodiments, the crosslinked asphalt composition has a softening point of 100° F. to 290° F. In some embodiments, the crosslinked asphalt composition has a softening point of 100° F. to 280° F. In some embodiments, the crosslinked asphalt composition has a softening point of 100° F. to 270° F. In some embodiments, the crosslinked asphalt composition has a softening point of 100° F. to 260° F. In some embodiments, the crosslinked asphalt composition has a softening point of 100° F. to 250° F. In some embodiments, the crosslinked asphalt composition has a softening point of 100° F. to 240° F. In some embodiments, the crosslinked asphalt composition has a softening point of 100° F. to 230° F. In some embodiments, the crosslinked asphalt composition has a softening point of 100° F. to 220° F. In some embodiments, the crosslinked asphalt composition has a softening point of 100° F. to 210° F. In some embodiments, the crosslinked asphalt composition has a softening point of 100° F. to 200° F. In some embodiments, the crosslinked asphalt composition has a softening point of 100° F. to 190° F. In some embodiments, the crosslinked asphalt composition has a softening point of 100° F. to 180° F. In some embodiments, the crosslinked asphalt composition has a softening point of 100° F. to 170° F. In some embodiments, the crosslinked asphalt composition has a softening point of 100° F. to 160° F. In some embodiments, the crosslinked asphalt composition has a softening point of 100° F. to 150° F. In some embodiments, the crosslinked asphalt composition has a softening point of 100° F. to 140° F. In some embodiments, the crosslinked asphalt composition has a softening point of 100° F. to 130° F. In some embodiments, the crosslinked asphalt composition has a softening point of 100° F. to 120° F. In some embodiments, the crosslinked asphalt composition has a softening point of 100° F. to 110° F.

In some embodiments, the crosslinked asphalt composition has a softening point of 110° F. to 300° F. In some embodiments, the crosslinked asphalt composition has a softening point of 120° F. to 300° F. In some embodiments, the crosslinked asphalt composition has a softening point of 130° F. to 300° F. In some embodiments, the crosslinked asphalt composition has a softening point of 140° F. to 300° F. In some embodiments, the crosslinked asphalt composition has a softening point of 150° F. to 300° F. In some embodiments, the crosslinked asphalt composition has a softening point of 160° F. to 300° F. In some embodiments, the crosslinked asphalt composition has a softening point of 170° F. to 300° F. In some embodiments, the crosslinked asphalt composition has a softening point of 180° F. to 300° F. In some embodiments, the crosslinked asphalt composition has a softening point of 190° F. to 300° F. In some embodiments, the crosslinked asphalt composition has a softening point of 200° F. to 300° F. In some embodiments, the crosslinked asphalt composition has a softening point of 210° F. to 300° F. In some embodiments, the crosslinked asphalt composition has a softening point of 220° F. to 300° F. In some embodiments, the crosslinked asphalt composition has a softening point of 230° F. to 300° F. In some embodiments, the crosslinked asphalt composition has a softening point of 240° F. to 300° F. In some embodiments, the crosslinked asphalt composition has a softening point of 250° F. to 300° F. In some embodiments, the crosslinked asphalt composition has a softening point of 260° F. to 300° F. In some embodiments, the crosslinked asphalt composition has a softening point of 270° F. to 300° F. In some embodiments, the crosslinked asphalt composition has a softening point of 280° F. to 300° F. In some embodiments, the crosslinked asphalt composition has a softening point of 290° F. to 300° F.

In some embodiments, the softening point is measured according to ASTM D36. In some embodiments, the softening point is measured according to BS EN 1427.

In some embodiments, the crosslinked asphalt composition has a tensile strength of 100 to 500 pounds per square inch (PSI). In some embodiments, the crosslinked asphalt composition has a tensile strength of 100 to 475 PSI. In some embodiments, the crosslinked asphalt composition has a tensile strength of 100 to 450 PSI. In some embodiments, the crosslinked asphalt composition has a tensile strength of 100 to 425 PSI. In some embodiments, the crosslinked asphalt composition has a tensile strength of 100 to 400 PSI. In some embodiments, the crosslinked asphalt composition has a tensile strength of 100 to 375 PSI. In some embodiments, the crosslinked asphalt composition has a tensile strength of 100 to 350 PSI. In some embodiments, the crosslinked asphalt composition has a tensile strength of 100 to 325 PSI. In some embodiments, the crosslinked asphalt composition has a tensile strength of 100 to 300 PSI. In some embodiments, the crosslinked asphalt composition has a tensile strength of 100 to 275 PSI. In some embodiments, the crosslinked asphalt composition has a tensile strength of 100 to 250 PSI. In some embodiments, the crosslinked asphalt composition has a tensile strength of 100 to 225 PSI. In some embodiments, the crosslinked asphalt composition has a tensile strength of 100 to 200 PSI. In some embodiments, the crosslinked asphalt composition has a tensile strength of 100 to 175 PSI. In some embodiments, the crosslinked asphalt composition has a tensile strength of 100 to 150 PSI. In some embodiments, the crosslinked asphalt composition has a tensile strength of 100 to 125 PSI. In some embodiments, the crosslinked asphalt composition has a tensile strength of 125 to 500 PSI. In some embodiments, the crosslinked asphalt composition has a tensile strength of 150 to 500 PSI. In some embodiments, the crosslinked asphalt composition has a tensile strength of 175 to 500 PSI. In some embodiments, the crosslinked asphalt composition has a tensile strength of 200 to 500 PSI. In some embodiments, the crosslinked asphalt composition has a tensile strength of 225 to 500 PSI. In some embodiments, the crosslinked asphalt composition has a tensile strength of 250 to 500 PSI. In some embodiments, the crosslinked asphalt composition has a tensile strength of 275 to 500 PSI. In some embodiments, the crosslinked asphalt composition has a tensile strength of 300 to 500 PSI. In some embodiments, the crosslinked asphalt composition has a tensile strength of 325 to 500 PSI. In some embodiments, the crosslinked asphalt composition has a tensile strength of 350 to 500 PSI. In some embodiments, the crosslinked asphalt composition has a tensile strength of 375 to 500 PSI. In some embodiments, the crosslinked asphalt composition has a tensile strength of 400 to 500 PSI. In some embodiments, the crosslinked asphalt composition has a tensile strength of 425 to 500 PSI. In some embodiments, the crosslinked asphalt composition has a tensile strength of 450 to 500 PSI. In some embodiments, the crosslinked asphalt composition has a tensile strength of 475 to 500 PSI.

In some embodiments, the tensile strength is measured according to ASTM C1135 (i.e., ASTM C1135-00 (Reapproved 2011)). In some embodiments, the tensile strength is measured according to ASTM 638.

In some embodiments, the crosslinked asphalt composition has an elongation of 1% to 100%. In some embodiments, the crosslinked asphalt composition has an elongation of 1% to 95%. In some embodiments, the crosslinked asphalt composition has an elongation of 1% to 90%. In some embodiments, the crosslinked asphalt composition has an elongation of 1% to 85%. In some embodiments, the crosslinked asphalt composition has an elongation of 1% to 80%. In some embodiments, the crosslinked asphalt composition has an elongation of 1% to 75%. In some embodiments, the crosslinked asphalt composition has an elongation of 1% to 70%. In some embodiments, the crosslinked asphalt composition has an elongation of 1% to 65%. In some embodiments, the crosslinked asphalt composition has an elongation of 1% to 60%. In some embodiments, the crosslinked asphalt composition has an elongation of 1% to 55%. In some embodiments, the crosslinked asphalt composition has an elongation of 1% to 50%. In some embodiments, the crosslinked asphalt composition has an elongation of 1% to 45%. In some embodiments, the crosslinked asphalt composition has an elongation of 1% to 40%. In some embodiments, the crosslinked asphalt composition has an elongation of 1% to 35%. In some embodiments, the crosslinked asphalt composition has an elongation of 1% to 30%. In some embodiments, the crosslinked asphalt composition has an elongation of 1% to 25%. In some embodiments, the crosslinked asphalt composition has an elongation of 1% to 20%. In some embodiments, the crosslinked asphalt composition has an elongation of 1% to 15%. In some embodiments, the crosslinked asphalt composition has an elongation of 1% to 10%. In some embodiments, the crosslinked asphalt composition has an elongation of 1% to 5%.

In some embodiments, the crosslinked asphalt composition has an elongation of 5% to 100%. In some embodiments, the crosslinked asphalt composition has an elongation of 10% to 100%. In some embodiments, the crosslinked asphalt composition has an elongation of 15% to 100%. In some embodiments, the crosslinked asphalt composition has an elongation of 20% to 100%. In some embodiments, the crosslinked asphalt composition has an elongation of 25% to 100%. In some embodiments, the crosslinked asphalt composition has an elongation of 30% to 100%. In some embodiments, the crosslinked asphalt composition has an elongation of 35% to 100%. In some embodiments, the crosslinked asphalt composition has an elongation of 40% to 100%. In some embodiments, the crosslinked asphalt composition has an elongation of 45% to 100%. In some embodiments, the crosslinked asphalt composition has an elongation of 50% to 100%. In some embodiments, the crosslinked asphalt composition has an elongation of 55% to 100%. In some embodiments, the crosslinked asphalt composition has an elongation of 60% to 100%. In some embodiments, the crosslinked asphalt composition has an elongation of 65% to 100%. In some embodiments, the crosslinked asphalt composition has an elongation of 70% to 100%. In some embodiments, the crosslinked asphalt composition has an elongation of 75% to 100%. In some embodiments, the crosslinked asphalt composition has an elongation of 80% to 100%. In some embodiments, the crosslinked asphalt composition has an elongation of 85% to 100%. In some embodiments, the crosslinked asphalt composition has an elongation of 90% to 100%. In some embodiments, the crosslinked asphalt composition has an elongation of 95% to 100%.

In some embodiments, the elongation is measured according to ASTM C1135 (i.e., ASTM C1135-00 (Reapproved 2011)). In some embodiments, the elongation is measured according to ASTM 638.

In some embodiments, the crosslinked asphalt composition has a pull-off adhesion of 100 to 400 PSI. In some embodiments, the crosslinked asphalt composition has a pull-off adhesion of 100 to 375 PSI. In some embodiments, the crosslinked asphalt composition has a pull-off adhesion of 100 to 350 PSI. In some embodiments, the crosslinked asphalt composition has a pull-off adhesion of 100 to 325 PSI. In some embodiments, the crosslinked asphalt composition has a pull-off adhesion of 100 to 300 PSI. In some embodiments, the crosslinked asphalt composition has a pull-off adhesion of 100 to 275 PSI. In some embodiments, the crosslinked asphalt composition has a pull-off adhesion of 100 to 250 PSI. In some embodiments, the crosslinked asphalt composition has a pull-off adhesion of 100 to 225 PSI. In some embodiments, the crosslinked asphalt composition has a pull-off adhesion of 100 to 200 PSI. In some embodiments, the crosslinked asphalt composition has a pull-off adhesion of 100 to 175 PSI. In some embodiments, the crosslinked asphalt composition has a pull-off adhesion of 100 to 150 PSI. In some embodiments, the crosslinked asphalt composition has a pull-off adhesion of 100 to 125 PSI.

In some embodiments, the crosslinked asphalt composition has a pull-off adhesion of 125 to 400 PSI. In some embodiments, the crosslinked asphalt composition has a pull-off adhesion of 150 to 400 PSI. In some embodiments, the crosslinked asphalt composition has a pull-off adhesion of 175 to 400 PSI. In some embodiments, the crosslinked asphalt composition has a pull-off adhesion of 200 to 400 PSI. In some embodiments, the crosslinked asphalt composition has a pull-off adhesion of 225 to 400 PSI. In some embodiments, the crosslinked asphalt composition has a pull-off adhesion of 250 to 400 PSI. In some embodiments, the crosslinked asphalt composition has a pull-off adhesion of 275 to 400 PSI. In some embodiments, the crosslinked asphalt composition has a pull-off adhesion of 300 to 400 PSI. In some embodiments, the crosslinked asphalt composition has a pull-off adhesion of 325 to 400 PSI. In some embodiments, the crosslinked asphalt composition has a pull-off adhesion of 350 to 400 PSI. In some embodiments, the crosslinked asphalt composition has a pull-off adhesion of 375 to 400 PSI.

In some embodiments, the pull-off adhesion is measured according to ASTM D 4796. In some embodiments, the elongation is measured according to ASTM D 4541.

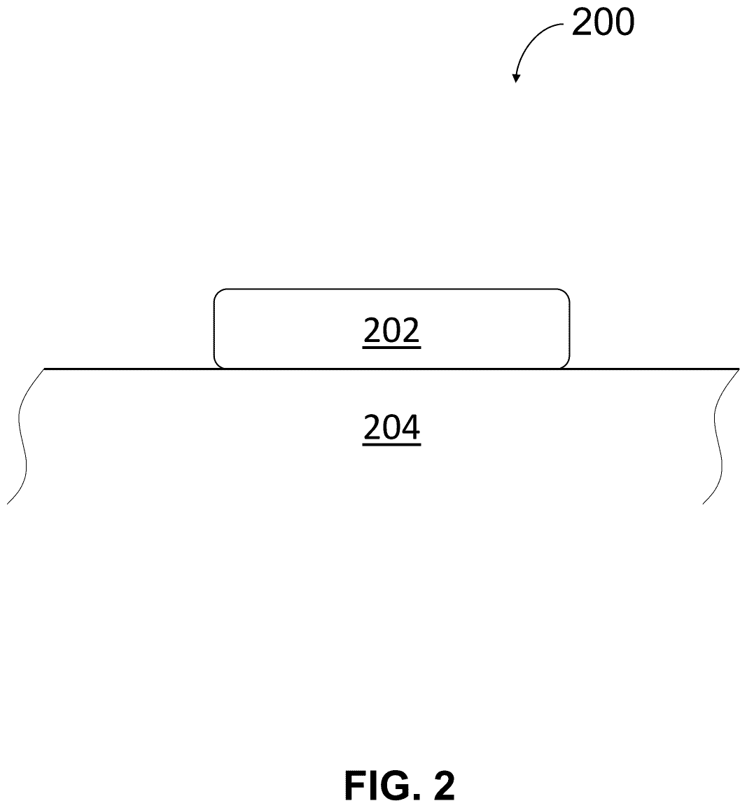

FIG. 2 is a schematic diagram of a cross-section of a system comprising a crosslinked asphalt composition, according to some embodiments. In some embodiments, the system 200 comprises a first layer 202. In some embodiments, the system 200 comprises a substrate 204. In some embodiments, the first layer 202 is located on the substrate 204. In some embodiments, the first layer 202 is located on the substrate 204 so as to seal at least a portion of the substrate 204. In some embodiments, the first layer 204 is located on the substrate 204 so as to coat (e.g., as a surface coating) at least a portion of the substrate 204. In some embodiments, the first layer 202 covers the substrate 204. In some embodiments, the first layer 202 is bonded to the substrate 204. In some embodiments, the first layer 202 is adhered to the substrate 204. In some embodiments, the first layer 202 directly contacts the substrate 204. In some embodiments, an intervening layer is located between the first layer 202 and the substrate 204. In some embodiments, the first layer 202 is located between the substrate 204 and a second substrate 206 (not shown) so as to adhere the substrate 204 to the second substrate 206.

In some embodiments, the first layer 202 comprises a cured asphalt composition. In some embodiments, the first layer 202 comprises a crosslinked asphalt composition. In some embodiments, the first layer 202 comprises a reaction product of a first formulation and a second formulation, wherein the first formulation and/or the second formulation comprises any one or more of the formulations disclosed herein. For example, in some embodiments, the first layer 202 comprises a reaction product, wherein the reaction product comprises a three-dimensional crosslinked polymer network. In some embodiments, the three-dimension crosslinked polymer network comprises an asphalt component. In some embodiments, the asphalt component is within the three-dimensional crosslinked polymer network. In some embodiments, the asphalt component is distributed within and/or throughout all or at least a portion of the three-dimensional crosslinked polymer network. In some embodiments, the asphalt component is dispersed or uniformly dispersed within the three-dimensional crosslinked polymer network. In some embodiments, the asphalt component is distributed or uniformly distributed within the three-dimensional crosslinked polymer network.

In some embodiments, the substrate 204 comprises at least one of a pavement, a road, a cement, a roofing substrate, a building substrate, a sheathing, an insulation, an asphaltic substrate, a plywood substrate, a glass substrate, a cellulosic substrate, an underlayment, a roofing membrane (reinforced or unreinforced), a roof deck, a photovoltaic (PV) panel, a modified bitumen (MODBIT) substrate, an oriented strand board (OSB), a roll good, a board (such as but not limited to at least one of a foam board (e.g., a polyisocyanurate (ISO) foam board), a cover board, or any combination thereof), a fire retardant board, a hail resistant board, a building structure, a high density cover board, a cement board, concrete, a base sheet, a pipe, a chimney, a wax paper, a roof shingle, a mat, a fabric, a glass mat, a fiberglass mat, a woven mat, a nonwoven a fabric, a polyester mat, a scrim, a coated scrim, or any combination thereof.

Some embodiments relate to a kit. In some embodiments, the kit comprises a first container. In some embodiments, the first container comprises a first formulation. In some embodiments, the first formulation comprises a crosslinker. In some embodiments, the crosslinker comprises a polyamine compound. In some embodiments, the kit comprises a second container. In some embodiments, the second container comprises a second formulation. In some embodiments, the second formulation comprises a polyfunctional epoxy-containing compound and an asphalt component. In some embodiments, a sufficient amount of the second formulation is configured to be mixed with at least a sufficient amount of the first formulation so as to form a crosslinkable asphalt composition. In some embodiments, the crosslinkable asphalt composition, when cured, forms a reaction product comprising a three-dimensional crosslinked polymer network. In some embodiments, the asphalt component is within the three-dimensional crosslinked polymer network.

Some embodiments relate to a system. In some embodiments, the system comprises a substrate. In some embodiments, the substrate comprises any one or more of the substrates disclosed herein. In some embodiments, the system comprises a crosslinked asphalt composition located on the substrate. In some embodiments, the crosslinked asphalt composition comprises any one or more of the crosslinked asphalt compositions disclosed herein. In some embodiments, for example, the crosslinked asphalt composition comprises a reaction product of a crosslinker and a polyfunctional epoxy-containing compound. In some embodiments, the reaction product comprises a three-dimensional crosslinked polymer network. In some embodiments, the crosslinked asphalt composition comprises an asphalt component. In some embodiments, the asphalt component is within the three-dimensional crosslinked polymer network. In some embodiments, the crosslinked asphalt composition directly contacts the substrate. In some embodiments, the crosslinked asphalt composition is located on the substrate so as to form a seal between the substrate and the crosslinked asphalt composition. In some embodiments, the crosslinked asphalt composition is located on the substrate so as to form a surface coating on the substrate. In some embodiments, the crosslinked asphalt composition is located between two substrates, wherein the two substrates are same or different. For example, in some embodiments, the crosslinked asphalt composition adheres a first substrate to a second substrate. In some embodiments, the crosslinked asphalt composition comprises a three-dimensional crosslinked polymer network. In some embodiments, the three-dimensional crosslinked network is a reaction product of a crosslinker and a polyfunctional epoxy-containing compound. In some embodiments, the crosslinked asphalt composition comprises an asphalt component. In some embodiments, the asphalt component is within the three-dimensional crosslinked polymer network.

### Example 1

A first formulation comprising an epoxy-modified oxidized asphalt, a polyamine curing agent, and an aromatic hydrocarbon solvent was prepared. A second formulation comprising a liquid epoxy resin and a filler was prepared. The first formulation and the second formulation were combined to form a crosslinkable asphalt composition. The crosslinkable asphalt composition was applied to a substrate, cured, and tested according to ASTM C1135 (i.e., ASTM C1135-00 (Reapproved 2011)). The weight percentages for each of the components in the first formulation and the second formulation are summarized in Table 1 below and are based on a total weight of the first formulation and the second formulation. The results of the tests are summarized in Table 2 below.

TABLE 1:

| | Weight Percentage |
|---|---|
| First Formulation | |
| Epoxy-modified oxidized asphalt | 30% |
| Aromatic Hydrocarbon Solvent | 5% |
| Polyamine Curing Agent | 12% |
| Second Formulation | |
| Liquid Epoxy Resin | 23% |
| Filler | 30% |

TABLE 2:

| Property | Results* |
|---|---|
| Gel Time (hour) | 3.2 |
| Fully Cure Time (hour) | 5 |
| Tensile Strength (PSI) | 230 |
| Elongation (%) | 13 |

*Results are based on a 0.5″ × 0.5″ × 2″ sample

### Example 2

A first formulation comprising an asphalt shingle waste and a curing agent was prepared. A second formulation comprising a liquid epoxy resin and fillers was prepared. The first formulation and the second formulation were combined to form a crosslinkable asphalt composition. The crosslinkable asphalt composition was a 100% solid, zero VOC system containing no solvent. The crosslinkable asphalt composition was applied to a substrate, cured, and tested according to ASTM C1135 (i.e., ASTM C1135-00 (Reapproved 2011)), ASTM D1640/1640M-14 ASTM 638, and ASTM D 4796/ASTM D 4541. The weight percentages for each of the components in the first formulation and the second formulation are summarized in Table 3 below and are based on a total weight of the first formulation and the second formulation. The results of the tests are summarized in Table 4 below.

TABLE 3:

| | Weight Percentage |
|---|---|
| First Formulation | |
| Asphalt Shingle Waste | 22% |
| Curing Agent | 8% |
| Second Formulation | |
| Liquid Epoxy Resin | 22% |
| Filler | 48% |

TABLE 4:

| Property | Results* |
|---|---|
| Gel Time (hour) | 2.5 |
| Fully Cure Time (hour) | 4 |
| Tensile Strength (PSI) | 233 |
| Elongation (%) | 12 |
| Pull-off Adhesion (PSI) | 207 |

*Results are based on a 0.5″ × 0.5″ × 2″ sample

### Example 3

A first formulation comprising diethylenetriamine is obtained. A second formulation comprising an asphalt shingle waste and an alkyl glycidyl ether is obtained. The alkyl glycidyl ether is combined with the asphalt shingle waste in an amount sufficient to make the second formulation a flowable liquid at ambient temperature and ambient pressure. The first formulation and the second formulation are combined to form a crosslinkable asphalt composition. The crosslinkable asphalt composition is applied to a substrate and allowed to cure to form a reaction product comprising a three-dimensional crosslinked polymer network. The three-dimensional crosslinked polymer network is a reaction product of the diethylenetriamine and the alkyl glycidyl ether. The asphalt component is within the three-dimensional crosslinked polymer network.

### Example 4

A first formulation comprising diethylenetriamine is obtained. A second formulation comprising an asphalt shingle waste and an epoxidized fatty acid ester is obtained. The epoxidized fatty acid ester is combined with the asphalt shingle waste in an amount sufficient to make the second formulation a flowable liquid at ambient temperature and ambient pressure. The first formulation and the second formulation are combined to form a crosslinkable asphalt composition. The crosslinkable asphalt composition is applied to a substrate and allowed to cure to form a reaction product comprising a three-dimensional crosslinked polymer network. The three-dimensional crosslinked polymer network is a reaction product of the diethylenetriamine and the epoxidized fatty acid ester. The asphalt component is within the three-dimensional crosslinked polymer network.

### Example 5

A first formulation comprising diethylenetriamine is obtained. A second formulation comprising an asphalt shingle waste and an epoxidized plant oil is obtained. The epoxidized plant oil is combined with the asphalt shingle waste in an amount sufficient to make the second formulation a flowable liquid at ambient temperature and ambient pressure. The first formulation and the second formulation are combined to form a crosslinkable asphalt composition. The crosslinkable asphalt composition is applied to a substrate and allowed to cure to form a reaction product comprising a three-dimensional crosslinked polymer network. The three-dimensional crosslinked polymer network is a reaction product of the diethylenetriamine and the epoxidized plant oil. The asphalt component is within the three-dimensional crosslinked polymer network.

### Example 6

A first formulation comprising triethylenetetramine is obtained. A second formulation comprising an asphalt shingle waste and an alkyl glycidyl ether is obtained. The alkyl glycidyl ether is combined with the asphalt shingle waste in an amount sufficient to make the second formulation a flowable liquid at ambient temperature and ambient pressure. The first formulation and the second formulation are combined to form a crosslinkable asphalt composition. The crosslinkable asphalt composition is applied to a substrate and allowed to cure to form a reaction product comprising a three-dimensional crosslinked polymer network. The three-dimensional crosslinked polymer network is a reaction product of the triethylenetetramine and the alkyl glycidyl ether. The asphalt component is within the three-dimensional crosslinked polymer network.

### Example 7

A first formulation comprising triethylenetetramine is obtained. A second formulation comprising an asphalt shingle waste and an epoxidized fatty acid ester is obtained. The epoxidized fatty acid ester is combined with the asphalt shingle waste in an amount sufficient to make the second formulation a flowable liquid at ambient temperature and ambient pressure. The first formulation and the second formulation are combined to form a crosslinkable asphalt composition. The crosslinkable asphalt composition is applied to a substrate and allowed to cure to form a reaction product comprising a three-dimensional crosslinked polymer network. The three-dimensional crosslinked polymer network is a reaction product of the triethylenetetramine and the epoxidized fatty acid ester. The asphalt component is within the three-dimensional crosslinked polymer network.

### Example 8

A first formulation comprising triethylenetetramine is obtained. A second formulation comprising an asphalt shingle waste and an epoxidized plant oil is obtained. The epoxidized plant oil is combined with the asphalt shingle waste in an amount sufficient to make the second formulation a flowable liquid at ambient temperature and ambient pressure. The first formulation and the second formulation are combined to form a crosslinkable asphalt composition. The crosslinkable asphalt composition is applied to a substrate and allowed to cure to form a crosslinked asphalt composition to form a reaction product comprising a three-dimensional crosslinked polymer network. The three-dimensional crosslinked polymer network is a reaction product of the triethylenetetramine and the epoxidized plant oil. The asphalt component is within the three-dimensional crosslinked polymer network.

What is claimed is:

1. A kit comprising:
a first container,
wherein the first container comprises a first formulation,
wherein the first formulation comprises a crosslinker; and
a second container,
wherein the second container comprises a second formulation,
wherein the second formulation comprises a polyfunctional epoxy-containing compound and an asphalt component;
wherein a sufficient amount of the second formulation is configured to be mixed with at least a sufficient amount of the first formulation so as to form a crosslinkable asphalt composition;
wherein the crosslinkable asphalt composition, when cured, forms a reaction product comprising a three-dimensional crosslinked polymer network,
wherein the asphalt component is within the three-dimensional crosslinked polymer network.

2. The kit of claim 1, wherein the crosslinker comprises at least one of a polyamine compound, an anhydride, an acid anhydride, a phenol-formaldehyde, an amino-formaldehyde, a carboxylic acid, a polybasic carboxylic acid, a polyamide, a polyamidoamide, an imidazoline, a polymeric amine, an aliphatic amine, an aromatic amine, a polyester, a polysulphide, a polymercaptan, a polyphenol, a thiol, a polythiol compound, or any combination thereof.

3. The kit of claim 1, wherein the polyfunctional epoxy-containing compound comprises at least one of an alkyl glycidyl ether, an epoxidized fatty acid ester, an epoxidized plant oil, or any combination thereof.

4. The kit of claim 1, wherein the asphalt component comprises at least one of an asphalt shingle waste, an asphalt pavement waste, or any combination thereof.

5. The kit of claim 1, wherein the asphalt component comprises:
an asphalt shingle waste,
wherein the asphalt shingle waste comprises:
a waste asphalt;
a limestone;
granules; and
impurities.

6. The kit of claim 1, wherein the asphalt component comprises:
an asphalt shingle waste,
wherein the asphalt shingle waste comprises:
1% to 99% by weight of an asphalt based on a total weight of the asphalt shingle waste,
wherein the asphalt comprises a waste asphalt; and
1% to 99% by weight of a limestone, granules, and impurities based on the total weight of the asphalt shingle waste.

7. The kit of claim 1, wherein the asphalt component comprises:
an asphalt pavement waste,
wherein the asphalt pavement waste comprises:
a waste asphalt; and
an aggregate.

8. The kit of claim 1, wherein the asphalt component comprises:
an asphalt,
wherein the asphalt comprises:
1% to 40% by weight of a waste asphalt based on a total weight of the asphalt.

9. The kit of claim 1, wherein the second formulation comprises:
1% to 20% by weight of the polyfunctional epoxy-containing compound based on a total weight of the second formulation; and
10% to 90% by weight of the asphalt component based on the total weight of the second formulation.

10. The kit of claim 9, wherein the second formulation further comprises:
20% to 70% by weight of a filler material based on the total weight of the second formulation.

11. A method comprising:
obtaining a first formulation,
wherein the first formulation comprises a crosslinker;
obtaining a second formulation,
wherein the second formulation comprises a polyfunctional epoxy-containing compound and an asphalt component;
mixing a sufficient amount of the first formulation with a sufficient amount of at least the second formulation so as to form a crosslinkable asphalt composition;
applying the crosslinkable asphalt composition to a surface; and
curing the crosslinkable asphalt composition, so as to form a reaction product comprising a three-dimensional crosslinked polymer network,
wherein the asphalt component is within the three-dimensional crosslinked polymer network.

12. The method of claim 11, wherein the crosslinker comprises at least one of a polyamine compound, an anhydride, an acid anhydride, a phenol-formaldehyde, an amino-formaldehyde, a carboxylic acid, a polybasic carboxylic acid, a polyamide, a polyamidoamide, an imidazoline, a polymeric amine, an aliphatic amine, an aromatic amine, a polyester, a polysulphide, a polymercaptan, a polyphenol, a thiol, a polythiol compound, or any combination thereof.

13. The method of claim 11, wherein the polyfunctional epoxy-containing compound comprises at least one of an alkyl glycidyl ether, an epoxidized fatty acid ester, an epoxidized plant oil, or any combination thereof.

14. The method of claim 11, wherein the asphalt component comprises at least one of an asphalt shingle waste, an asphalt pavement waste, or any combination thereof.

15. The method of claim 11, wherein the asphalt component comprises:
an asphalt shingle waste,
wherein the asphalt shingle waste comprises:
a waste asphalt;
a limestone;
granules; and
impurities.

16. The method of claim 11, wherein the asphalt component comprises:
an asphalt shingle waste,
wherein the asphalt shingle waste comprises:
1% to 99% by weight of an asphalt based on a total weight of the asphalt shingle waste,
wherein the asphalt comprises a waste asphalt; and
1% to 99% by weight of limestone, granules, and impurities based on the total weight of the asphalt shingle waste.

17. The method of claim 11, wherein the asphalt component comprises:
an asphalt pavement waste,
wherein the asphalt pavement waste comprises:
a waste asphalt; and
an aggregate.

18. The method of claim 11, wherein the asphalt component comprises:
an asphalt,
wherein the asphalt comprises:
1% to 40% by weight of a waste asphalt based on a total weight of the asphalt.

19. The method of claim 11, wherein the second formulation comprises:
1% to 20% by weight of the polyfunctional epoxy-containing compound based on a total weight of the second formulation; and
10% to 90% by weight of the asphalt component based on the total weight of the second formulation.

20. A system comprising:
a substrate; and
a crosslinked asphalt composition,
wherein the crosslinked asphalt composition is located on the substrate;
wherein the crosslinked asphalt composition comprises:
a three-dimensional crosslinked polymer network,
wherein the three-dimensional crosslinked polymer network is a reaction product of a crosslinker and a polyfunctional epoxy-containing compound; and
an asphalt component,
wherein the asphalt component is within the three-dimensional crosslinked polymer network.
